(19) United States
(12) Patent Application Publication
(10) Pub. No.: US 2025/0149994 A1
(43) Pub. Date: May 8, 2025

(54) Improved performance of a flyback converter

(71) Applicant: EGGTRONIC ENGINEERING SPA, MODENA (IT)

(72) Inventors: Igor SPINELLA, MODENA (IT); Lorenzo FERRARI, MODENA (IT); Andrea ZANETTI, MODENA (IT)

(21) Appl. No.: 18/837,022

(22) PCT Filed: Feb. 10, 2023
(86) PCT No.: PCT/EP2023/053328

§ 371 Date: Aug. 8, 2024

(30) Foreign Application Priority Data
Feb. 11, 2022 (GB) 2201775.0

(51) Int. Cl. H02M 3/335; H02M 1/00; H02M 1/36; H02M 1/42; H02M 3/00; H02M 3/158

(52) U.S. Cl. CPC H02M 3/33592; H02M 1/0058; H02M 1/008; H02M 1/36; H02M 1/4208; H02M 3/01; H02M 3/1582

(57) ABSTRACT

A flyback converter comprising: a transformer having a primary side winding and a secondary side winding; a primary side switch located at the primary side of the transformer; two secondary side switches located at the secondary side of the transformer; in which the two secondary side switches are connected in parallel and have different characteristics; and a control unit configured to generate a rectification signal and a Zero Voltage Switching (ZVS) pulse and to drive the two secondary side switches; in which a secondary side switch is driven by the rectification signal and the other secondary side switch is driven by the ZVS pulse. At the end of a switching cycle, before turning on the primary side switch: the control unit is configured to generate the ZVS pulse in the secondary side winding such that the parasitic capacitor of the primary side switch is discharged, and to consequently turn on the primary side switch in ZVS conditions or near ZVS conditions.

### BACKGROUND OF THE INVENTION

### 1. Field of the Invention

The field of the invention relates to flyback converters and to related systems and methods for operating the converters.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

The flyback power converter is a widely used topology for low to mid output power applications. One common switching mode of operation is the quasi-resonant mode in which switching (primary side switch turns on) occurs at the lowest drain voltage valleys generated by the resonance between the primary inductance and parasitic capacitance of the circuit.

Existing flyback converters, although low cost, are often not very efficient as well as bulky.

Existing flyback converters may include synchronous MOSFET rectification, combining a MOSFET with a control for turning the device on or off. However, the rectifier section often works in hard switching mode, therefore inducting high losses both in turn on and in turn off of the primary side MOSFET.

Moreover, EMI emissions are often non-negligible, leading to the use of relatively large filters and hence a significant circuit size.

Thus, there is a need for optimising existing flyback and quasi-resonant flyback designs to improve efficiency, size and cost. Additionally, it is desirable to improve the performance and efficiency of flyback converters under any load conditions.

The present invention addresses the above vulnerabilities and also other problems not described above.

### SUMMARY OF THE INVENTION

The invention relates to an improved flyback converter as defined in the appended Claims.

A consolidated list of key features is at the Appendix.

### BRIEF DESCRIPTION OF THE FIGURES

Aspects of the invention will now be described, by way of example(s), with reference to the following Figures, which each show features of the invention:

FIG. 1 shows the general topology of quasi-resonant flyback converter

FIG. 2 shows the corresponding waveform plot of FIG. 1.

FIG. 3 shows a flyback converter topology in which a primary side control unit is located on the primary side circuit of the transformer.

FIG. 4 shows the waveform plot for a flyback converter in which a primary side control unit is located on the primary side circuit of the transformer.

FIG. 5 shows another example of flyback converter topology with a valley synchronizer unit located on the secondary side circuit of the transformer.

FIG. 6 shows the waveform plot for a flyback converter having a valley synchronizer unit located on the secondary side circuit of the transformer.

FIG. 7 shows another example of flyback converter topology including a control unit on the secondary side of the transformer.

FIG. 8 shows the effect on the primary side switch when a pulse request is received from the secondary side.

FIG. 9 shows another example of flyback converter topology also including a control unit on the secondary side of the transformer.

FIG. 10 shows the ZVS pulse markers available for pulse detection, in the case of a flyback converter including a control unit on the secondary side of the transformer

FIG. 11 shows a single transformer that integrates both power and signal transmission.

FIG. 12 shows a flyback converter topology where a signal transformer ensures the communication between primary and secondary side with a control unit located on the primary side circuit.

FIG. 13 shows a flyback converter topology where a signal transformer ensures the communication between primary and secondary side with a control unit located on the primary side circuit and a valley synchronizer unit located on the secondary side circuit.

FIG. 14 shows a flyback converter topology where a signal transformer ensures the communication between primary and secondary side, in the case of a primary side control unit located on the primary side circuit with a control unit on the secondary side.

FIG. 15 shows examples of a simplified AC/DC converter capable of inducing primary side ZVS switching.

FIG. 16 shows a proposed flyback architecture with regenerative clamp.

FIG. 17 shows an illustration of a five-winding configuration and of a bifilar wire.

FIG. 18 shows a standard regulation, where the rectifying MOSFET is commanded as an ideal diode.

FIG. 19 shows a phase-shifted regulation, where the secondary FET is turned ON as soon as the body diode would start conducting current, and is turned OFF after the current has changed sign.

FIG. 20 shows a simple possible implementation of a phase shift regulation, where the output voltage control loop is realized on the secondary side.

FIG. 21 shows a flyback converter using two auxiliary windings.

FIG. 22 shows an example of an auxiliary voltage circuit based on a rectifier that can be enabled or disabled by a FET.

FIG. 23 shows an example of a closed-loop solution for the circuit in FIG. 22 where the “enable” signal is high when the Vaux is greater than a threshold.

FIG. 24 shows an example of a rectifier capable of extracting an auxiliary voltage from a switching or resonant net.

FIG. 25 shows the voltage outputs of the auxiliary circuit.

FIG. 26 shows an LLC converter including the half-bridge implementation of the switching network and a full-wave rectifier.

FIG. 27 shows the circuit diagram of a AC/DC converter comprising a transformer, with primary winding L6 and secondary winding L8, and an auxiliary storage winding L1, arranged in a flyback-like (27A) or forward-like (27B) configuration.

FIG. 28 shows the circuit diagram of a AC/DC converter with a trifilar configuration made of one main primary and two auxiliary windings (28A), and with a bi-filar configuration made of two primary and two auxiliary windings (28B).

FIG. 29 shows a plot of the input voltage V_{BUS} and different power signals as compared to a threshold voltage V_{TH}. Two control methods are shown.

FIG. 30 shows a plot of the electrical signal during the main phase of the single magnetic AC/DC converter.

FIG. 31 shows a plot of the electrical signal during the auxiliary phase of the single magnetic AC/DC converter.

FIG. 32 shows the circuit diagram of a single stage AC/DC converter including a battery pack as storage element.

FIG. 33 shows the circuit diagram for active parallel storage combined with modified flyback with 2 primary windings.

FIG. 34 shows an AC-DC converter including an energy storage element on the secondary side of the converter.

FIG. 35 shows an AC-DC converter including a boost PFC and an insulated converter.

FIG. 36 shows an AC-DC converter including an insulated power converter, a storage element and a DC/DC stage.

FIG. 37 shows an AC/DC converter for providing several output voltages.

FIG. 38 shows a traditional AC/DC converter for providing several output voltages.

FIG. 39 shows the circuit diagram of an insulated PFC implemented using a resonant architecture comprising magnetic coupling.

FIG. 40 shows the circuit diagram of an insulated PFC implemented using a resonant architecture comprising capacitive coupling.

FIG. 41 shows the circuit diagram of an insulated PFC implemented using a bridgeless PFC architecture.

FIG. 42 shows the circuit diagram of a non-inverting buck boost converter.

FIG. 43 shows a circuit diagram of an AC/DC converter comprising an insulated PFC and the non-inverting buck boost converter.

FIG. 44 shows another circuit diagram including several non-inverting buck boost converters in parallel providing multiple independent output voltages.

FIG. 45 shows a multiple output AC/DC converter realized with an insulated buck-boost followed by one DC/DC converter for each output rail.

FIG. 46 shows a multiple outputs AC/DC converter realized with an insulated PFC converter, where the main output is generated filtering the output voltage of the PFC, while the other outputs are generated by a dedicated DC/DC converter.

FIG. 47 shows the circuit diagram of a two-stages parallel architecture including a converter in parallel with an insulated PFC.

FIG. 48 shows a waveform plot corresponding to the circuit of FIG. 47.

FIG. 49 shows a resonant not-insulated DC-DC bidirectional converter.

FIG. 50 shows a parallel storage circuit including a resonant capacitive circuit.

FIG. 51 shows a parallel storage including weakly coupled inductors, in a flyback configuration.

FIG. 52 shows a parallel storage including weakly coupled inductors, in a forward configuration.

FIG. 53 shows a parallel storage including a bidirectional flyback.

FIG. 54 shows the circuit diagram of a parallel architecture including a converter in parallel with an insulated PFC.

FIG. 55 shows a diagram of an insulated converter with the secondary side circuit configured as a voltage doubler.

FIG. 56 shows a diagram of an insulated converter with the secondary side circuit configured as a full bridge circuit.

FIG. 57 shows a diagram illustrating the different phases of the insulated converter.

FIG. 58 shows a diagram illustrating the different phases of the insulated converter.

FIG. 59 shows a diagram illustrating the different phases of the insulated converter.

FIG. 60 shows a diagram illustrating the different phases of the insulated converter.

FIG. 61 shows a diagram illustrating the different phases of the insulated converter.

FIG. 62 shows a diagram illustrating the different phases of the insulated converter.

FIG. 63 shows a diagram illustrating the different phases of the insulated converter.

FIG. 64 shows a diagram illustrating the different phases of the insulated converter.

FIG. 65 shows a diagram of the insulated converter used as an insulated PFC.

FIG. 66 shows circuit diagrams of the single stage bridgeless and capless wireless architecture.

FIG. 67 shows a conventional block diagram of the typical architecture of a <75 W input AC-DC converter.

FIG. 68 shows the block diagram of a simplified AC/DC converter.

FIG. 69 shows an example of a high voltage start-up circuit.

FIG. 70 shows the plot of the signals of FIG. 69.

FIG. 71 shows a flyback converter architecture including a secondary side rectifying switch driven by a rectification signal and a secondary side ZVS pulse switch configured to induce ZVS on the primary switch.

FIG. 72 shows a plot of the current at the secondary side, the combined signal, the rectification signal and the ZVS pulse signal.

FIG. 73 shows a plot of the voltage at the gate of the primary side switch the voltage at the gate of the secondary side switch the current at the secondary side and the voltage at the primary side switch.

### DETAILED DESCRIPTION

The specification is organised around the following categories or core technology:
SECTION I. Flyback converter
SECTION II. Active Storage
SECTION III. Active Parallel Filter
SECTION IV. Insulated converter
SECTION V. Simplified AC/DC
SECTION VI. Additional features of the Flyback converter

### Section I. Flyback Converter

Methods for improving the performances of a flyback converter are described here.

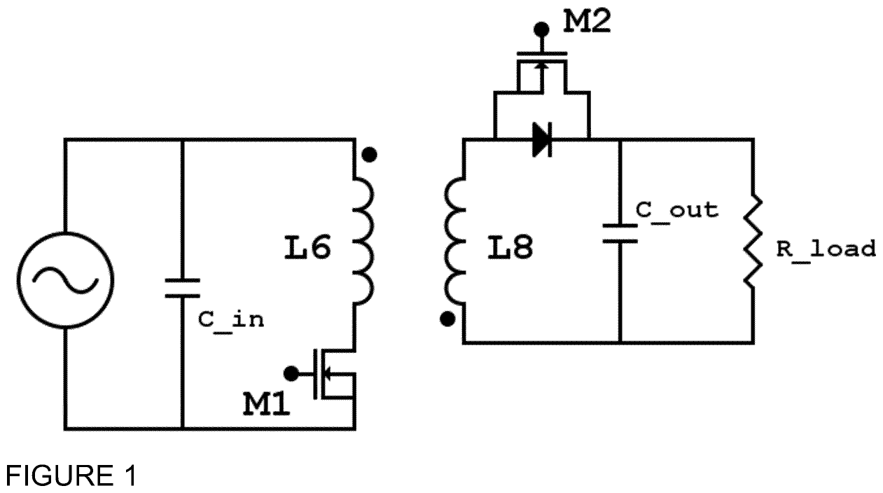

With reference to FIG. 1, the topology of a traditional quasi-resonant flyback converter is shown. It comprises a transformer composed of two highly coupled inductors L6 and L8 (located respectively at the primary and secondary side of the transformer), ideally coupled with a k=1, and a flyback type coupling, a primary side switch or MOSFET M1 in series with L6, a secondary side switch M2, a secondary side diode in series with L8, a primary side AC voltage source, an input capacitor Cin, and a secondary side capacitor Cout, in parallel with a load R_load.

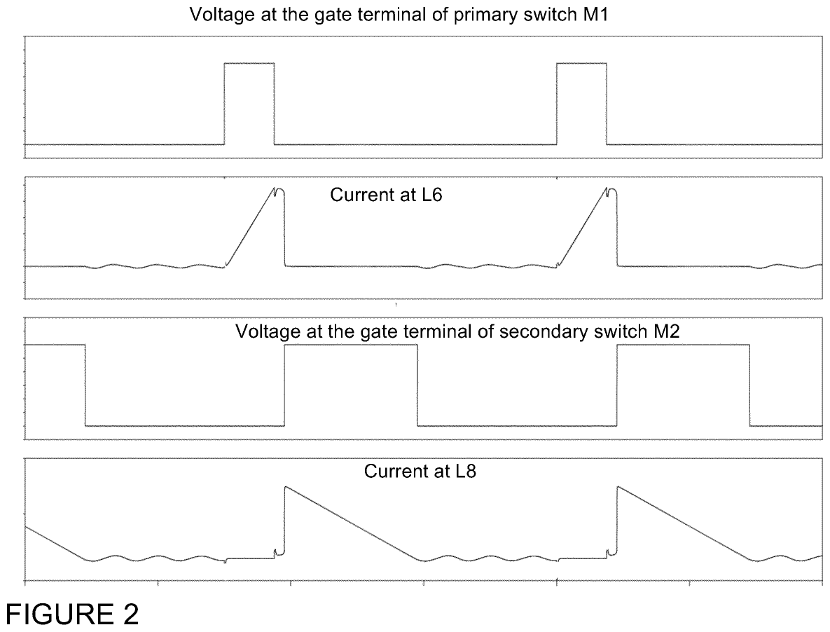

FIG. 2 shows the corresponding waveform plot of FIG. 1.

### Forced Primary Side ZVS

A method is now described for generating or inducing a ZVS (Zero Voltage Switch) turn-on of the primary side switch or MOSFET (M1) of a flyback converter in order to increase its efficiency. The aim is to induce ZVS turn-on of the primary side switch or MOSFET using no additional switches, on the widest range of load conditions.

Additionally, it is desirable to recover the primary leakage inductance energy, occurring at turn off of the primary side MOSFET, instead of dissipating it in an RCD snubber. Indeed, a reduction of the energy dissipated at each switching cycle would allow an increase in the frequency of operation, which in turns would allow for the use of smaller inductors and capacitors, with direct benefits on the overall power density of the converter.

Optionally, the secondary side switch or MOSFET M2 may also work as a synchronous rectifier, with the gate terminal of the secondary side switch activated during the transformer secondary energy transfer phase.

### Examples of Implementation

We now describe how we can correctly synchronize the switches or MOSFETs in order to achieve the desired behaviour. All the solutions presented below may also be referred to “QuarEgg” architecture, as a unifying class.

A) A secondary side induced ZVS flyback control scheme in which a ZVS pulse is generated by a primary side controller, transmitted to the secondary side using a signal coupling or a communication link (capacitive, inductive by means of a signal transformer, proximity antenna, etc.), and used to drive the secondary side switch, eventually in conjunction with the sync rectifier control signal.

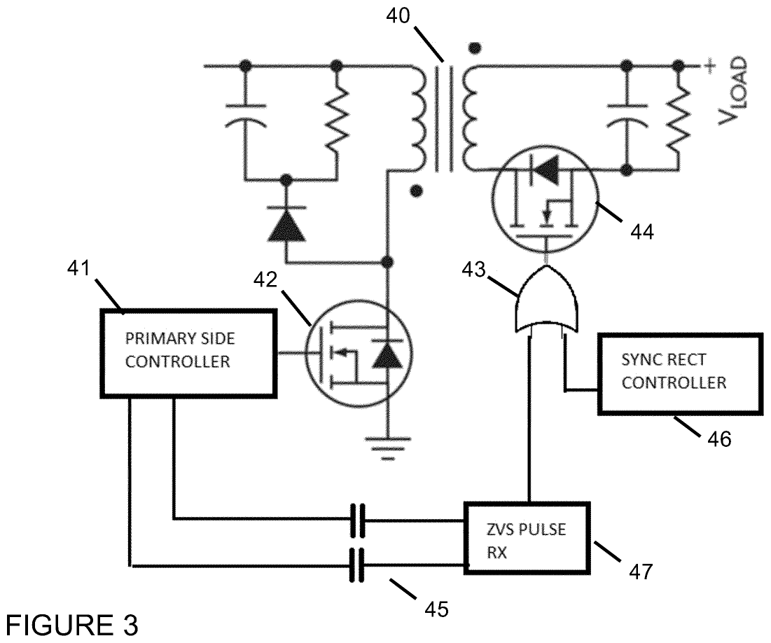

With reference to FIG. 3, a flyback converter topology is shown in which a primary side control unit 41 is connected to the primary side switch or MOSFET 42 of the transformer 40. The secondary side of the transformer 40 includes an OR logic gate 43 connected to the secondary side switch or MOSFET 44, in order to ensure the secondary side MOSFET is able to act as both a rectifier and a ZVS pulse generator to force ZVS on the primary side. Communication between the primary side and secondary side is achieved using a communication link, such as capacitive coupling 45.

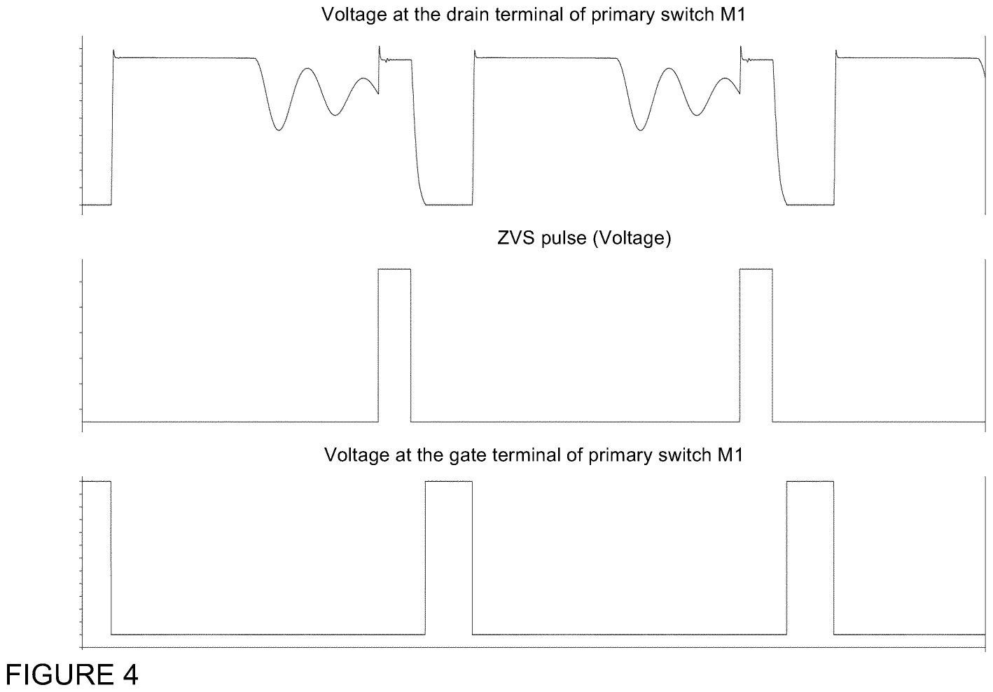

FIG. 4 shows the characteristic waveforms corresponding to the flyback converter of FIG. 3, in particular the voltage at the gate terminal and drain terminal of the primary side switch or MOSFET, and the generated ZVS pulse. The generated ZVS pulse is sent to the secondary switch via the OR logic gate. As seen, when the voltage at the drain terminal of the primary switch goes to zero or close to zero, the primary switch is then turned on in ZVS conditions.

With the proposed control scheme, the primary side controller 41 sends a ZVS pulse 47 on the secondary side rectifier turning on the secondary side MOSFET for a short pulse, before turning on the primary side MOSFET 42.

During the ZVS pulse, the voltage on the drain terminal of the primary side MOSFET 42 is forced at a high value (more or less equal to the converter's output voltage multiplied by the transformer's turns ratio) and some energy is stored in the transformer. When the ZVS pulse is released, there is a dead time during which both MOSFETs are off. During the dead time, the previously pre-charged transformer pushes down the primary side switching node, decreasing the voltage until it reaches zero or near zero volts. The primary side switch 42 is then turned on in Zero Voltage Switching conditions.

B) A secondary side valleys synchronized ZVS flyback control scheme in which the ZVS pulse request is generated by the primary side controller and transmitted to the secondary side circuit of the transformer using a communication link. The ZVS pulse request is used to enable a valley synchronizer circuit placed at the secondary side. The valley synchronizer circuit then synchronizes the ZVS pulse with a secondary side drain valley synchronizer unit.

In addition, the ZVS pulse may also be used to drive the secondary side switch in conjunction with a synch rectifier control signal.

Hence, instead of turning on the secondary side switch or MOSFET in a generic instant such as in hard switching mode, the secondary side MOSFET is also turned on in ZVS or near to ZVS conditions while minimizing its switching losses. Therefore, by detecting the secondary side valley, the secondary side switch hard switching losses are also minimised.

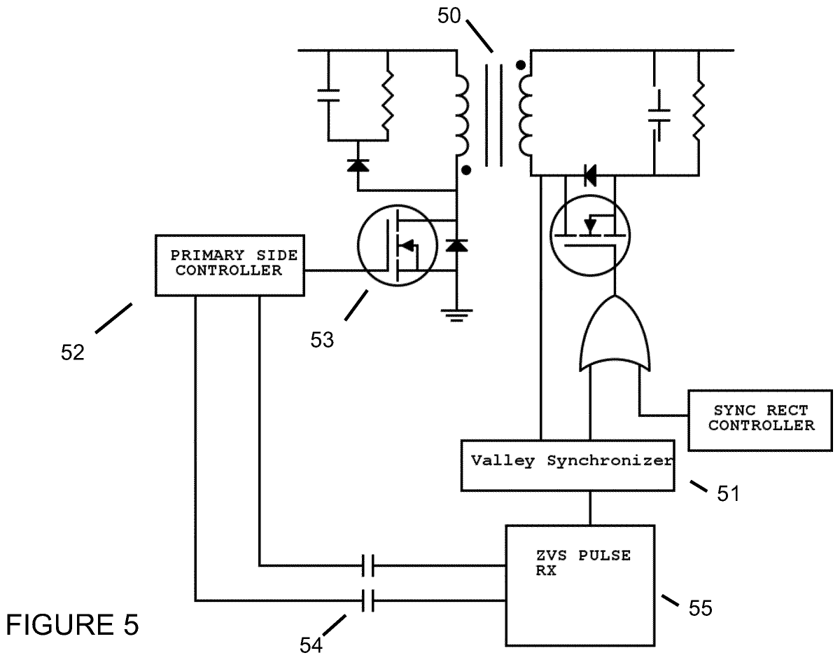

With reference to FIG. 5, another example of a flyback converter topology is shown in which a valley synchronizer unit 51 is included on the secondary side circuit of the transformer 50. The valley synchronizer unit 51 is configured to synchronize the primary side circuit and secondary side circuit.

In this implementation, before turning on the primary side switch or MOSFET 53, the controller 52 on the primary side sends the ZVS request signal through the communication channel 54 to the secondary side of the transformer. Rather than turning on the secondary side MOSFET immediately, the valley synchronizer 51 adds a delay able to start the ZVS pulse 55 when the secondary side valley is detected.

After the ZVS pulse is over, both primary and secondary side MOSFETs are off for a certain dead time, then the primary side switch may be turned on in ZVS condition.

Then the circuit as shown in FIG. 5 acts similarly to the one shown in FIG. 3.

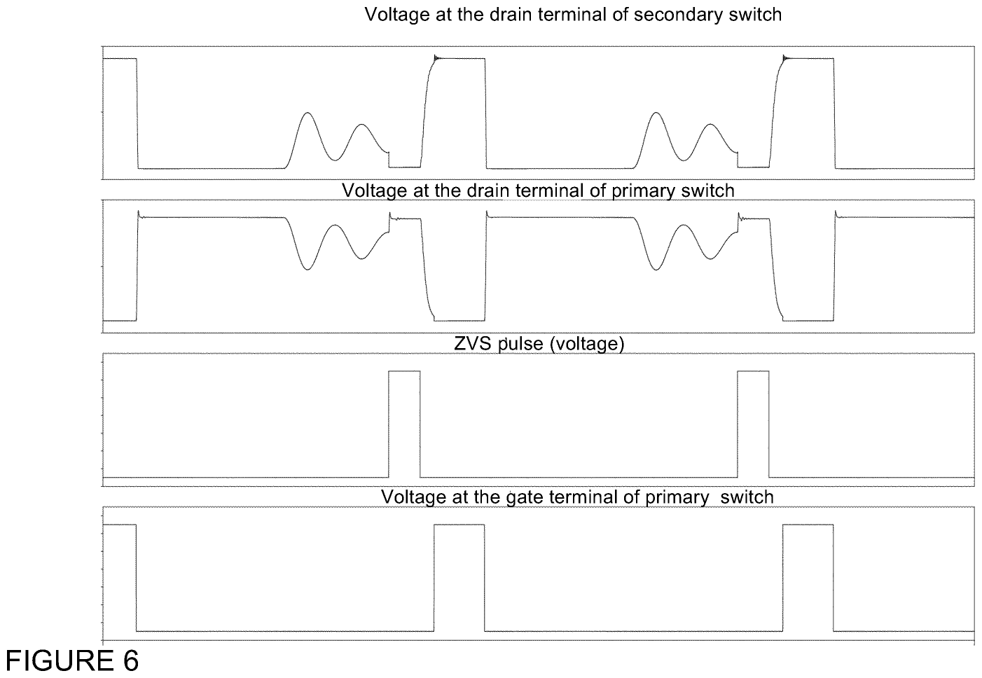

FIG. 6 shows the waveform plot of the circuit of FIG. 5, with primary MOSFET drain and gate voltages, secondary MOSFET drain and ZVS pulse gate signal. For simplicity, the secondary MOSFET synchronous rectification gate signal is not shown. It illustrates the valley synchronization of the secondary drain voltage with the secondary current decrease.

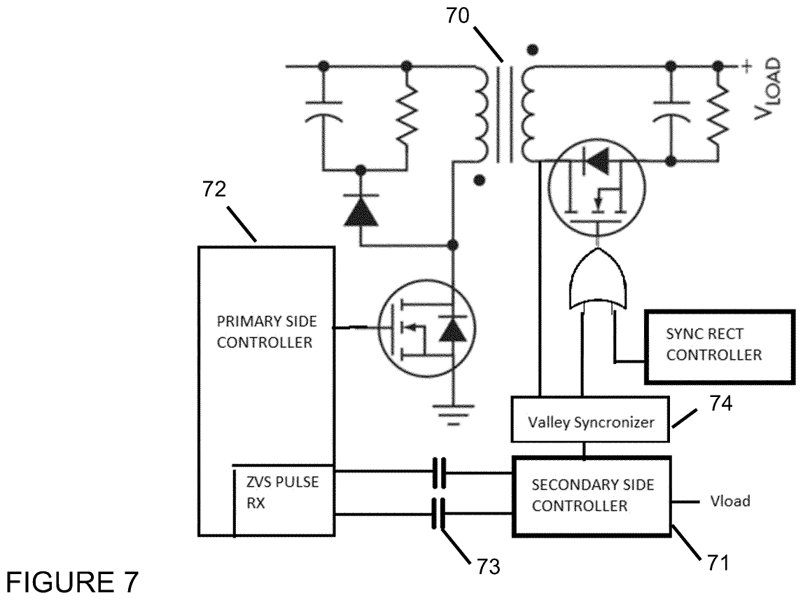

C) A ZVS flyback control scheme in which the main controller is located at the secondary side. With reference to FIG. 7, another example of a flyback converter topology is shown including a control unit 71 on the secondary side of the transformer 70.

The secondary side control unit 71 determines the switching frequency using a pulse density modulation approach to control output power. When an energizing pulse is requested, the control unit 71 first executes the ZVS pulse and then sends to the primary side switch or MOSFET 73 a turn-on request via capacitive coupling 73 (or any other signal couplings such as inductive coupling or proximity antenna).

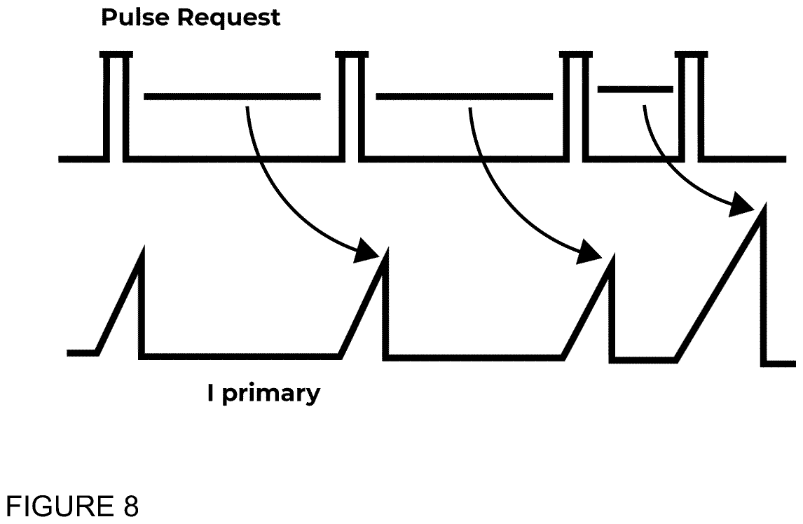

FIG. 8 shows the effect on the primary side switch when a pulse request is received from the secondary side. The primary side controller executes the requested pulse and chooses the turn-off current level through the density of pulses received. Higher density means more power requested and an increased peak current and/or duty cycle.

Optionally, a valley synchronizer unit 74 may also be included, as shown in FIG. 7.

Therefore, in this implementation, the controller 71 is located on the secondary side circuit of the transformer 70 and the primary side simpler controller 72 just “obeys” the secondary side controller 71 by turning on the primary side MOSFET when the ZVS pulse is completed, thus when the voltage on the primary side MOSFET is zero.

D) A ZVS flyback control scheme in which the main controller is located at the secondary side.

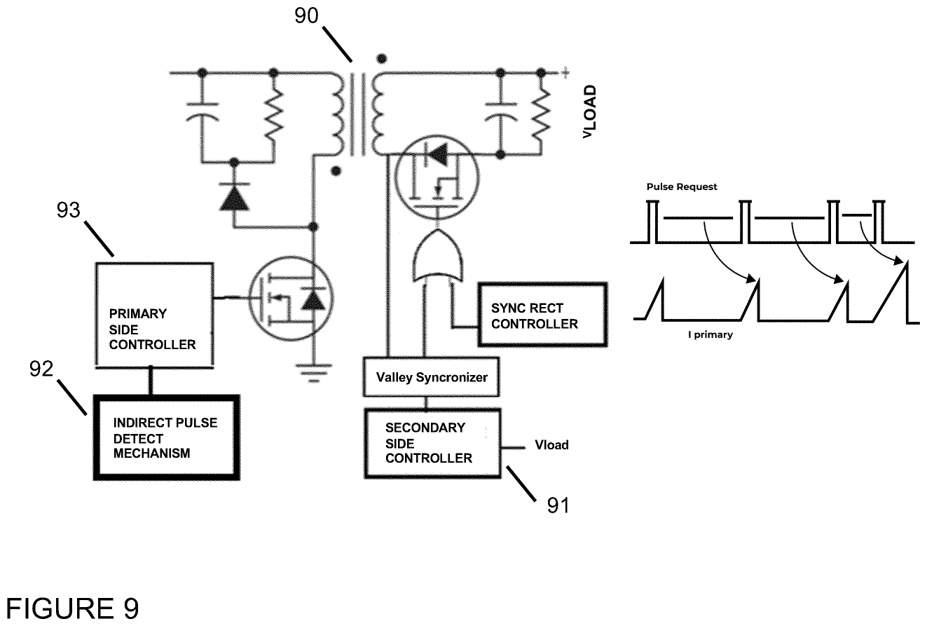

With reference to FIG. 9, another example of a flyback converter topology is shown including a control unit 91 on the secondary side of the transformer 90 and an indirect pulse detection mechanism unit 92 that is connected to the primary side control unit 93.

The secondary side controller determines the switching frequency using a pulse density modulation approach to control the output power. When a pulse is requested, the secondary side executes the ZVS pulse. The primary side control unit 93 detects the ZVS pulse through an ‘indirect pulse detection mechanism’, executes the requested energizing pulse and chooses the turn-off current level through the density of pulses received.

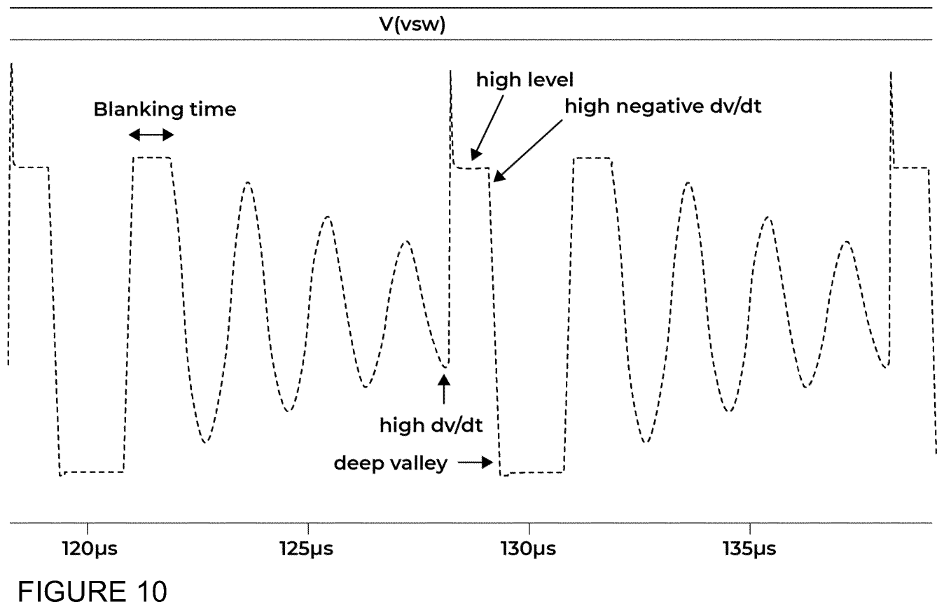

With reference to the switching voltage profile shown in FIG. 10, different ZVS pulse markers are available for pulse detection. In particular, an ‘indirect pulse detection mechanism’ may be implemented on the primary side, including but not limited to one of the following mechanisms or techniques:
1. Deep valley sensing performed directly on the drain terminal of the primary side MOSFET (Vdrain) or through an auxiliary winding. When the voltage drops down to zero (or close to zero), the controller detects a ZVS generated on the secondary side.
2. Same as point 1, with an additional filter mechanism configured to enable the deep valley sensor only after a detection of a high level on the MOSFET Vdrain or through an auxiliary winding, in order to avoid deep quasi-resonant valleys to be confused with forced ZVS pulses.
3. Same as point 1, with an additional filter mechanism configured to enable the deep valley sensor only after a detection of a high dv/dt followed by a high level on the MOSFET Vdrain or through an auxiliary winding.
4. Same as point 1, with an additional filter mechanism configured to enable the deep valley sensor only after a high negative dv/dt detection on the MOSFET Vdrain or through an auxiliary winding.
5. Same as point 1, with an additional filter that is configured to blank time after main power switch turn-off.
6. Any combination of points 1, 2, 3, 4, 5 above.

### Signal Coupling or Communication Link

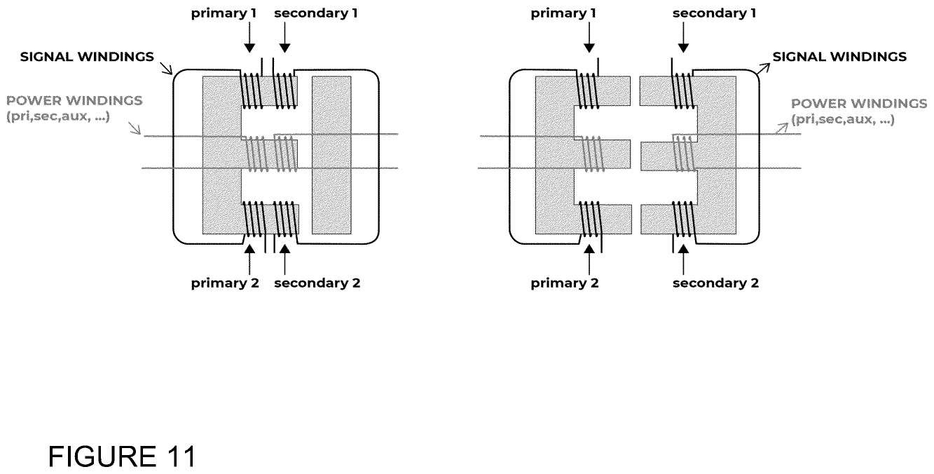

The communication link between the primary side and secondary side of the transformer may be implemented in a number of ways, such as:
Capacitive coupling, in which the signals are transmitted through a capacitive interface. The capacitors may also provide safety insulation between the primary and the secondary sides.
Parasitic capacitive coupling, in which one or more signal capacitors are substituted by the parasitic capacitance between the primary and/or auxiliary and/or secondary windings of the power transformer.
inductive coupling, in which a signal transformer, composed by two or more windings, is used to transfer signals between primary and secondary sides.
integrated power and signal transformer, as shown in FIG. 11, in which signal windings may be wound on the power transformer in order to benefit from the benefits of a transformer based on a ferrite core, without the need of using an additional core. Each signal winding may be realized by two windings in series, wound around the core in order to be sensitive to the magnetic flux generated by the other signal winding, and to cancel and reject the magnetic flux generated by the power windings, that would otherwise add noise to the signal.

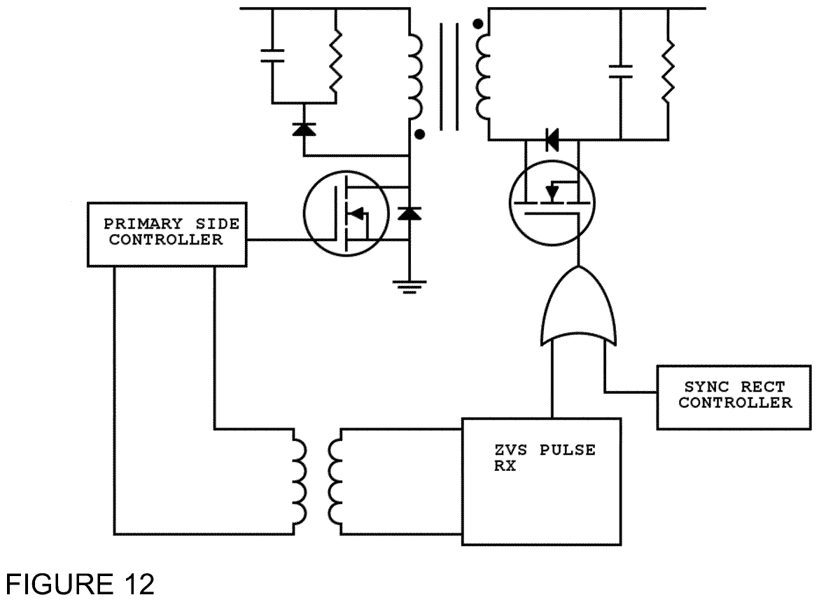

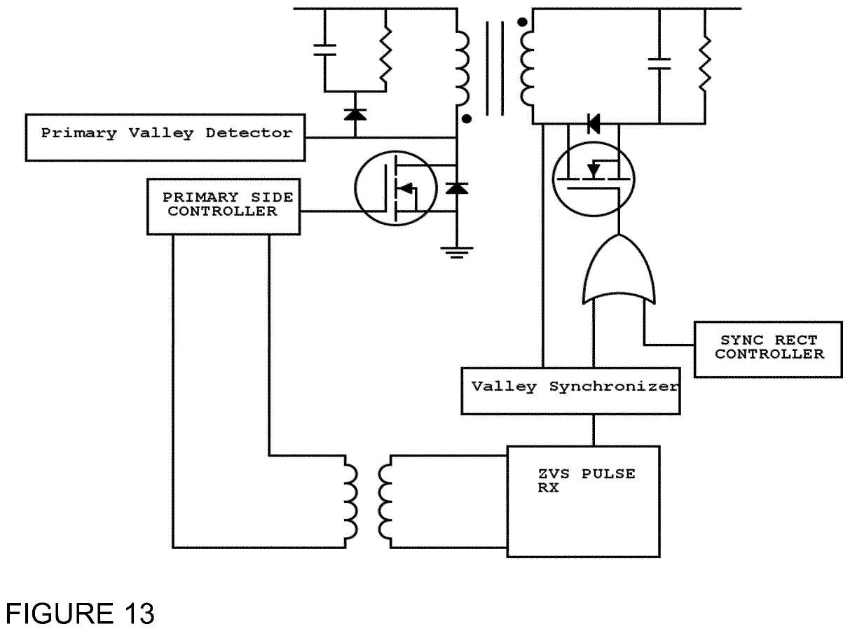

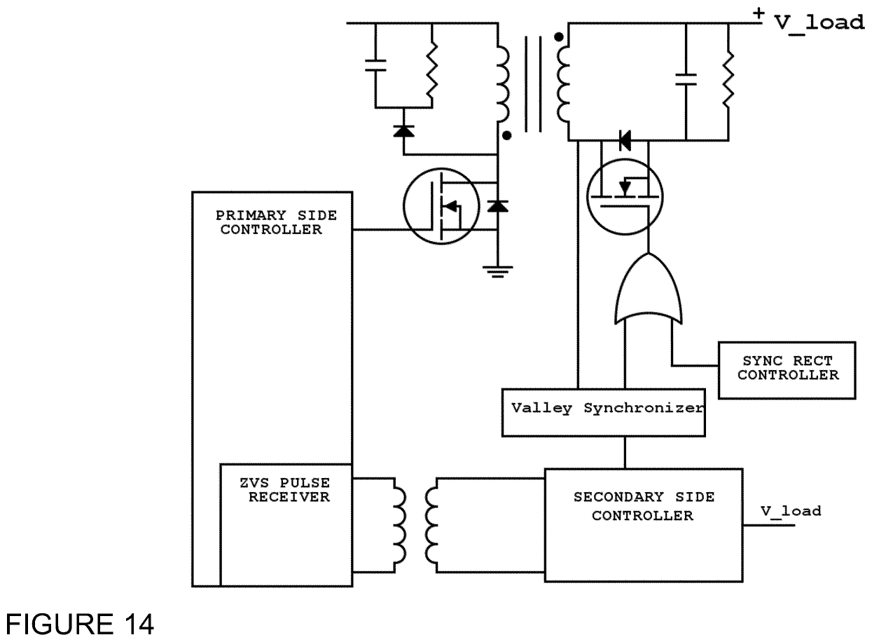

The inductive signal link implementations of the schemes described above in points A, B and C are also illustrated in FIGS. 12 to 14.

### Hardware Configurations

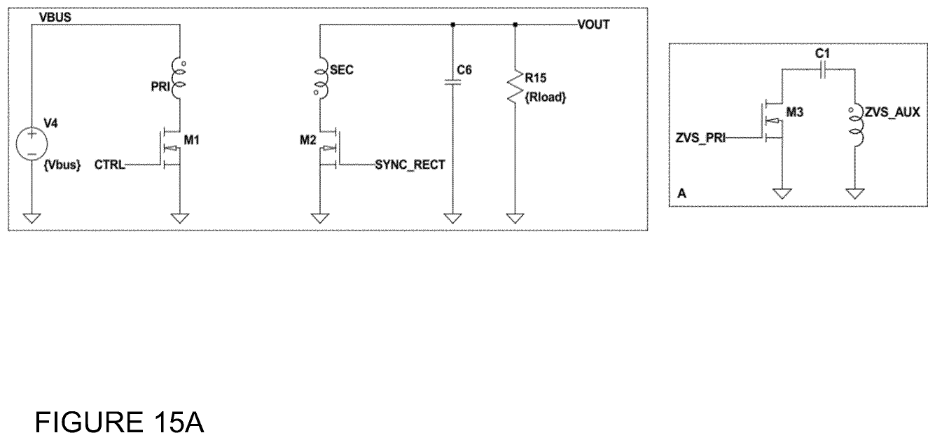

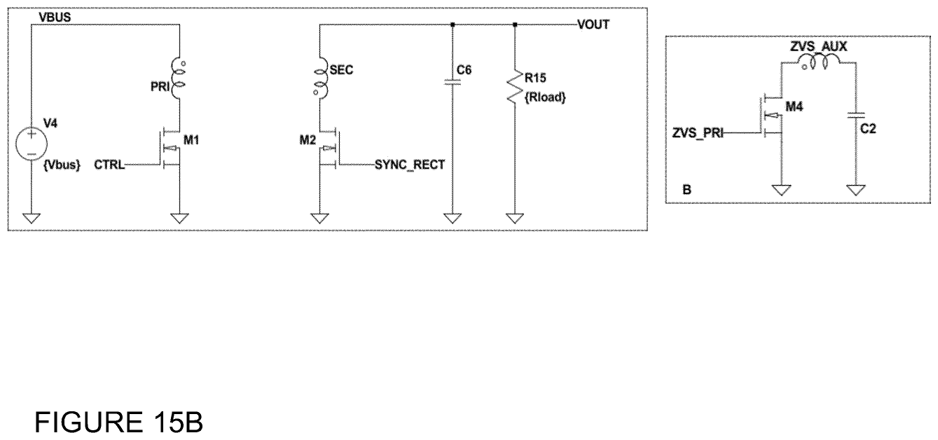

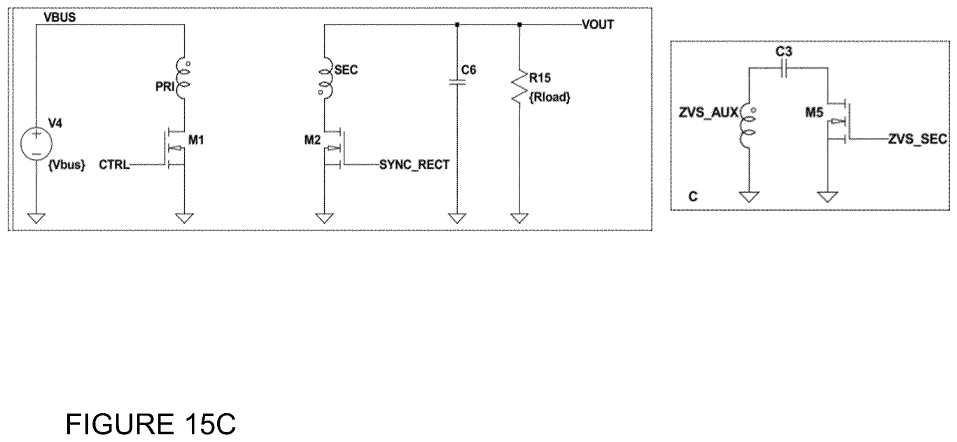

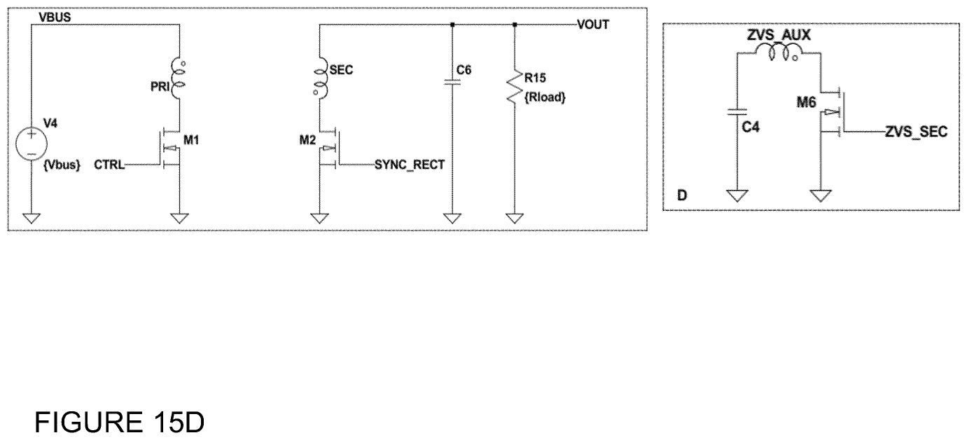

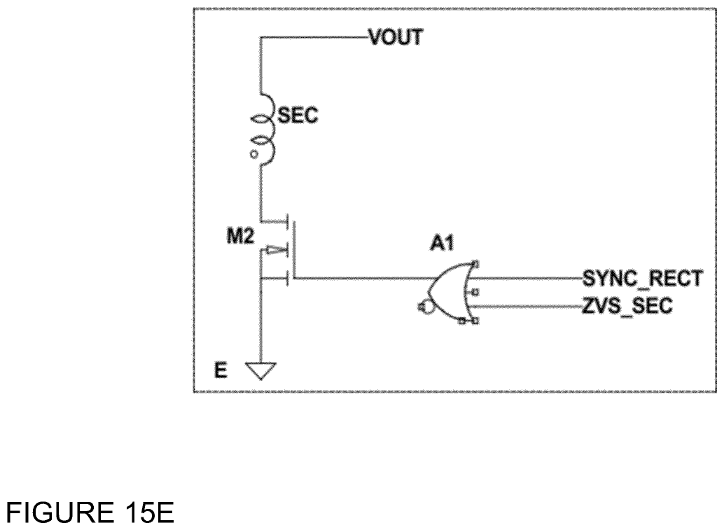

The control schemes presented above may be implemented using a number of circuit configurations, as shown in the examples of FIGS. 15A to 15E.

Although the figures presented in the different sections of this document often show for illustration purposes a generic ground symbol for the primary, secondary, and auxiliary circuits. The primary, secondary and auxiliary circuits may not always share the same electric ground and the architectures presented may also apply to insulated converters comprising independent circuits that do not share the same ground.

One or more additional MOSFETs (and/or any other electric switches) are configured to connect/disconnect to an auxiliary winding from a dedicated circuit or to also short-circuit the auxiliary winding. The auxiliary winding may either be located at the primary side (See FIGS. 15A and 15B) or at the secondary side (see FIGS. 15C and 15D) of the transformer.

The secondary winding may be driven by combining a rectification signal and a signal configured to induce ZVS on the primary switch. The combination of the signals is implemented using an OR logic gate, as shown in FIG. 15E.

Other windings, i.e. windings used to rectify auxiliary voltages, may also be driven by combining a rectification signal and a signal configured to induce ZVS on the primary switch.

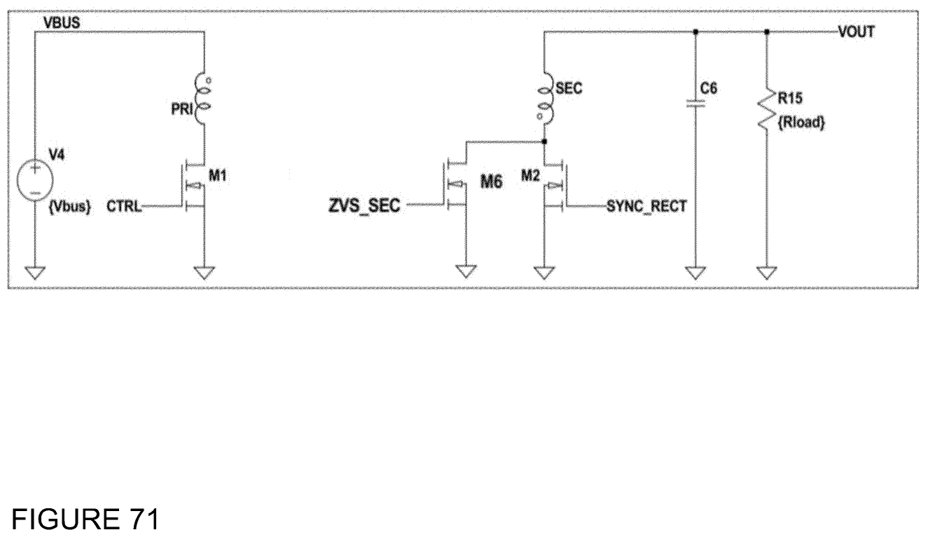

Further control schemes are described in Section VI below and illustrated via FIGS. 71-73.

Flyback Converter with Regenerative Clamp

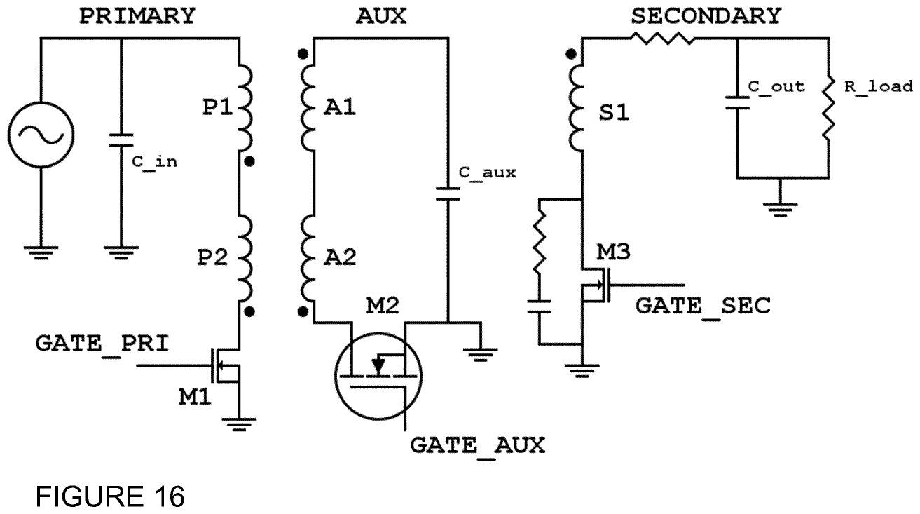

FIG. 16 shows a proposed flyback architecture with regenerative clamp. The architecture comprises a transformer including a primary, an auxiliary and a secondary winding.

The auxiliary winding is configured to have a high—almost ideal (k=1)—mutual coupling with the primary winding.

The primary (P1, P2) and the auxiliary (A1, A2) windings may be made of bifilar wire and split into two asymmetrical halves, for example NP1:NA1=1, NP2:NA2=1, NP1:NP2>1. The main primary has the two halves in series, and the auxiliary primary has the two halves connected in anti-series, thus resulting in a low voltage winding with an extremely high coupling coefficient with the main primary.

In this Configuration:
Both primary sub-windings P1 and P2 are in flyback configuration with the secondary winding;
The auxiliary sub-winding with the higher number of turns is in forward configuration with the secondary winding;
The auxiliary sub-winding with the lower number of turns is in flyback configuration with the secondary winding;

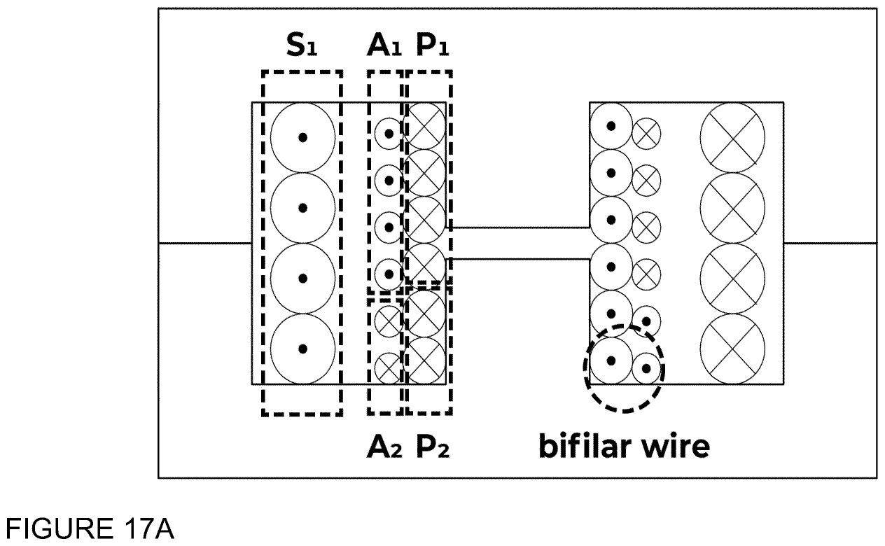

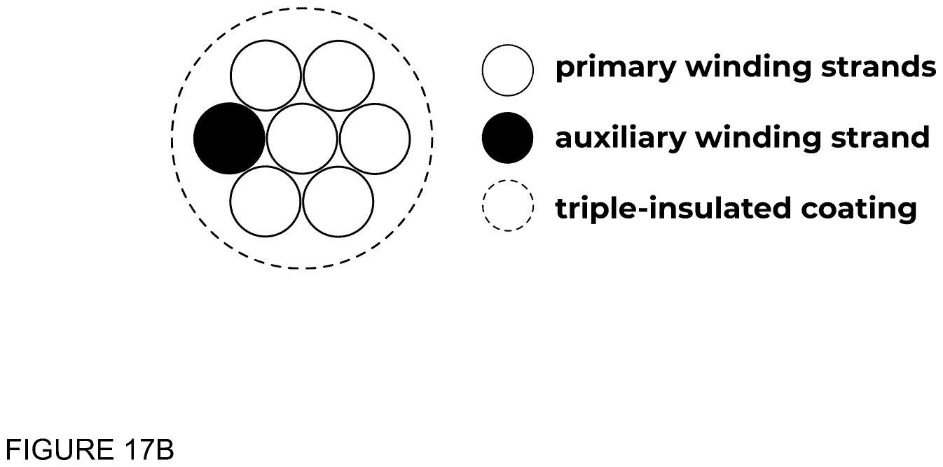

A possible scheme for this five-winding configuration is shown in FIG. 17A.

Since the main primary and auxiliary winding are configured to have a high coupling, the needed clamping action on the primary side is performed by simply rectifying the voltage on the auxiliary primary winding. In this way, all the energy which cannot couple to the secondary winding is simply recovered into the auxiliary capacitor C_aux.

The energy stored in the auxiliary capacitor C_aux may then be used to supply the primary side logic and/or controllers.

The antiseries configuration between A1 and A2 is intended to generate an auxiliary voltage roughly equal to the output voltage multiplied by the turn ratio between the difference of the two auxiliary turns (NA1−NA2) and the secondary winding number of turns NS1, so Vaux=Vout*(NA1−NA2)/NS1. The ratio NA1:NA2 can be chosen according to the output voltage and the desired auxiliary voltage.

The rectification switch M2 of the auxiliary circuit may be a diode, or a switch controlled synchronously or by an ideal-diode controller.

If a switch is used, the auxiliary circuit may play a double role, working both as a regenerative clamp (as described in this chapter) and as a circuit supposed to force a ZVS pulse on the primary side switch (as described in the forced primary ZVS chapter).

Bifilar or n-Filar Wire Implementations

A bifilar or n-filar wire may be used for the primary and auxiliary windings to ensure high coupling.

“n-filar wire” refers to a wire obtained by pairing n individual wires. Each of the n individual wires may be realized in a number of ways, including but not limited to: single/multi-strand wire; insulated/not insulated strands; copper/other metal strands; litz/standard wire; externally coated/not coated wire, triple-insulated/not triple insulated wire coating.

Examples of implementations for the primary and auxiliary bifilar wire include:
primary winding: litz wire with external coating; auxiliary winding: single strand wire with external coating; the two coatings may be joined in order to provide a reliable mechanical pairing between the two windings
as shown in FIG. 17B, primary winding: litz wire composed by a number of individually-insulated strands; auxiliary winding: single strand indifferently insulated or not insulated wire; primary and auxiliary windings are grouped together and protected by an external triple-insulated coating, providing safety insulation towards the core and the other windings of the transformer;
primary winding: litz wire composed by a number of individually-insulated strands; auxiliary winding: single strand indifferently insulated or not insulated wire; primary and auxiliary windings grouped together and coated with a simple non-triple insulated coating. The safety insulation between the primary side and the secondary side of the converter is ensured realizing the secondary winding with triple insulated wire;
primary winding: standard (non-litz) wire with external coating; auxiliary winding: single strand wire without external coating; primary and auxiliary windings grouped together and protected by an external triple-insulated coating, providing safety insulation towards the core and the other windings of the transformer.

### Phase Shift Regulation

Referring to the scheme of the flyback in FIG. 1, a standard control and a phase shifted control are compared. Note that while in both cases the primary side switch M1 is driven by identical signals, the output voltages are different: the phase shift control technique is explained below.

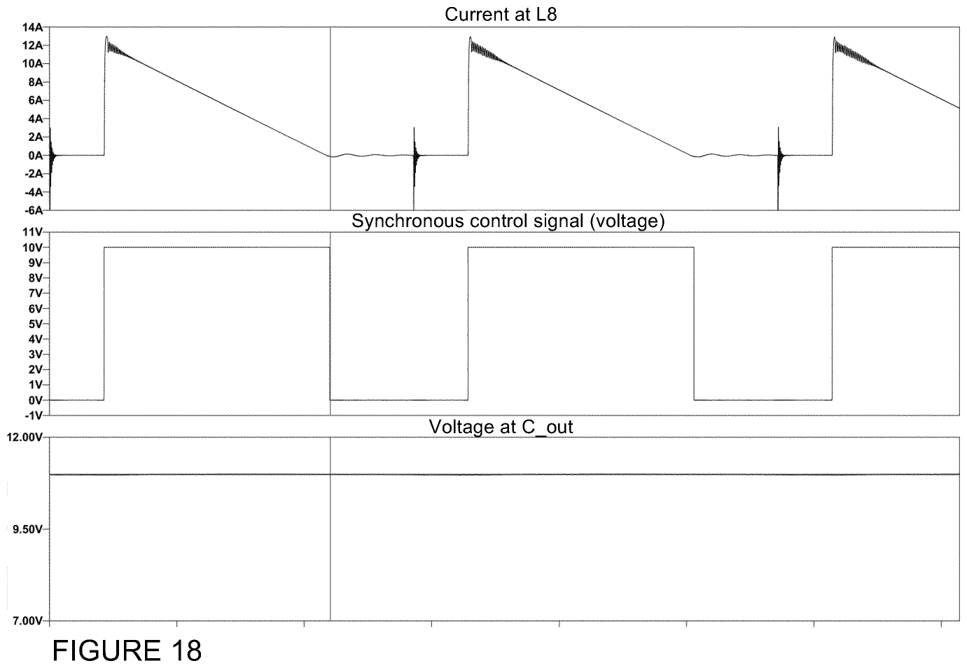

FIG. 18 shows waveforms illustrating a standard regulation where the rectifying switch M2 (See FIG. 1) is used as an ideal diode, so that M2 is turned ON when the secondary winding would force a current through the body diode of the switch, and M2 is turned OFF when the current is close to zero and is about to start flowing in the other direction.

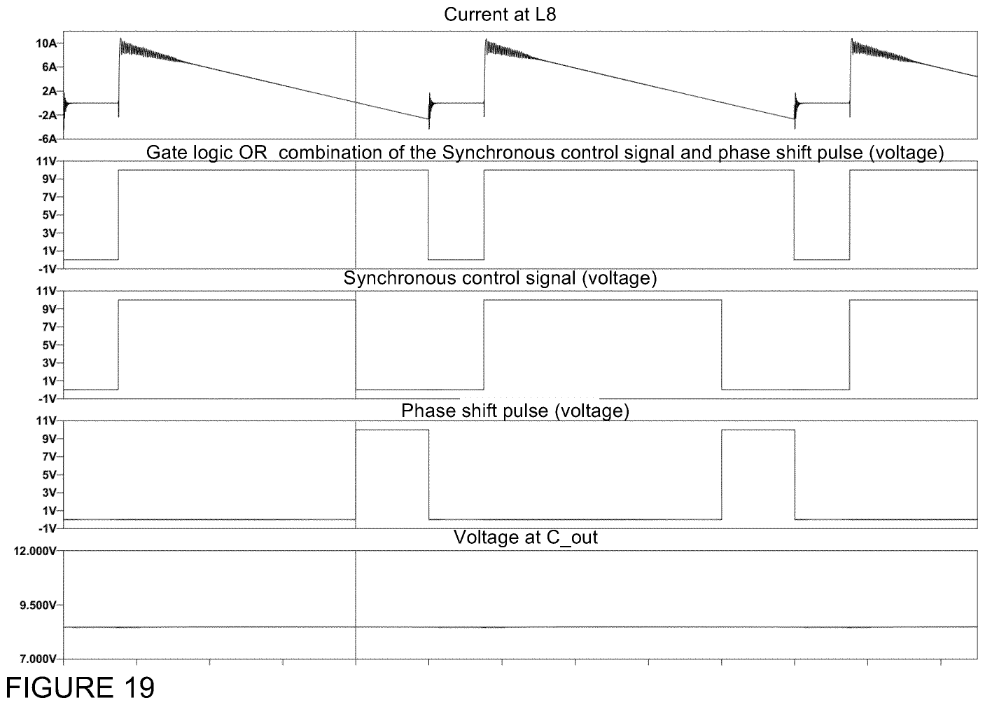

FIG. 19 shows waveforms illustrating a phase-shifted regulation, where the secondary switch M2 (See FIG. 1) is turned ON when the body diode starts conducting current, and is turned OFF after the current has changed sign. The more the turn-OFF front is delayed from the current zero-crossing, the more reactive energy is sent back into the transformer, delivering less power to the load.

This technique can be implemented in a number of different ways, such as a secondary side fast control unit coupled either with an open loop (not regulated) primary switch driving, or a slow primary switch control loop. With “fast” or “slow” control, we refer to the converter's loop crossover frequency: as long as traditional converter's crossover frequencies are usually limited by the low-frequency pole introduced by the optocoupler-based feedback, and is rarely greater than 5 kHz, a secondary side regulation may overcome this limitation and achieve converter crossover frequency up to 10 kHz or above.

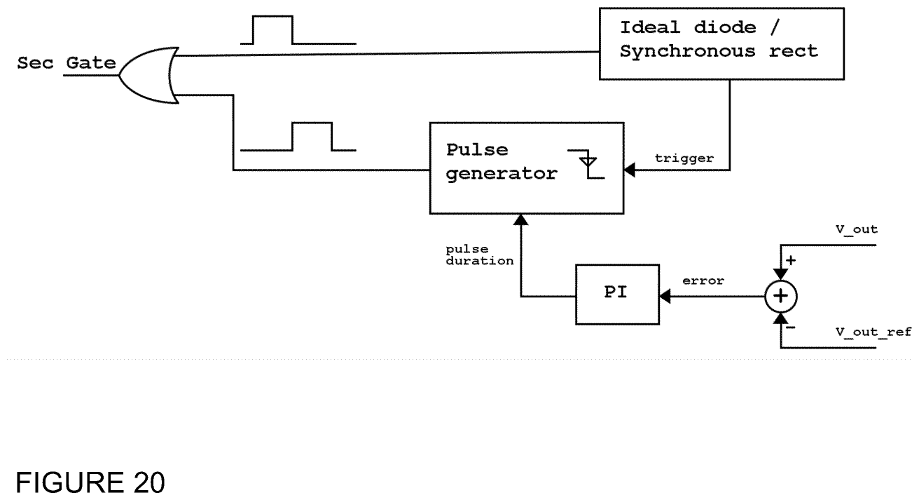

FIG. 20 shows an implementation of a phase shift regulation, where the output voltage control loop is realized on the secondary side. The secondary side rectifying switch M2 is driven by combining the following two signals using an OR logic gate:
a signal generated with a “standard” ideal diode or synchronous control approach, i.e a signal that is high during a specific amount of time in which the current of the secondary switch flows between the source-to-drain terminals (“diode conduction”),
a control or pulse signal or pulse control signal whose positive front corresponds to the other signal's negative front, and with a duration that is defined by a PI, PID or another controller. The control or pulse duration is then used for the output voltage regulation, as the longer it is, the more energy will be reflected back to the primary side, therefore resulting in a lower output voltage.

### Auxiliary Voltage Generation

While the main role of a power converter is to generate one or more AC or DC output voltages starting from an AC or DC input, the converter may also be configured to generate one or more low voltage rails to supply the analog and digital parts of a control circuit. These low voltage rails, usually low voltage and low power, are referred as “auxiliary voltages”.

Auxiliary voltages are commonly generated thanks to one or more auxiliary windings connected to a dedicated circuit. The auxiliary winding may be connected in forward or flyback configuration with the other windings of the transformer.

Flyback converters often comprise an auxiliary winding in forward configuration with the secondary winding, in order to generate an auxiliary voltage, with the auxiliary voltage being proportional to the converter output voltage. In case of a converter with a variable output voltage (ie. a USB Power Delivery AC/DC adaptor providing 5V, 9V, 15V, 20V, 48V etc. negotiable output voltages), the auxiliary voltage may present a broad range of values according to the converter's working point. In order to obtain a fixed voltage, an inefficient linear regulator is needed.

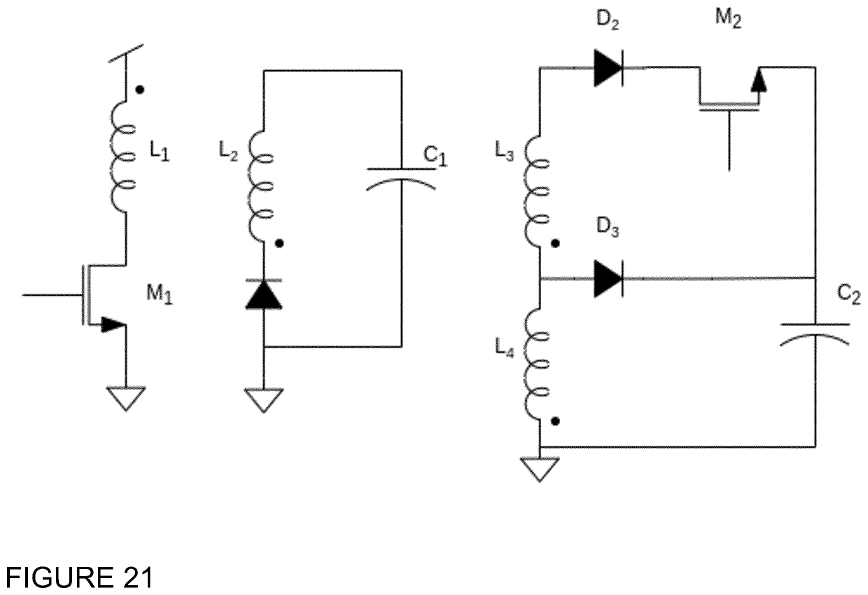

FIG. 21 shows a solution using two auxiliary windings (L3 and L4, while L1 and L2 are respectively the primary and the secondary windings) with the aim of improving the efficiency of the circuit at both high and low output voltage.

The auxiliary windings L3 and L4 are in forward configuration with the secondary winding L2. When the secondary winding L2 is conducting current towards the output capacitor C1, both L3 and L4 each copy a voltage that is proportional to the output voltage.

With high output voltage, L4 is able to generate an acceptable Vaux voltage so M2 can disconnect L3 from the circuit. So, L4 voltage is rectified into the auxiliary capacitor C2.

With low output voltage, L4 generates an insufficient voltage, but the series of L3 and L4 can generate the right voltage, M2 is turned on. So, the sum of L3 and L4 voltages is rectified into the auxiliary capacitor C2.

A similar approach may be used with auxiliary windings connected in a forward configuration with the primary winding: in this case the double winding approach (using L3 and L4 both in a forward configuration with L1) also provides an acceptable auxiliary voltage at different input voltages, in an efficient way.

### Auxiliary Voltage Single Winding Solution (for Transformer-Based Converters)

Although the double winding approach may be used to generate auxiliary voltages in applications where the input and output voltages have a wide range, single winding approaches may also be used for providing low cost solutions.

A single winding approach may help in order to reduce the cost of the transformer as well as to reduce the waste space in the transformer winding area. In this case, the diameter of the wires may also be increased in the windings.

A single winding approach may use a switch (or MOSFET, BJT, etc.) in order to activate and deactivate the winding from a rectifier circuit. When the switch is off, no current flows in the circuit, and thus there is no need to limit or dissipate power.

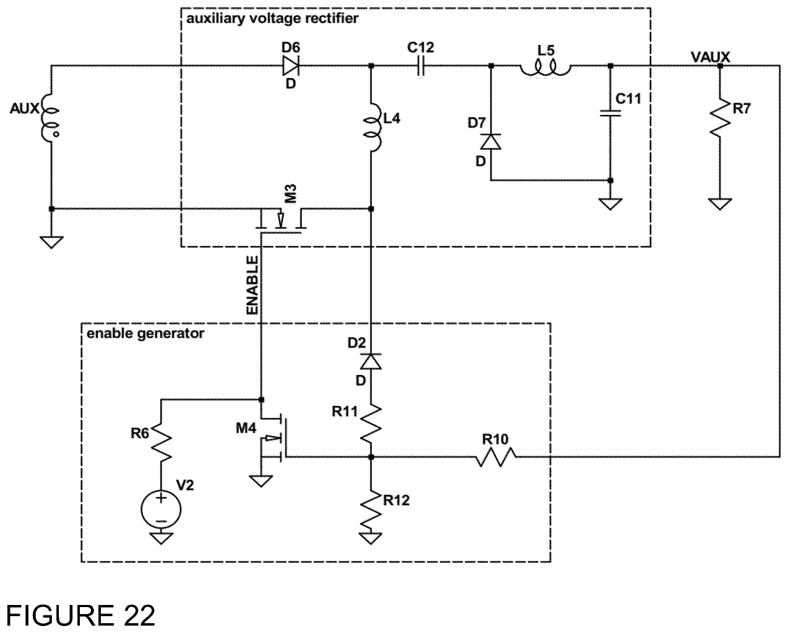

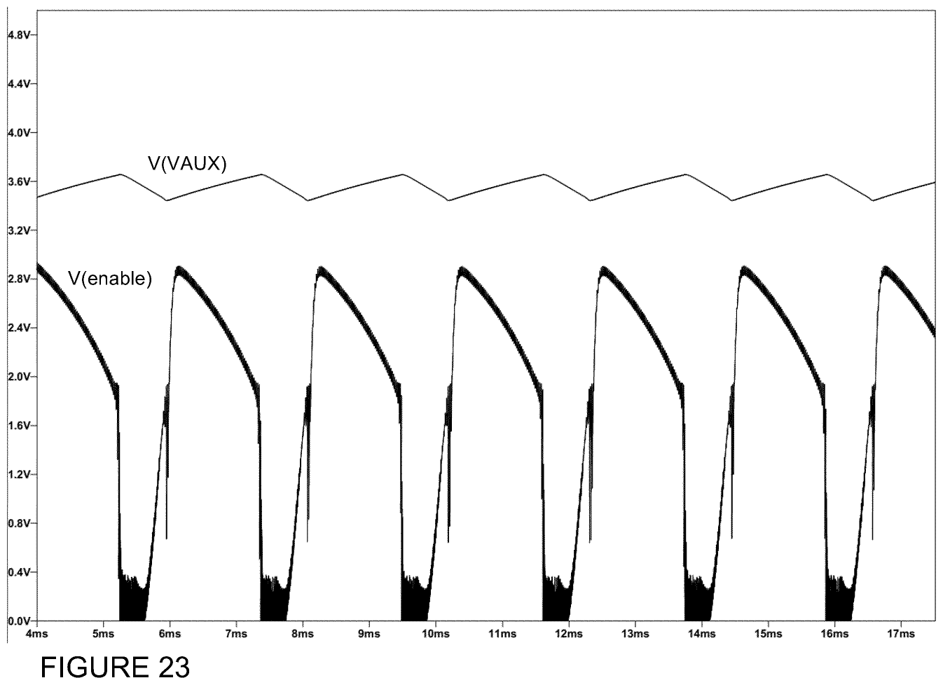

FIG. 22 and FIG. 23 show an example of an auxiliary voltage circuit based on a rectifier that can be enabled or disabled by the MOSFET M4, and the corresponding voltage plot. The “enable” signal can be generated by an external controller, or with a dedicated circuit.

FIG. 23 shows an example of a closed-loop solution where the “enable” signal is high when the Vaux is greater than a threshold and vice versa.

Hysteresis may be present (in this example provided by R11 and D2): setting higher hysteresis (small R11 value) will generate a lower frequency “enable” signal, with a consequential bigger output ripple. Thus, in this configuration, M3 is neither supposed to switch at high frequency (as in a switching regulator), nor to be driven in the saturation region (as in a linear regulator), but is simply a low frequency enable or disable switch.

### Auxiliary Voltage Capacitive Solution (for Switching and Resonant Circuits)

Thanks to circuits connected to hard switching and/or soft/switching and/or resonant nets, auxiliary voltages may be obtained without the need of auxiliary windings in the transformer. The proposed approach may therefore generally be applied both in transformer-based and transformer-less converters.

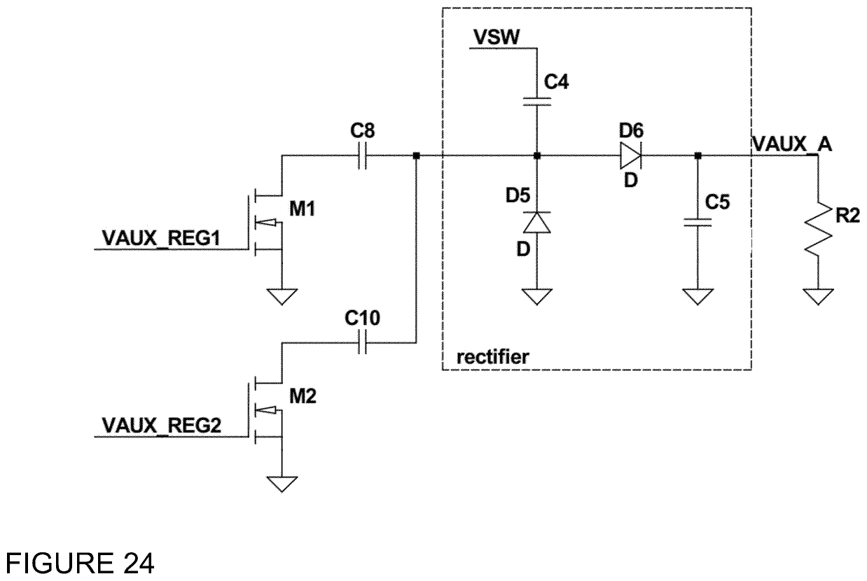

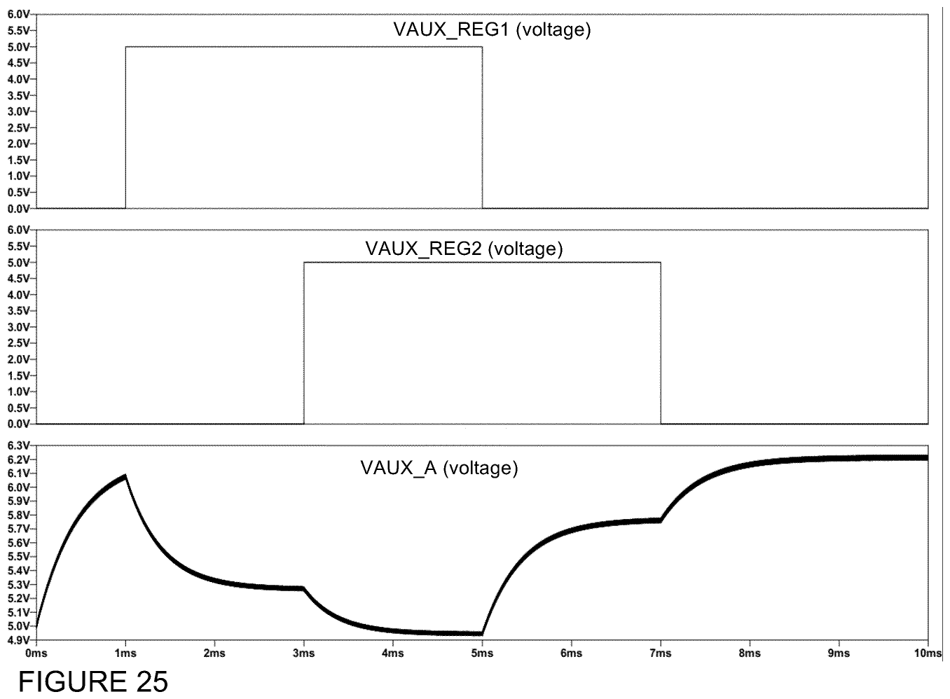

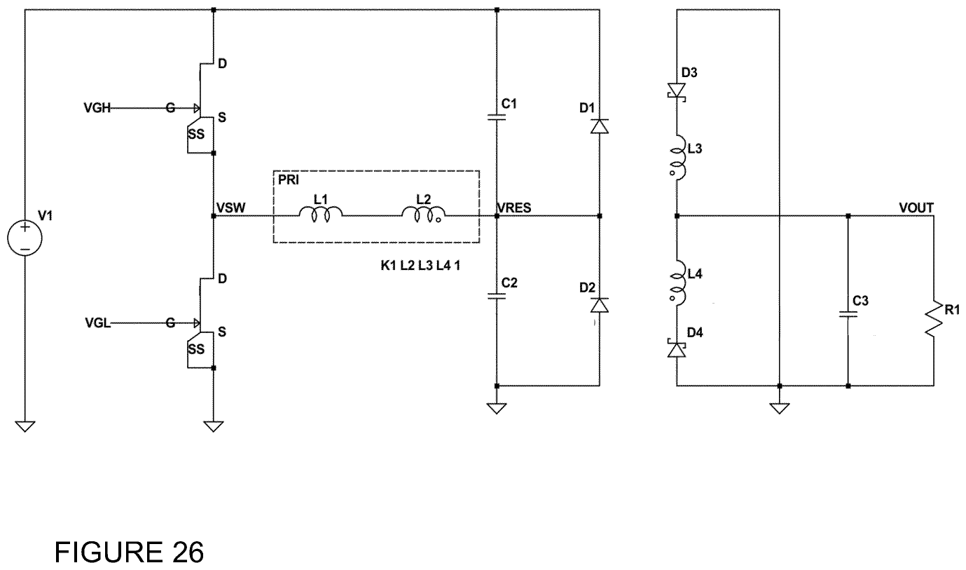

FIG. 24 and FIG. 25 show an example of a rectifier capable of extracting an auxiliary voltage from a switching or resonant net (for example VSW or VRES of an LLC converter, as the one in FIG. 26). During VSW positive fronts, C4 charges till a voltage equal to VSW-VD5 (current through D5 and C4), while during negative fronts C4 discharges till VSW−VAUX_A−VD6 (current through C4 and D6), where VD5, VD6 are the forward voltages of diodes D5, D6. Diodes D5, D6 may be substituted with FETs in order to reduce conduction losses.

In order to control the output voltage, one or more capacitors in parallel to D5 may be connected and/or disconnected. One or more switches, including but not limiting FETs (M1, M2) can be opened/closed in order to connect the related capacitor (C8, C10).

Capacitors in parallel with D5 will create parallel current paths both during VSW rising fronts (current path in parallel with D5) and during VSW falling fronts (current path in parallel with D6), so C4 charge/discharge capability will be decreased and it will deliver less current to the output.

### Section II. Active Storage

A single magnetic AC/DC converter with PFC capabilities and improved efficiency is now described.

### Auxiliary Storage Winding (Flyback Configuration)

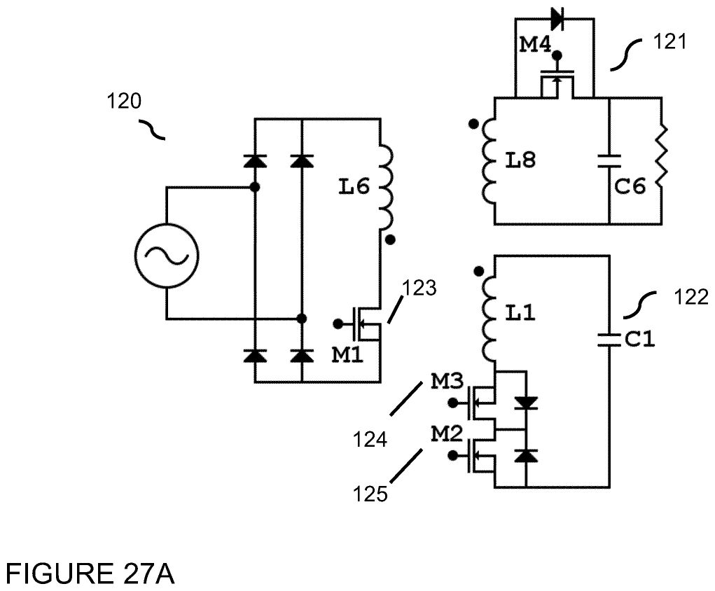

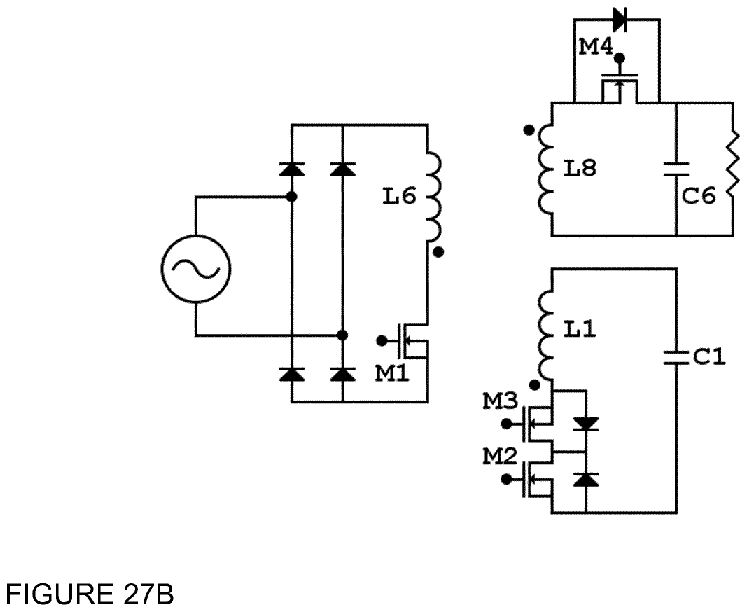

With reference to FIG. 27A, a single magnetic AC/DC converter is provided comprising a transformer including a primary winding L6, a secondary winding L8 and an auxiliary storage winding L1.

Note that the auxiliary storage winding (or simply auxiliary winding) described in this section must not be confused with the concept of an auxiliary winding used to generate an auxiliary voltage (a low-power voltage rails used to supply the control circuits).

The architecture is based on a flyback-derived topology. Different switching modes of operations are possible, such as quasi-resonant and induced ZVS driving.

The auxiliary side circuit 122 has several goals, including but not limited to:
It allows the creation of a parallel PFC circuit.
It allows the control of the output voltage.
It allows for ZVS turn on of the primary switch or MOSFET 123 on the primary side circuit 120 as it is possible to create ZVS pulses able to discharge the drain of the primary MOSFET 123. We'll also refer to the primary MOSFET as M1. The primary side circuit may also be referred as the main circuit.
Because the auxiliary circuit 122 is on the primary side together with the primary circuit, there are no requirements of safety isolation. For this reason, the driving and the communication is easier and cost-effective in comparison with other architectures. To enable this feature, the auxiliary circuit includes a bidirectional switch that comprises two switches or MOSFETS 124 & 125 connected in antiseries. Alternatively, another bidirectional switch may be used. We'll also refer to the two MOSFETs of the auxiliary control unit as the first aux MOSFET or M2 and the second aux MOSFET or M3.
If the coupling between the primary winding L6 and the auxiliary winding L1 is very good (coupling factor k is close to 1), it is possible to store the energy that otherwise would have been lost because of the leakage inductance between the primary side winding and the secondary side winding. In this case, bifilar winding may be used to ensure a very high coupling between the primary side winding and the auxiliary winding.

These different use cases may also be combined together depending on the application requirements.

Any turn ratio between the different windings may be used depending on the application and specifications needed. As an example and with reference to FIG. 27A, the turns ratios are the following: between the primary and secondary windings: Npri:Nsec=6.67 and between the primary and auxiliary windings Npri:Naux=1.

The choice of Npri:Naux=1 may be easily implemented using a bifilar wire, guaranteeing a very low leakage inductance between the two windings.

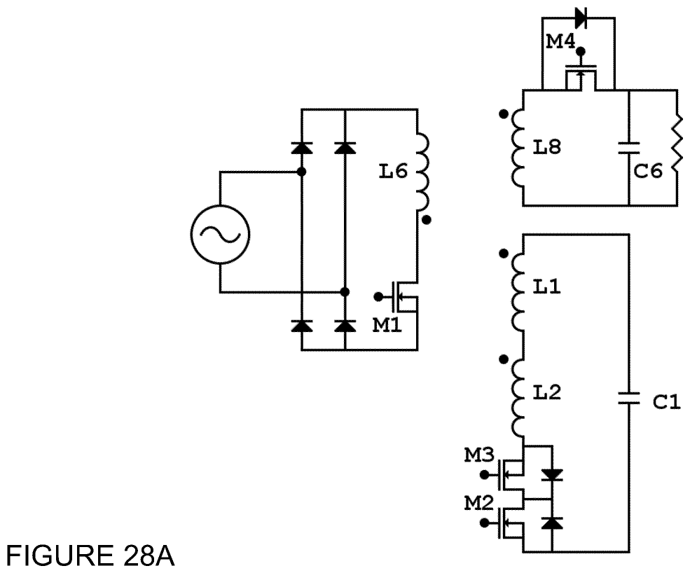

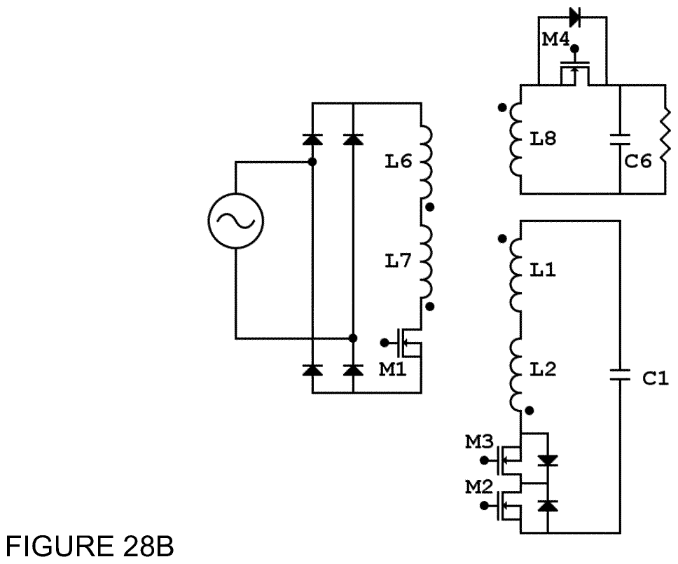

Alternatively, using a trifilar wire (the main primary and 2 auxiliary windings connected in series, as shown in FIG. 28A) may allow to achieve Npri:Naux=2 in order to boost the auxiliary voltage. Higher voltage is often useful for PFC to store the energy in capacitors maximizing the energy density. The single wires composing the bifilar or trifilar wire may be equal to one another (in terms of material, diameter, number of strands, insulation between the strands, etc.).

Depending on the application, when Npri:Naux<1 is required (which means that the main primary voltage is higher than the auxiliary voltage), the bi-filar auxiliary winding may also be partially in series and partially in anti-series (See FIG. 28B), in order to achieve simultaneously high coupling factor k (thus, high efficiency) and lower auxiliary winding inductance.

### Converter's Working Phases

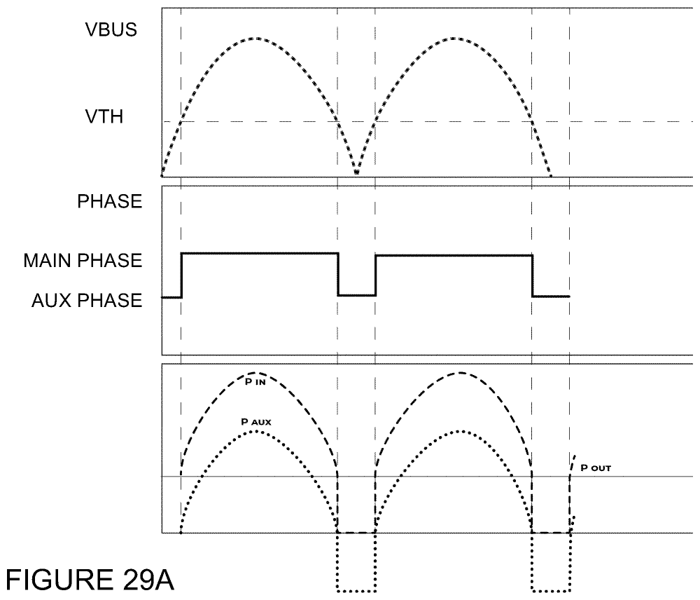

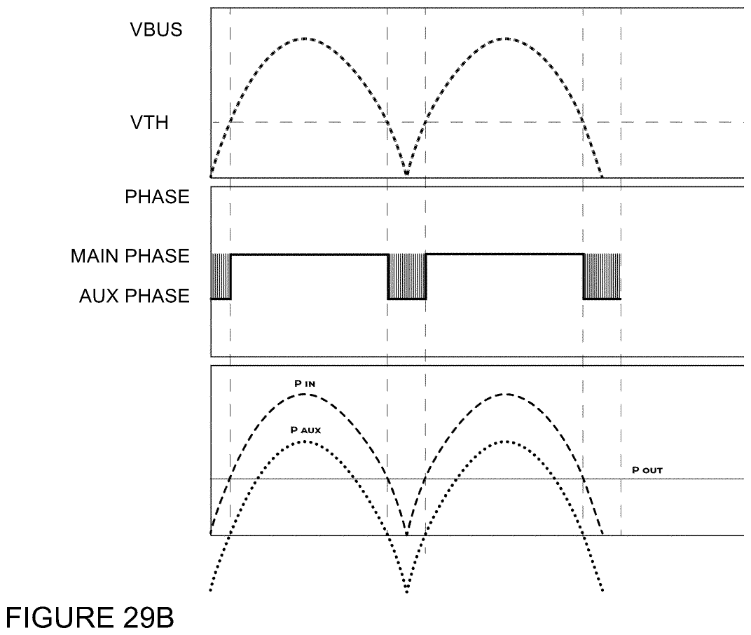

With reference to FIG. 29A, the circuit is analyzed in two different phases, namely the main phase or “MAINphase” and auxiliary phase or “AUXphase” depending on the voltage level of the rectified input voltage “V_{BUS}” in comparison with a threshold voltage “V_{TH}”. When the input voltage “V_{BUS}” is higher than a predetermined threshold voltage “V_{TH}”, the converter works in the “MAINphase”; when “V_{BUS}” is lower than “V_{TH}” the converter works in the “AUXphase”.

The value of “V_{TH}” may be related to the energy absorbed by the load and the energy provided by the grid for each instant:
When the rectified sinusoidal input voltage (V_{BUS}) is high enough for the converter to transfer from the primary side the whole power requested by the output load, the converter works in the “MAINphase”;
When the input voltage (V_{BUS}) is too low, and the converter is not able to transfer from the primary side the whole power requested by the output load, the converter works in the “AUXphase”.

We will now describe how the converter works during the two phases:
During the “MAINphase”, the main power stage (L6-M1) both supplies the secondary stage (L8-M4-Rload), and stores some extra-energy into the aux stage (L1-M2-M3-C1) simultaneously.
In particular
   the main power stage absorbs current from the mains like a PFC control, guaranteeing a high power factor (close to 1)
   the aux stage is controlled in order to absorb the difference of energy between the energy requested by the load and the excess of energy coming from the input
   the energy in excess is stored in the storage capacitor C1.
During the “AUXphase”, the main power stage is off so no energy is absorbed by the mains; the energy requested by the load is entirely given by the aux stage, delivering the energy previously stored in the storage capacitor.

In the “MAINphase”:
M1 is driven by the PFC controller to achieve unitary Power Factor. As in a flyback converter, the energy is stored into the transformer during the switch ON-time (and will later be rectified by the secondary and/or auxiliary stages);
M4 is driven as an “ideal diode” (ON when the secondary winding L8 would force the current to flow from source to drain), in order to rectify L8 voltage to the C6 output capacitor.

From a logic point of view, an ideal diode-controlled switch can be considered as a diode, while the ideal diode driving is capable of decreasing the voltage drop across the switch and so the conduction losses.
M2, M3 are connected in anti-series, so their positions can be switched. In particular:
   M2 is driven as an ideal diode (same notes discussed for M4), in order to rectify L1 voltage to the C1 storage capacitor.
   M3 is driven to direct the power from the primary side to the secondary side and/or to the storage capacitor.
   When M3 is OFF, the auxiliary winding is kept floating and no energy is rectified from it. So, the input energy from the main power stage is entirely delivered to the load.
   When M3 is ON, the input energy is shared between the secondary stage (load) and the auxiliary stage (storage).
   Thus, M3 duty cycle can be used to regulate the output voltage: a higher duty cycle will keep the auxiliary stage enabled for longer, with a consequent lower output voltage and higher storage voltage.

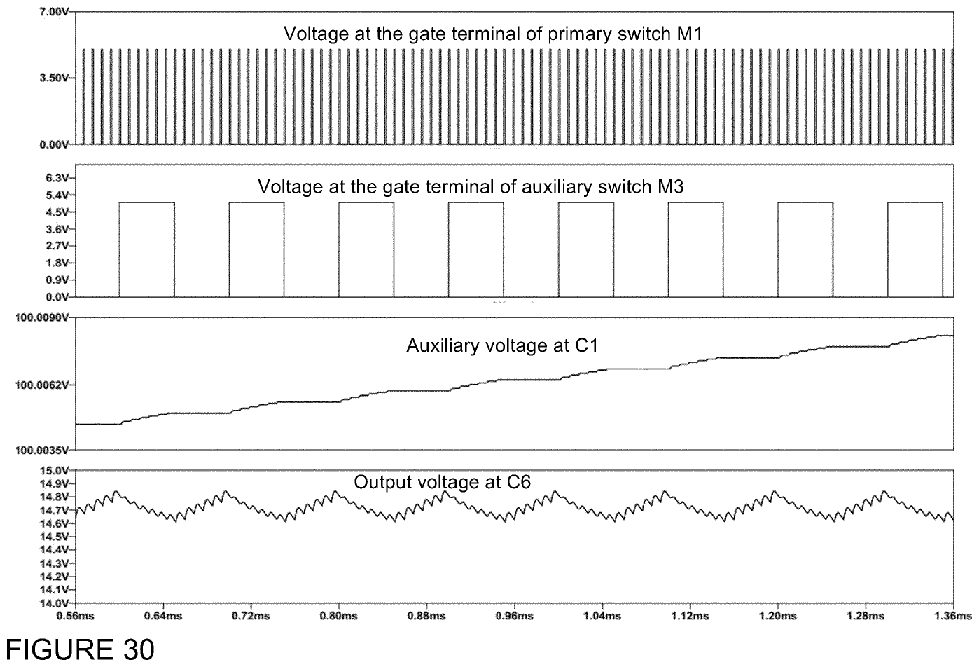

The electric signals during the “MAINphase” are shown in the plot provided in FIG. 30.

In the “AUXphase”:
M1 is OFF. From a logic point of view, the primary winding L6 does not play a relevant role in the power transfer phase.
M2 is driven to provide a regulated output power. In fact, the coupling between the auxiliary and the secondary windings L1 and L8 behaves like a forward converter, where the storage capacitor is the power source, M2 and L1 are the energizing elements sending power to the rectifier composed by L8, M4 and C6.
The freewheeling of the energy stored in the parasitic leakage inductance of the L1-L8 forward transformer is done through M1 thanks to its embedded diode (or any equivalent source-to-drain conduction mechanism).
M3 is always ON in order to never inhibit M2, or may also be driven with the same M2 driving signal.

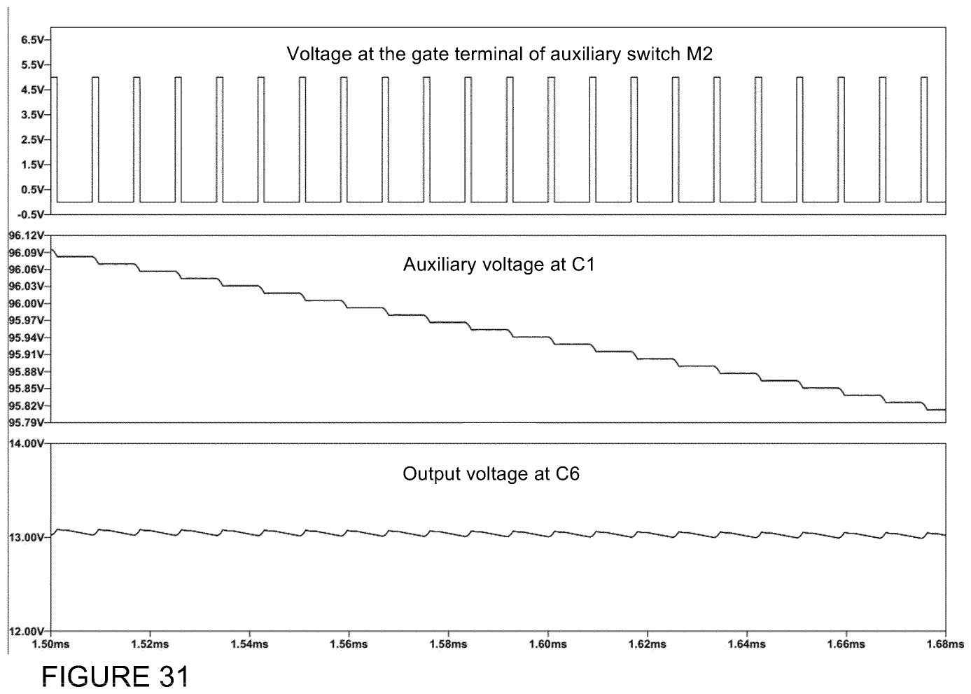

FIG. 31 shows a plot of the electric signals during the “AUXphase”.

### Explanation of the Control

One goal of the AC/DC converter is to guarantee a constant power delivered to the load (typically the load is supplied with constant voltage or constant current) while absorbing energy in a sinusoidal manner in order to ensure a high power factor.

Traditionally, this result is obtained with a PFC converter in series with an insulated converter.

The proposed implementation is able to achieve the same goal with a single converter.

Considering the power balancing among the three networks, we have:

$${P}_{I N} ( t ) = {P}_{A U X} ( t ) + {P}_{O U T} ( t )$$

Under the assumption that the load absorbs a constant power, we have:

$${P}_{I N} ( t ) = {P}_{A U X} ( t ) + {P}_{O U T}$$

In order to achieve a simple PFC, the controller on the main power stage (M1) will absorb an input power proportional to the input line voltage (sine wave at fₗᵢₙₑ), so rearranging the terms of the previous equation, we have:

$${P}_{A U X} ( t ) = {P}_{I N} ( t ) - {P}_{O U T}$$

In other words, the controller on the auxiliary stage (M2, M3) will absorb a power proportional to P_{IN} (t) with a constant offset given by E_{OUT}. FIG. 29A clearly depicts the phases and the power signals of the converter of two different control methods:

### Control Method A (FIG. 29A)

when V_{BUS}(t)≥V_{TH}, the converter works in the “MAINphase”
   During this phase, P_{IN}(t)≥P_{OUT}; in this phase, following the previous equation, the absorption of P_{AUX}(t) is proportional to P_{IN}(t) downsized of P_{OUT};
when V_{BUS}(t)≥V_{TH}, the converter works in the “AUXphase”
   During this phase, P_{IN}(t)=0; following the previous equation, we have:
   0=P_{AUX}(t)+P_{OUT}→P_{AU}x(t)=−P_{OUT} negative sign meaning that the power is provided and not absorbed).

### Control Method B (FIG. 29B)

when V_{BUS}(t)≥V_{TH}, the converter works in the “MAINphase”
   During this phase, P_{IN}(t) P_{OUT}; in this phase, following the previous equation, the absorption of P_{AUX}(t) is proportional to P_{IN}(t) downsized of P_{OUT};
when V_{BUS}(t)≥V_{TH}, the converter works in a hybrid mode, toggling between the “MAINphase” and “AUXphase”. During the two sub-phases:
   subphase “MAINphase”: the main power stage absorbs a low (0<P_{IN}(t)<P_{OUT}) amount of power from the input and transfers it to the auxiliary stage and/or secondary stage
   subphase “AUXphase”: the auxiliary stage transfers power to the secondary side

### Alternative Loop Control Techniques

As long as two control loops must be closed (input current control loop for the Power Factor, and output voltage control loop for output regulation), and that the driving of both the primary stage and the auxiliary stage may have an impact on the absorbed and delivered power, two different control approaches can be followed:
As already described, a possible control approach is to drive the primary side MOSFET in order to ensure the PFC, and to drive the auxiliary MOSFET in order to absorb the excess of energy during the main phase (thus to control the output voltage).
An alternative approach is to drive the primary side MOSFET to control the output voltage, and to drive the auxiliary MOSFET to ensure the PFC control.

In comparison with a standard PFC solution, for example based on a boost PFC followed by an insulated DC/DC stage, this circuit has several advantages, including but not limited to:
The auxiliary stage can be modelled as a PFC in parallel with the main primary-to-secondary insulated flyback converter. By contrast, standard PFCs are usually in series with the main insulated converter.
When the PFC is connected in series, the global efficiency is given by the efficiency of the PFC multiplied by the efficiency of the main converter.
By contrast, this circuit is able to achieve a greater efficiency because, for example:
   Most of the energy passes directly from the input to the output as if it was a single stage (without PFC) converter.
   Only the difference of energy between the output and the input passes through the PFC auxiliary winding
   Auxiliary stage works at high voltage (thus low current and high efficiency).
The auxiliary and primary windings have a very high coupling, with a consequent low leakage inductance and low losses due to the freewheeling of the leakage inductance current, increasing the efficiency further.

We now describe some possible alternatives to the above architecture.

### Auxiliary Storage Winding (Forward Configuration)

The auxiliary winding can be connected in a forward configuration with the primary side winding (FIG. 27B). In this case:
During the main phase, the auxiliary side stores energy in the storage element, acting as the secondary side of a forward converter, and the secondary winding is acting as a secondary side standard flyback.
During the auxiliary phase, the auxiliary stage is driven like the primary side of a flyback converter (the switch is turned ON in order to transfer energy from the storage capacitor to the transformer), and the secondary stage simply rectifies the power as a traditional flyback rectifier would do.

### Battery or Supercapacitor as Storage Elements

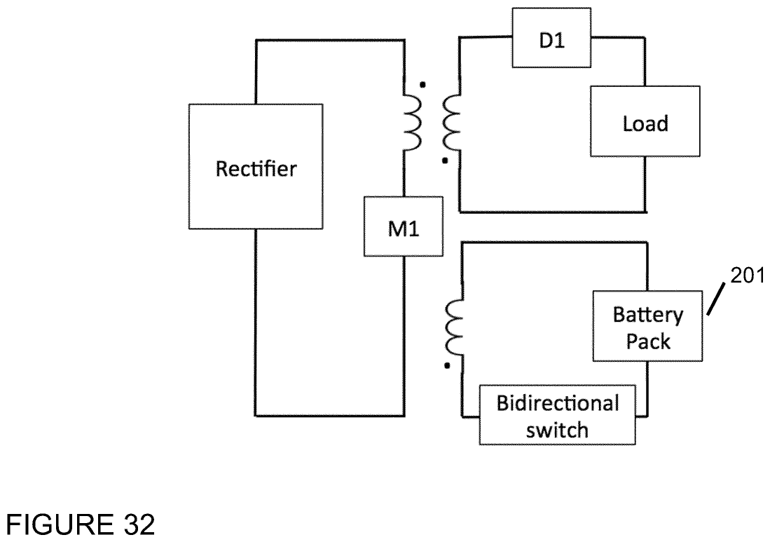

With reference to FIG. 32, the single stage AC/DC converter is illustrated, in which the storage element 201 is a battery pack including one or more battery cells and/or supercapacitors. The advantage of using a battery pack as a storage element includes the improvement of efficiency, the reduction of the size of the storage element, and the reduction of the voltage ripple on the storage element thanks to the greater capacity of a battery, compared to a capacitor.

### Auxiliary Winding and Forced ZVS

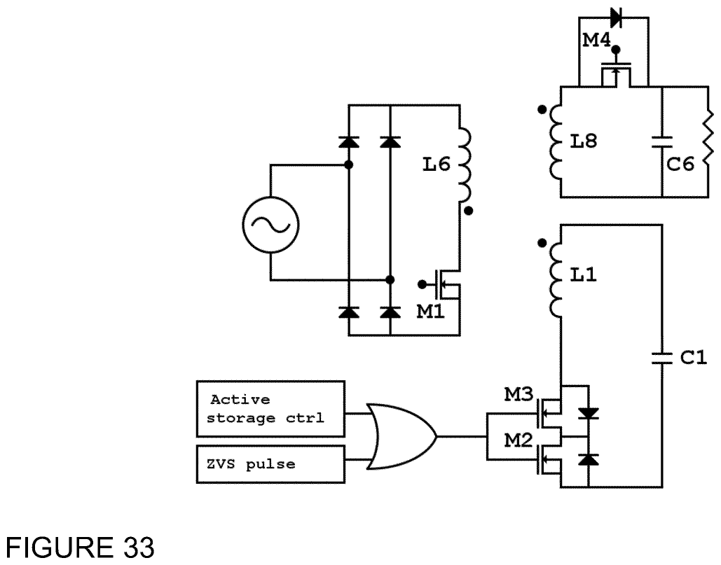

The parallel converter described can be combined with the modified flyback as described in Section I. FIG. 33 shows a possible implementation where the auxiliary switches are driven by the logic OR of two signals:
The ZVS pulse can be set in order to force the depletion of the parasitic capacitance of the primary side switch drain, allowing it to be turned on in ZVS.
The active storage control signal used to enable or disable the auxiliary circuit in both the MAINphase and AUXphase, in order to store or withdraw power in or to the storage capacitor.

Thus, any winding of the converter, including but not limited to a parallel storage auxiliary winding, can be driven in order to force a deep voltage valley at the primary side switch allowing it to turn on under ZVS conditions or near ZVS conditions.

### Section III. Active Parallel Filter

### Secondary Side Storage Element

A typical architecture for a less than 75 W input AC-DC converter often comprises an insulated power converter which is optionally connected to an output converter.

A typical architecture for a higher than 75 W input AC-DC converter with high power factor further includes a PFC stage positioned before the insulated power converter in order to deliver more power.

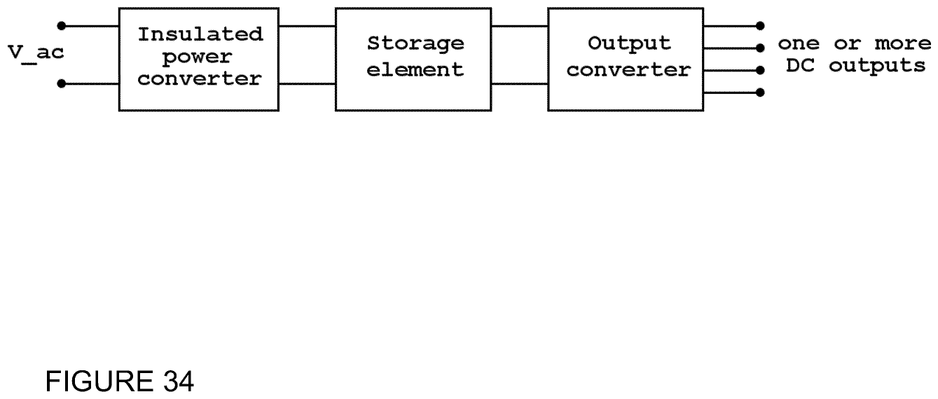

With reference to FIG. 34, an implementation of the invention is an AC-DC converter including an energy storage element on the secondary side of the converter. The storage element is implemented with a variety of technologies, included but not limited to batteries and/or supercapacitors.

In the case of a <75 W input converter, key advantages of this topology include, but are not limited, to the following:
Capability of providing a high level of output power (>75 W) for a time period determined by the state of charge (SOC) of the storage element, while not being forced to introduce a PFC stage: this can be achieved limiting the power absorbed from the mains to values below 75 W, and providing all the extra power that is the delivered to the load from the energy stored in the secondary side storage element. If the energy stored in the storage element is higher than the integral over time of the difference between the output power and the input power multiplied by the efficiency of the converter, then the PFC can be avoid ensuring the same performance of a device with PFC, based on the principle of averaging the energy absorbing more when the load requires less energy and using the energy stored when the device has a higher peak power.
Capability of providing output power for a time period determined by the state of charge (SOC) of the storage element, even when the AC input is not present (i.e. Power bank functionality).
Cheaper insulated power converter, since it can be designed for the average output power instead of the peak output power. In fact, the insulated power converter just needs to transfer the average output power to the secondary side, while the load power peaks can be handled at the secondary side thanks to the storage element, which is capable of providing additional power, when needed.

In the case of a >75 W input converter, key advantages of this topology include, but are not limited, to the following:
Capability of providing output power for a time period determined by the state of charge (SOC) of the storage element, even when the AC input is not present (Powerbank functionality)
Cheaper and very simple insulated power converter designed to achieve high power factor, thus eliminating the need for an additional PFC stage
Cheaper insulated power converter, since it can be designed for the average output power instead of the peak output power

### Use Case Example—Converter without PFC

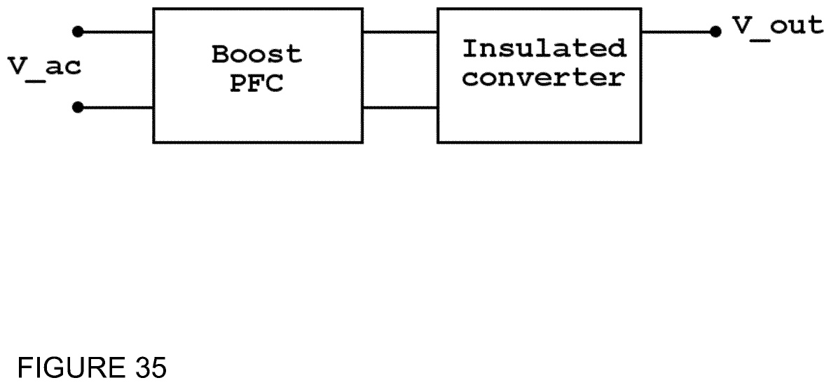

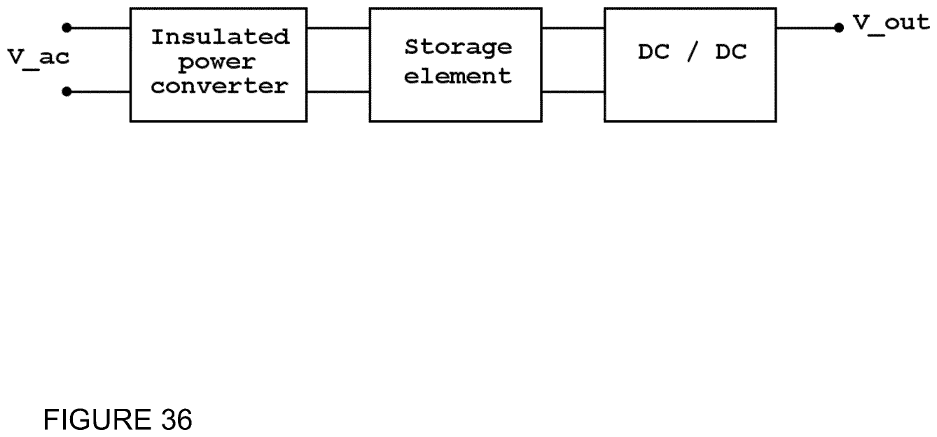

In order to charge the 100 Wh battery of a 16 inch MacBook pro, the following adapters may be used:
A conventional 96 W Apple power adapter (including a PFC), as in FIG. 35;
The proposed power adapter without PFC, composed of an insulated power converter with nominal continuative output power of 70 W including an integrated 18.5 Wh/5000 mAh Lithium battery, as shown in FIG. 36. Note that:
The input power it limited to be less than 75 W, so no PFC specification must be respected.
The battery provides additional power in order to speed up the charge of the device delivering the maximum power required by the device.
When the output power required by the device would lower the input power to less than 75 W, the extra input power available is used to charge the battery.
The global efficiency is higher because the PFC circuit is removed completely.

The proposed power adapter without PFC is of the same size or even smaller than the 96 W one, charges the device in a similar amount of time time. In addition, the overall cost of the adapter is reduced and it behavies substantially like a small 5000 mAh portable power bank, even when not plugged to AC mains.

There are a number of alternatives to the proposed power adapter without PFC, such as one including a larger battery.

### Insulated PFC

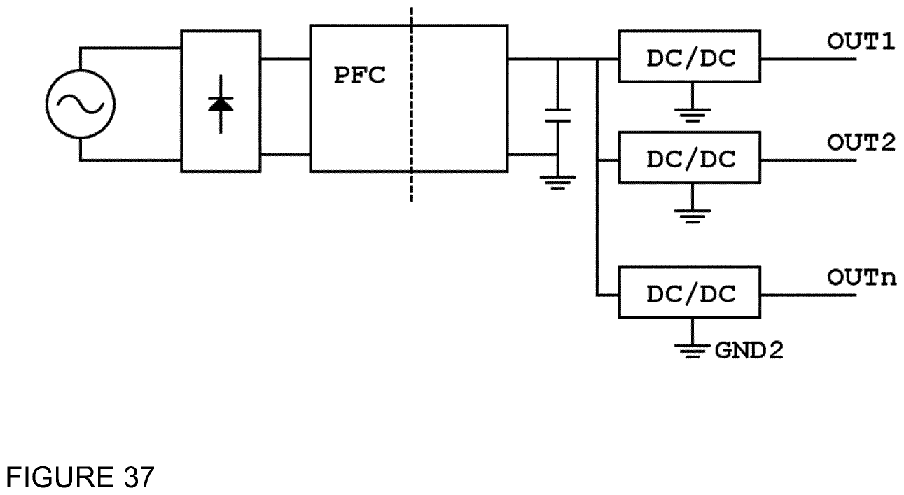

With reference to FIG. 37, an AC/DC converter for providing several output voltages is presented. The AC/DC converter includes a bridge rectifier used to rectify an AC input voltage, a single stage insulated PFC for providing power factor correction, a storage element in parallel with the PFC and several DC to DC converters providing multiple output voltages (Out1, Out2 . . . Outn).

The storage element may be composed of one or more capacitors and/or a battery pack including one or more battery cells and/or supercapacitors.

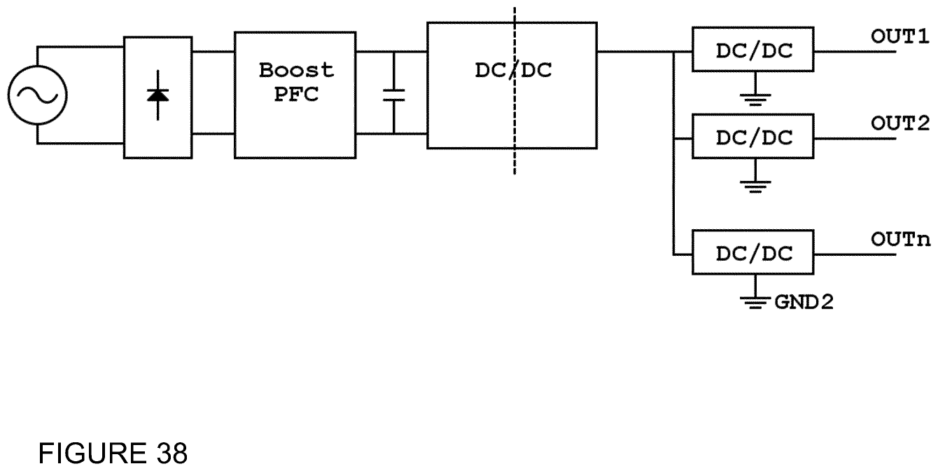

The main idea is to remove stages in series in order to improve efficiency. Because the PFC is specially configured as an insulated circuit, the number of stages in series is reduced. In comparison, the traditional circuit in FIG. 38 uses a non-insulated PFC, an insulated stage and a DC/DC converter. Traditional circuits include more components and more stages in series, with a consequent lower efficiency.

The architecture presented in FIG. 37 allows both to reduce the number of stages in series, and to reach high efficiency levels.

The insulated PFC may be implemented using any available insulated converter by simply changing the control loop (in particular controlling the input current rather than the output voltage).

This architecture may use a low voltage storage capacitor on the secondary side, that may be much bigger (in terms both of capacitance and physical size) than the storage capacitor working at high voltage in the traditional solution (E=½C*V\hat{ }2).

The energy that must be stored is always a function of the maximum output power and the requested holdup time, in fact, when the input voltage is missing, the converter is supposed to supply the load for a certain amount of time (hold up time). This is possible by withdrawing the energy previously stored in the storage capacitor, and of course longer hold up times will require bigger energy storages.

Also, for a fixed DC output power, the converter's AC input power is fixed (and has the same average value), and so the power ripple in the storage capacitor is fixed, too. Lower storage capacitor voltages will then require higher ripple currents on the storage capacitor. Higher ripple currents may both mean higher voltage ripple and higher losses on the Equivalent Series Resistance (ESR) of the capacitor.

Even if lower voltage capacitors can provide higher capacity density and lower ESR compared to a higher voltage one, the energy density is generally lower and the ohmic losses will be generally higher because of the higher currents.

The choice of the storage capacitor voltage may depend on a number of factors:
maximize the energy density.
   Higher storage voltage will be preferred. As long as the storage is at the secondary side and may so be accessible by the end user (ie. in the case of hand-hold appliances), the required safety standards must be followed.
   The maximum voltage will be then probably chosen not to overcome the Extra-Low Voltage (ELV) safety level
minimize the voltage drop on the following stages.
   The voltage should be high enough to guarantee the minimum voltage required by the following stages.
   Let us assume, for example, that the FIG. 37 output DC/DCs are buck converters supposed to respectively generate 20V, 15V and 12V output voltages, and they all require an input voltage equal to the output voltage+3V. In this case the storage voltage must be chosen to be equal or higher than 23V.

Various architectures for realizing an insulated PFC are now described.

Other single stage insulated PFC architectures are currently available. However, they are often quite bulky because of the low voltage storage. In comparison, the number of components of the architectures presented below has been greatly reduced.

Any flyback converter (hard witching, active clamp, quasi resonant or other variants) or a forward converter may be used, as well as an LLC, an LCC or an asymmetric flyback converter.

Also, a resonant architecture (also referred as “Class-Egg” because it has a working principle similar to a modified Class-E amplifier) may be used, as presented in patent application No. PCT/IB2019/057523. These kinds of architectures are based on a primary side switch used to provide and inhibit a current path between the input voltage and a primary side inductor, and a rectifier on the secondary side. The primary side inductor may be weakly coupled with a secondary side inductor. The power is transferred to the secondary side through magnetic and/or capacitive coupling. When the primary switch is off, the primary inductor resonates with the primary side parasitic or discrete capacitances, allowing the next primary side switch turn on to be in ZVS or quasi-ZVS condition.

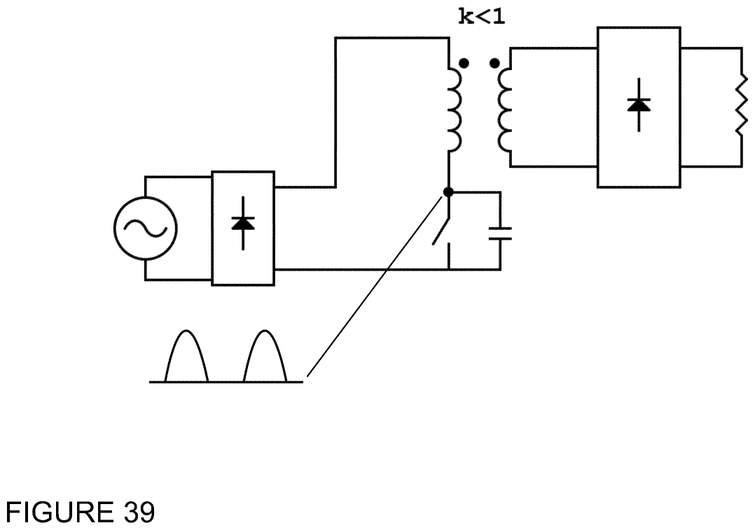

With reference to FIG. 39, an insulated PFC implemented using “Class-Egg” architecture comprising magnetic coupling is shown.

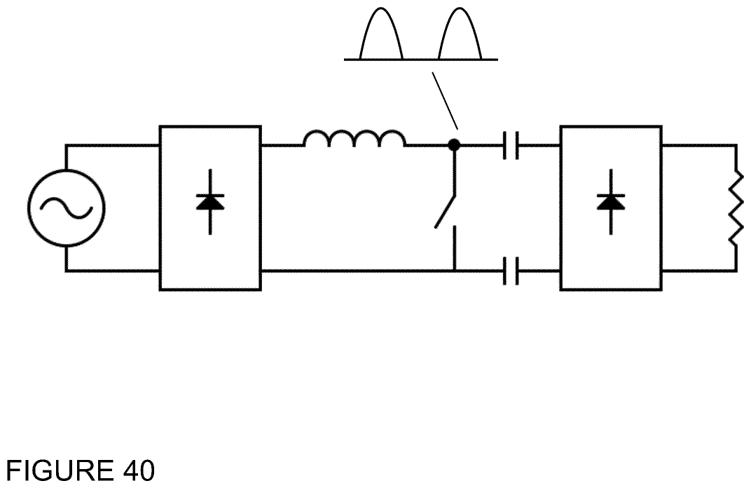

With reference to FIG. 40, an insulated PFC implemented using “Class-Egg” architecture comprising capacitive coupling is shown.

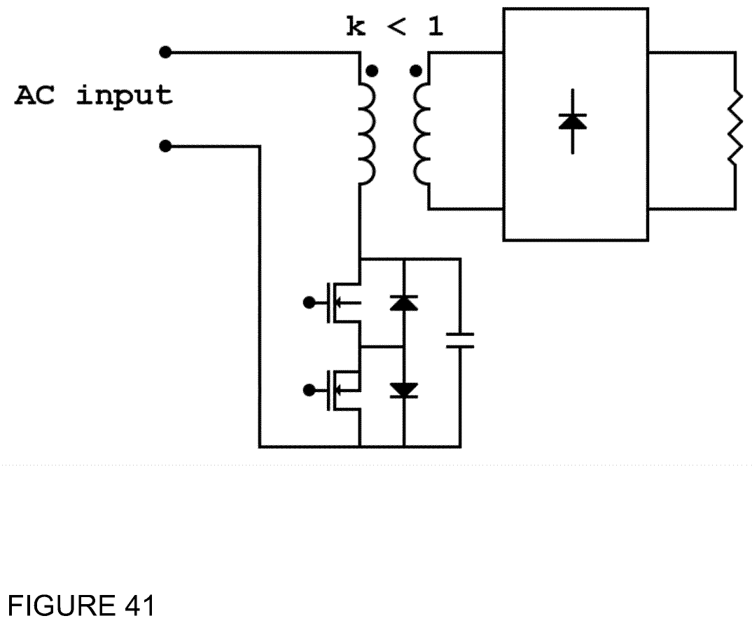

FIG. 41 represents an alternative architecture to implement the insulated PFC converter of FIG. 39: here the “Class-Egg” primary switch is replaced with a couple of switches connected in antiseries. The effect of such a substitution is to allow a bridgeless primary side, where the switches may be turned on in order to provide a current path between the input voltage and the primary winding, and turned off in order to disable the current path. As long as the AC input voltage is positive during a half-period and negative during the other half-period, when the switches are turned off, one of the two anti-series embedded body diodes will be in direct polarization, while the other one will be in indirect polarization. So, the two antiseries switches allow for an AC input bridgeless operation.

The rectifier may either be half-wave or full-wave, such as single switch, push-pull, voltage doubler and current doubler rectifiers.

An interleaved version of the converter may also be realized using one or more additional primary side branches, each of them including a primary winding and two switches in series. Each of the additional primary windings may independently be in a flyback or forward configuration with the first primary winding.

A number of other architectures may be used for creating the insulated PFC, such as, but not limited to:
“Class-Egg” architecture including capacitive or inductive coupling.
“QuarEgg” architecture, described in Section I.
Class-E architectures.
Non-inverting buck boost converter.
Insulated converter described in Section IV.

### Non-Inverting Buck Boost Converter (Optionally Insulated)

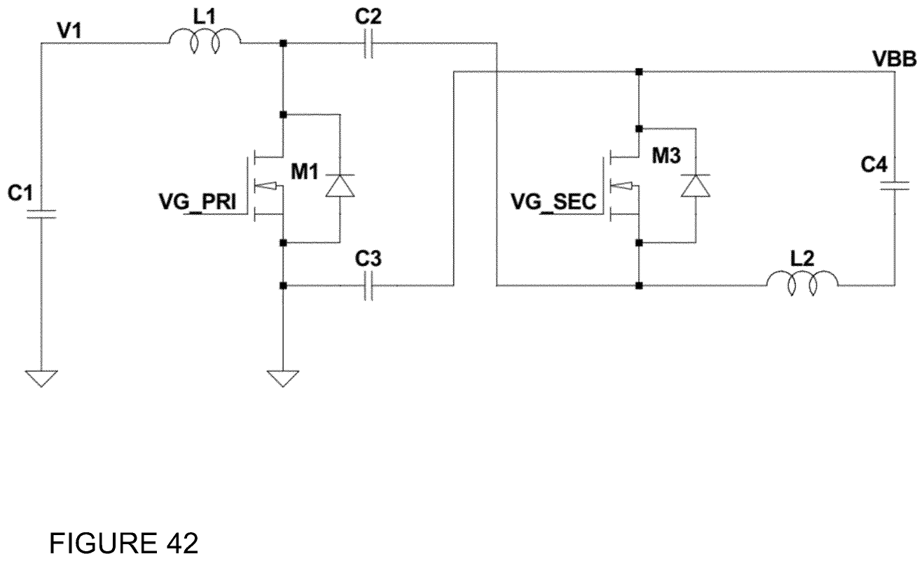

With reference to FIG. 42, the non-inverting buck boost converter is provided. The converter is based on a cuk converter wherein the cuk storage capacitor is split into two storage capacitors C2 and C3 and the nodes at the junction between the storage capacitors and the DC load are inverted (by twisting the wires), such that power is transferred from the DC voltage source to the DC load in a non-inverting way.

M1 may be driven in PWM or similar modes. When it is ON, it charges energy in L1. When it is OFF, L1 pushes current to the secondary side through the capacitive barrier. M3 acts as a diode: it turns ON when C2 current flows towards the secondary, creating a path toward the C4 upper (positive) node.

C1 and C2 split the circuit into two sub-circuits: the primary side and the secondary side.

The secondary side ground can be referenced to any node, including but not limiting to C4 low side node (negative node), or M3 source node (in order to drive M3 with a low-side driver).

It is easy to notice that the converter is bidirectional: by simply driving M3 (with PWM or similar modes), and driving M1 as an ideal diode, the power can be withdrawn from C4 and be rectified by the primary side stage.

As compared to conventional non-inverting buck boosts that are made with 2 stages (boost and buck stages) and 4 MOSFETs (2 high side and 2 low side MOSFETs), the architecture presented is able to achieve a substantially similar performance with only 2 low side MOSFETs.

The converter may be optionally insulated or non-insulated: in the second case, any node of the secondary side can be connected to any node of the primary side directly or through one or more components and/or circuits, for example in order to share the same ground.

The converter may include a double isolation barrier, so that the primary side can be connected to the mains or other hazardous voltage rails, and the secondary side can be an Extra Low Voltage (ELV) rail accessible by the user, according to the safety regulations.

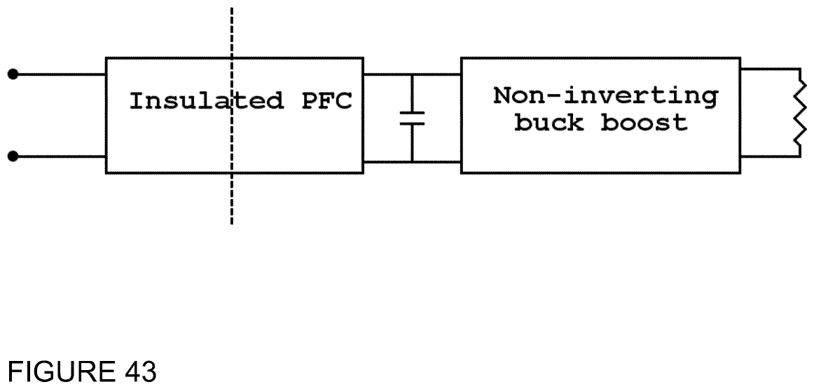

FIG. 43 shows a circuit diagram of an AC/DC converter comprising an insulated PFC for providing power factor correction, a storage element in parallel with the PFC and the non-inverting buck boost converter providing an output voltage to a load.

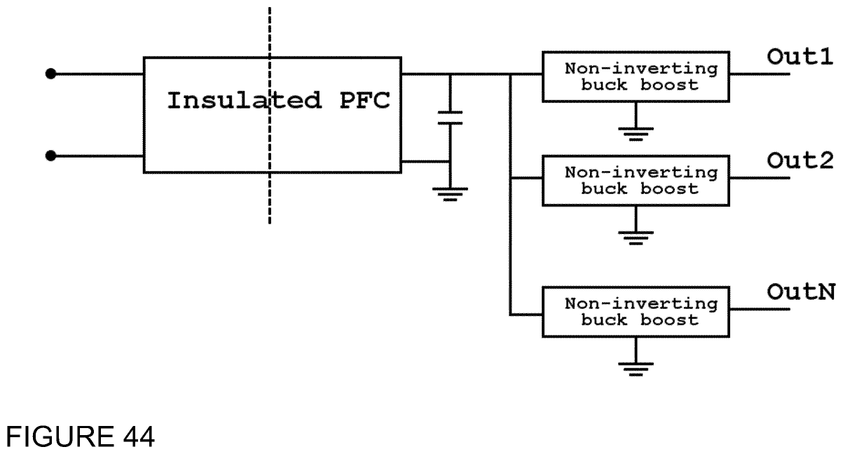

FIG. 44 shows another circuit diagram including several non-inverting buck boost converters in parallel providing multiple independent output voltages.

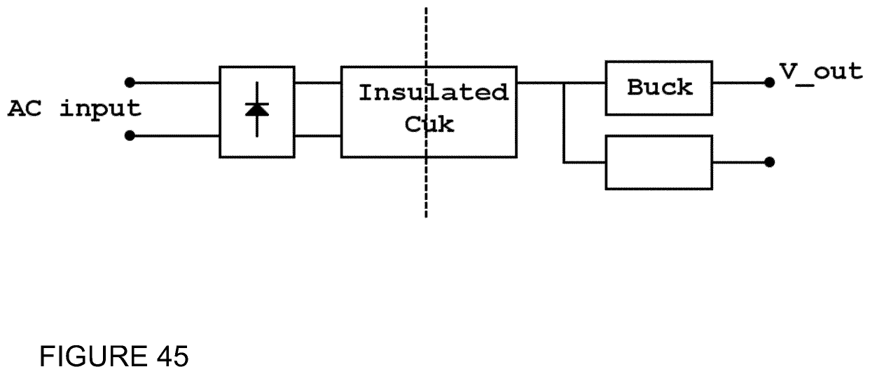

FIG. 45 shows a multiple output AC/DC converter realized with an insulated buck-boost followed by one DC/DC converter for each output rail.

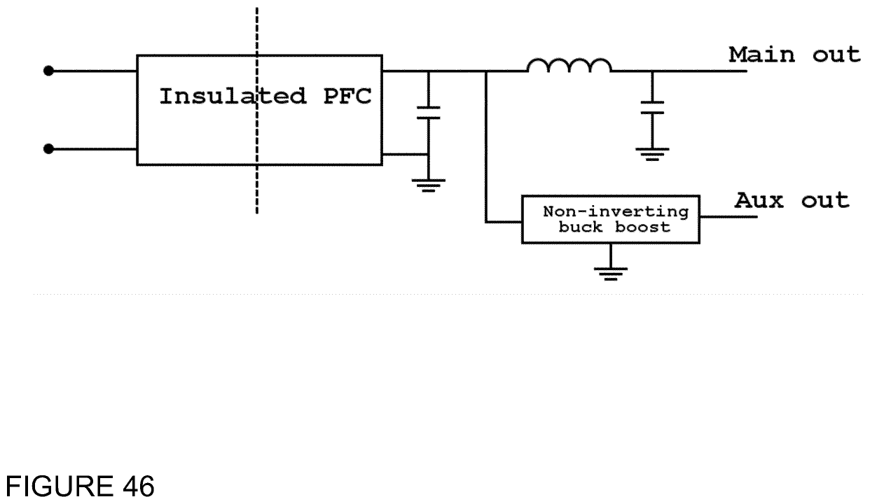

FIG. 46 shows a multiple outputs AC/DC converter realized with an insulated PFC converter (i.e. an insulated buck boost), where the main output is generated simply filtering the output voltage of the PFC, while the other outputs are generated by a dedicated DC/DC converter (i.e. a non-inverting buck boost).

### Parallel Converter Architecture

Due to the non-constant power absorption from the input, the output of a PFC usually consists in a storage element (i.e. one or more capacitors) affected by high voltage ripple.

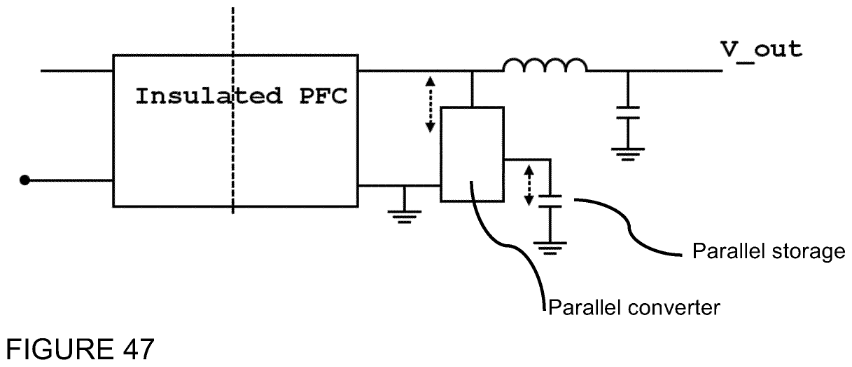

With reference to FIG. 47, rather than adding a second converter in series (as in a traditional solution), a converter is now added in parallel with the PFC output capacitor (for simplicity, we will indicate this as “in parallel with the PFC”).

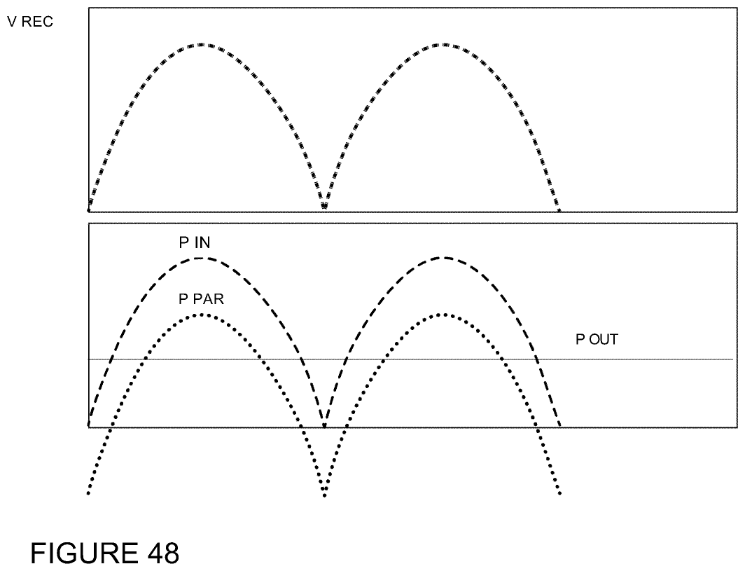

The parallel converter is a bidirectional converter comprising a power storage, and it mainly works in two modes:
When the instantaneous PFC output power is greater than the power requested by the load, the parallel converter stores the exceeding power into the parallel storage (positive P PAR values in FIG. 48).
When the instantaneous PFC output power is less than the power requested by the load, the parallel converter withdraws the needed power from the parallel storage and delivers it to the load (negative P PAR values in FIG. 48).

Advantages include, but are not limited to:
The average energy goes directly from the input to the output with a single insulated stage, thus with an efficiency that can be as high as 97%-98%
The ripple energy (needed to ensure the PFC effect) is handled by the parallel storage, which acts as a parallel filter able to remove the voltage ripple, thus reducing the need of big LC filters on the output.
This means that the current in this parallel converter is much smaller than the current in a standard DC-DC converter put in series, thus the efficiency can be higher (or smaller devices can be used to achieve the same efficiency).
Most of the energy is stored (at whatever voltage) in the parallel storage capacitor, thus in a very efficient way as the storage is done at a voltage that may differ from the output voltage. This is also another way to reduce the current further, thus increasing the efficiency. So, a very small storage capacitor can be used in comparison with low voltage storage needed in the other insulated PFC implementation.

A number of different parallel storage converters may be used. Some examples are listed below.

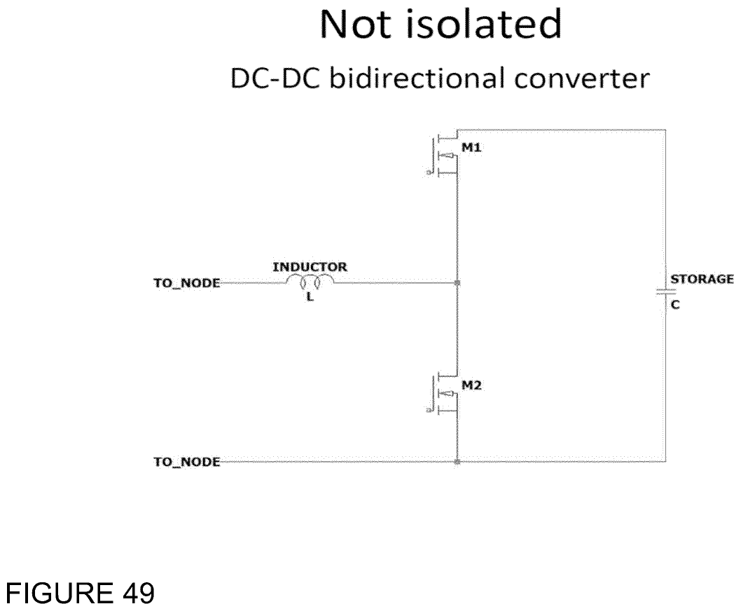

As an example, FIG. 49 shows a not-insulated DC-DC bidirectional converter. This architecture is easily achievable at low cost. In comparison with the same circuit put in series, the parallel solution achieves a much smaller converter because the current is just the ripple current (i.e. main current flows directly to the load). When the energy is absorbed and stored, the circuit may be driven as a boost converter. When the energy is delivered from the storage to the output, the circuit may be driven as a buck converter.

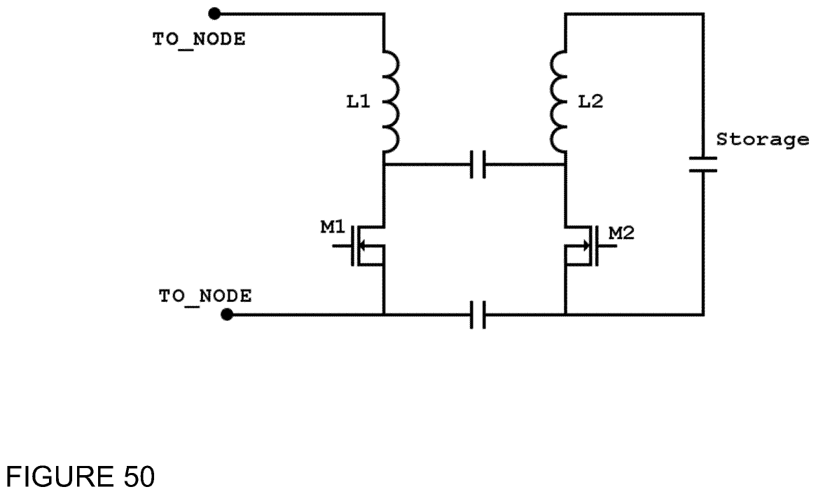

FIG. 50 shows a “Class-Egg” resonant capacitive circuit which behaves in a similar manner than a class E amplifier. A resonance is obtained between L1, L2 and C in order to get ZVS (and optionally ZCS operations). The circuit acts as an insulated non-inverting buck boost. In comparison with the circuit shown in FIG. 49, this has 2 low side MOSFETs (easier to be driven).

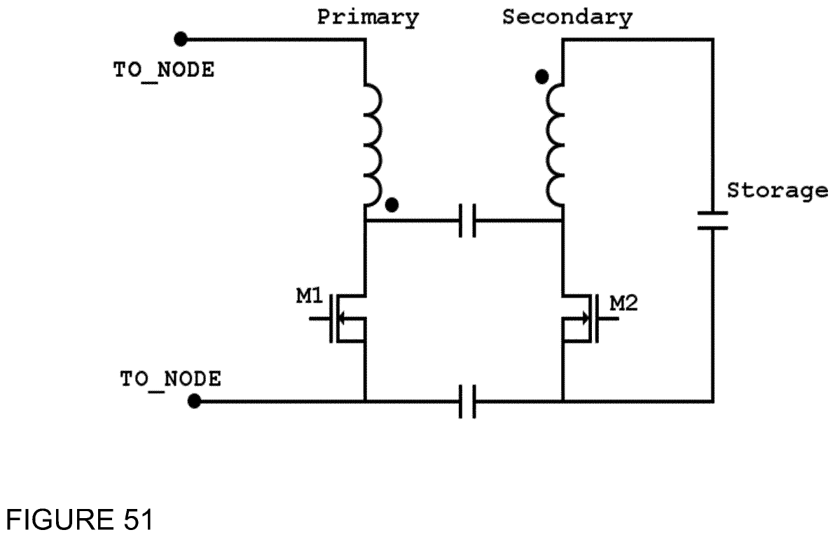

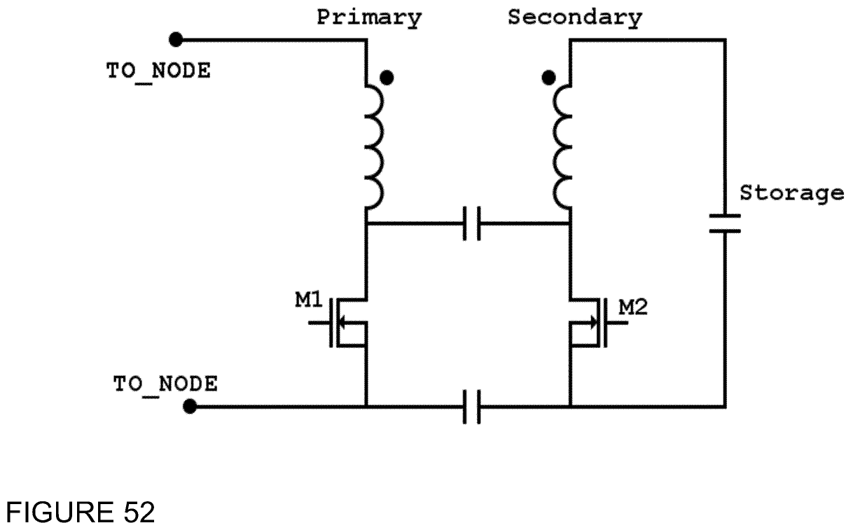

FIG. 51 and FIG. 52 show a “Class-Egg” parallel storage including weakly coupled inductors, with the mutual coupling k between the primary and secondary inductors being less than 1. The two inductors are configured to have mutual coupling and a leakage inductance, and a galvanic isolation barrier is provided between the input terminals and the storage capacitor. FIG. 51 and FIG. 52 respectively show flyback-like and forward-like configuration between the coupled inductances.

The weak coupling between the inductors is added in order to reduce the peak voltage on the active devices. In addition, a single magnetic component can be used (something that is at the same time a transformer and 2 inductors).

The bidirectional two-FETs buck boost converter shown in FIG. 42 can be simply used to store and withdraw energy to and from the storage capacitor C4.

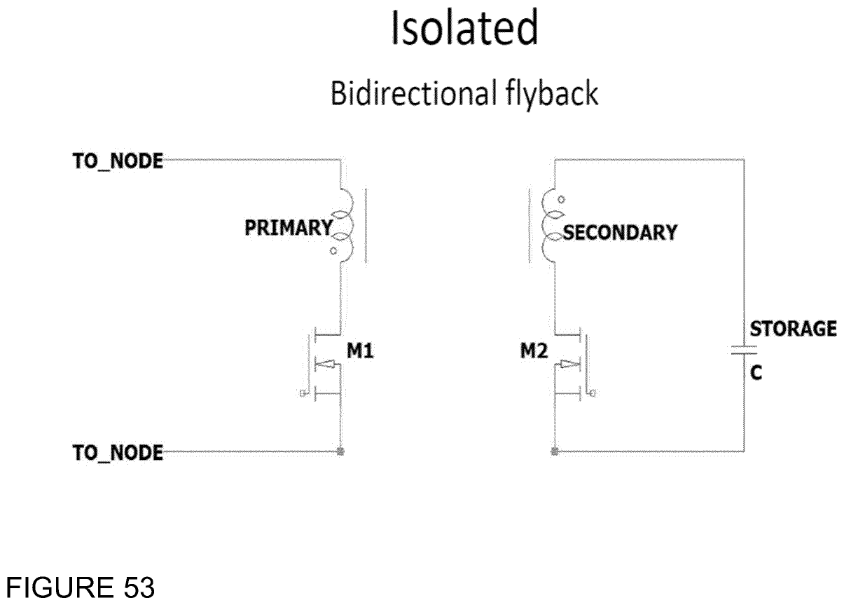

Finally, a bidirectional flyback may also be used, as shown in FIG. 53. This small parallel flyback can be used for a very compact implementation, as it is made of an extremely small magnetic component, two low current MOSFETs and a storage capacitor. A peculiarity of this use of the flyback is that critical conduction mode can be achieved, which leads to ZVS operations. Also, DCM can be achieved, which leads to ZCS operations.

### Primary Side Parallel Converter

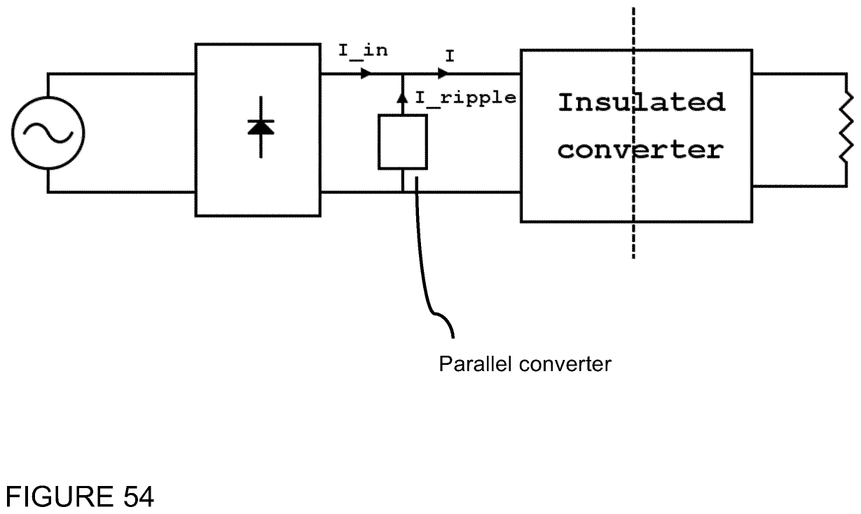

Another peculiarity of the parallel converter architecture is that the parallel converter can be put either on the secondary (FIG. 47) or the primary side (FIG. 54).

The primary side parallel converter architecture benefits from all the advantages of the secondary side parallel converter architecture, while allowing it to overcome the maximum voltage limitations of the storage element. For example, while a secondary side storage capacitor may be limited to a maximum of 50V due to the Extra-Low Voltage (ELV) safety level, a primary side storage capacitor would not be subjected to this limit.

### Section IV. Insulated Converter

Bridgeless converters and forward converters have already been used. However, they are uncommon, as they need a lot of extra components and increase stress on the active components in comparison with flyback converters.

### 4.1 Insulated Converter Topology

An insulated converter comprising a weakly coupled transformer including a primary winding and a secondary winding arranged in a forward configuration is now described.

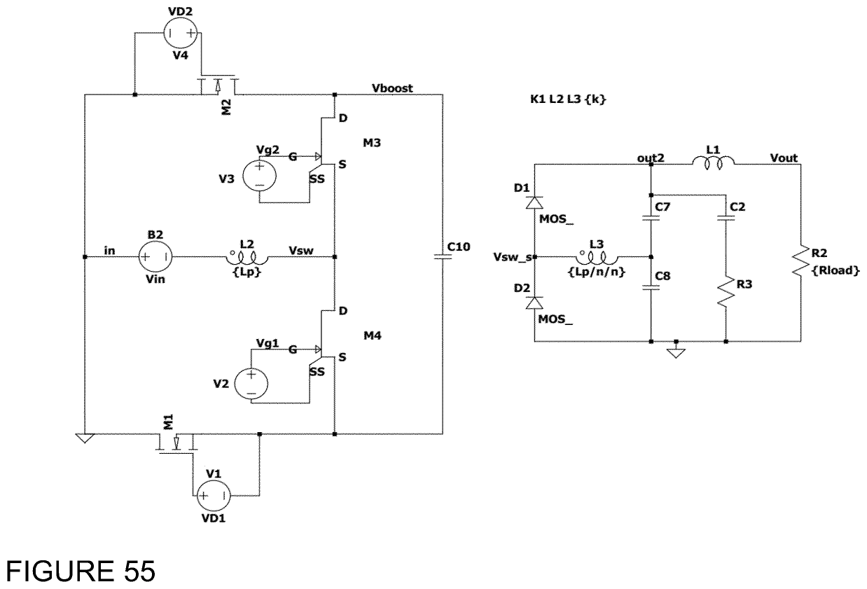

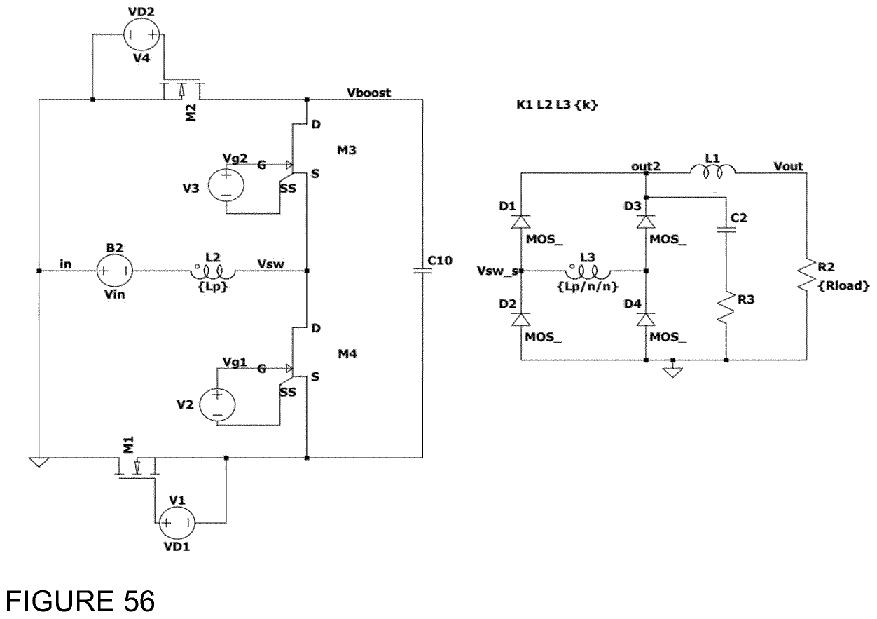

The proposed improved architecture is shown in FIG. 55 and FIG. 56, which relates to an insulated Converter (including PFC functionality and insulated regulator, or just the insulated regulator, or insulated PFC) with a storage element C2 located on a secondary side circuit and a storage element C10 on primary side. The transformer includes a primary winding L2 and secondary winding L3 arranged in a forward configuration.

It can be used as the following, but not limited to:
an insulated PFC.
insulated converter with single or multiple outputs with or without PFC.
storage on the secondary side using a battery, storage at high voltage on the primary side.

The primary side circuit is a bridgeless circuit with M1 and M2 acting as diodes (at 50 Hz). By removing two diodes as compared to standard circuits including a bridge, the power loss is halved (as two diodes are needed as compared to four). Of course, M1 and M2 can be substituted by standard diodes. Also, a standard bridge of diodes can be used for low current converters where the difference in performance is low in comparison with a bridgeless solution.

The architecture is bridgeless in order to increase the power efficiency and reduce the Bill of Material. Thus:
The drain of the upper switch (i.e. the drain of the upper MOSFET) is connected to the 2^{nd} terminal of the input source through a diode, with the anode of the diode connected to the drain of the upper MOSFET.
The source of the lower switch (i.e. the source of the lower MOSFET) is connected to the 2^{nd} terminal of the input voltage source through a diode, with the cathode of the diode connected to the source of the switch
MOSFETs driven as ideal diodes may also be used to substitute the diodes and increase the efficiency further.

The secondary side rectifying circuit can be configured as a voltage doubler circuit as shown in FIG. 55 or a full bridge circuit as shown in FIG. 56.

On the primary side, M3 and M4 are fast switching MOSFETs with high switching frequency (such as 1 MHz or 500 KHz). A capacitor C10 on the primary side circuit is located in parallel with the switching branch including M3 and M4.

The two inductors L2 and L3 are arranged on the same core and have a mutual coupling k less than 1. In the example provided in the following slides, k is chosen to be equal to around 0.8 to 0.95. Hence, the transformer including primary side winding L2 and secondary side winding L3 is not an ideal transformer deliberately. The two inductors L2 and L3 are also arranged in a forward configuration, so that the current flowing in L2 has the same direction.

The presented insulated converter provides a number of important advantages, such as, but not limited to:
The forward configuration of the transformer minimises the amount of magnetic energy that needs to be stored, reducing the physical size of the transformer. In comparison with a standard forward converter, the proposed architecture does not need an auxiliary reset winding nor a reset diode, reducing the number of components and simplifying the architecture. Also, in comparison with a standard forward converter, the architecture is Zero Voltage Switching, increasing dramatically the efficiency of the converter.
L2 and L3 are weakly coupled. Hence, although most of the energy is transferred to the load (similar to a standard forward converter), because of the k<1 a small amount of energy is stored in L2. This energy is used to ensure Zero Voltage Switching transitions in the primary side MOSFETs.

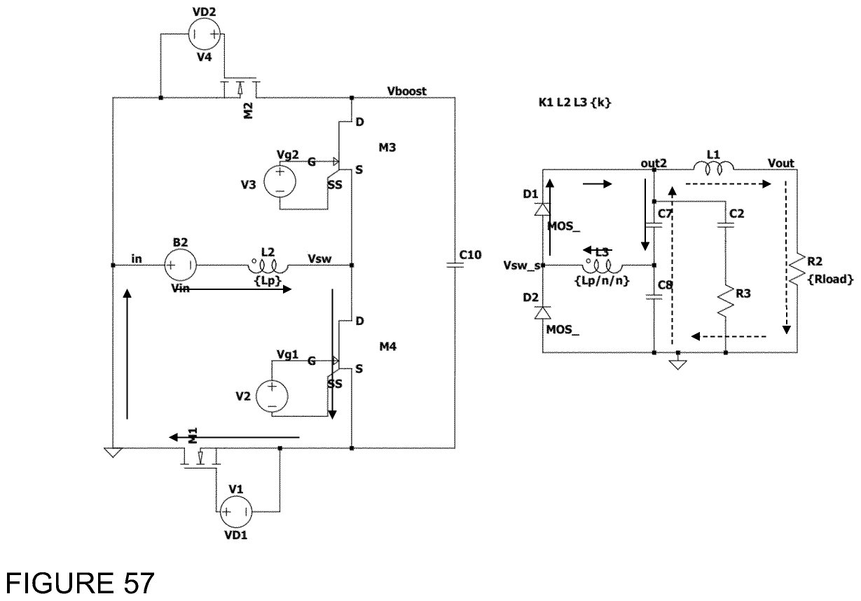

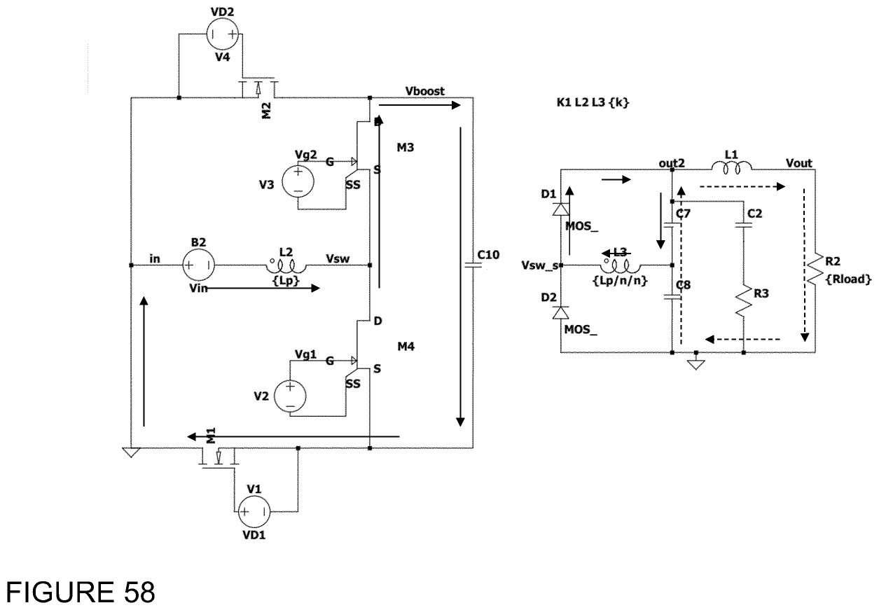

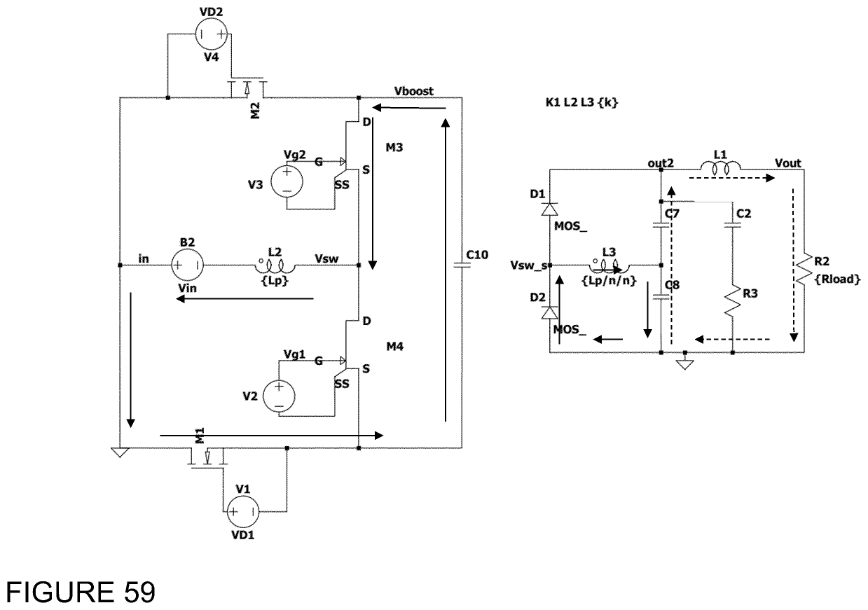

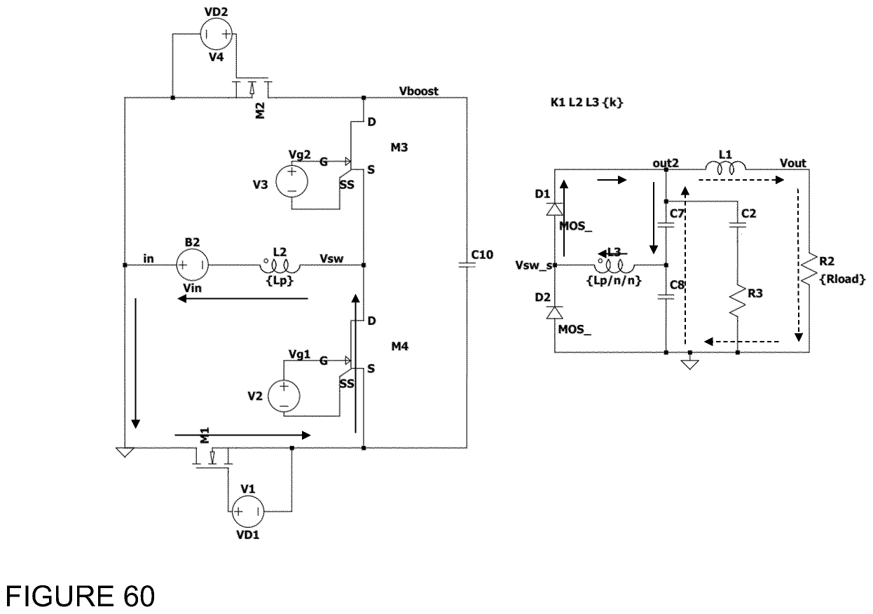

In the following description, a positive half wave of the sinusoidal AC input from the grid (50-60 Hz 90-260V AC) is considered. During this half wave, M1 is turned ON and M2 is turned on.
During Phase 1 (FIG. 57), the primary side switch M4 is turned on. As L2 and L3 have the same polarity windings (forward-mode), energy is transferred to the secondary side and rectified by D1 (in case of a full bridge rectifier, it is rectified by D1 and D4). At the same time, because coupling between L2 and L3 is lower than 1, a small amount of energy is stored in L2 (similarly to the charging phase of a boost converter). The longer the time Ton during which the switch is turned on, the more the energy transferred to the load and the energy stored in L2.
When the switch M4 is turned off (FIG. 58), L2 acts as a current generator (because of the small amount of energy stored in L2). In this phase, the primary side circuit acts as a Boost converter discharging L2 and charging C10 through the switch M3, which is driven as a diode (similar to the diode of the boost converter). The voltage on C10 therefore rises to a voltage that is higher than the grid voltage, and the current in L2 drops progressively down to 0 A. Additionally and simultaneously, in Phase 2, energy is also still being transferred to the secondary side because of the coupling between L2 and L3, while D1 is still conducting.
The voltage at C10 can be determined or chosen based on the mutual coupling of the inductors. The lower the coupling is, the higher the voltage on C10 will be because more energy is stored in L2 during Phase 1 (FIG. 58). Also, the converter can be designed to ensure that after the initial transient the voltage at C10 is almost constant and higher than the grid, acting as a storage element, or the voltage at C10 can be highly variable, oscillating from a minimum value to a maximum value.
When L2 is fully discharged, the switch M3 is kept turned on (FIG. 59) (this is a difference between the proposed converter and a boost converter). Thus, the current is reversed in L3 (Phase 3). Hence no reset diode is needed as noted above. In this phase, energy is still transferred to the load through the diode D2 (in case of a full bridge rectifier, through D2 and D3, in FIG. 56).
When the switch M3 is turned off. The current in L2 is still not zero and flowing to the grid through M4 (FIG. 60). Thus, the parasitic capacitance of M4 is fully discharged and the voltage on the drain of M4 drops down to 0V, ensuring Zero Voltage Switching operations.
When the voltage on M4 is 0V, a new switching cycle can start.

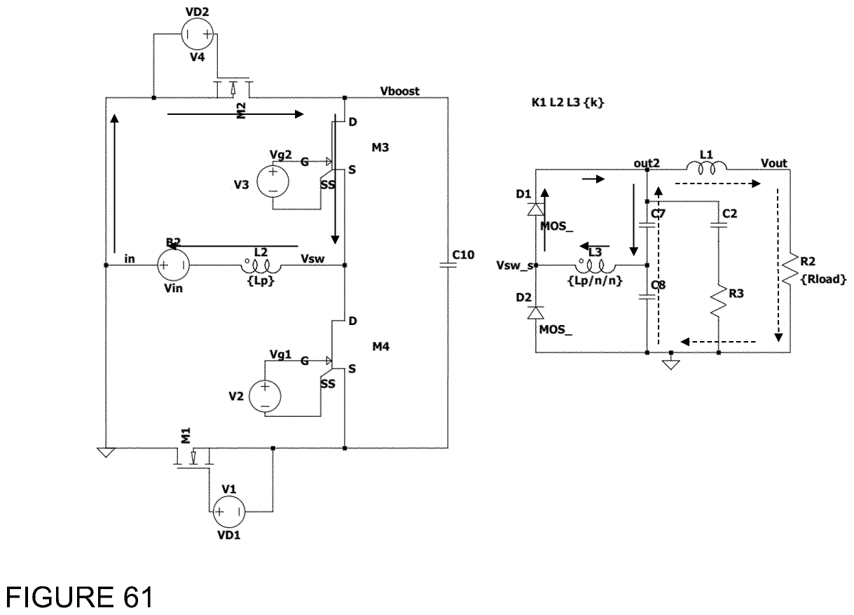

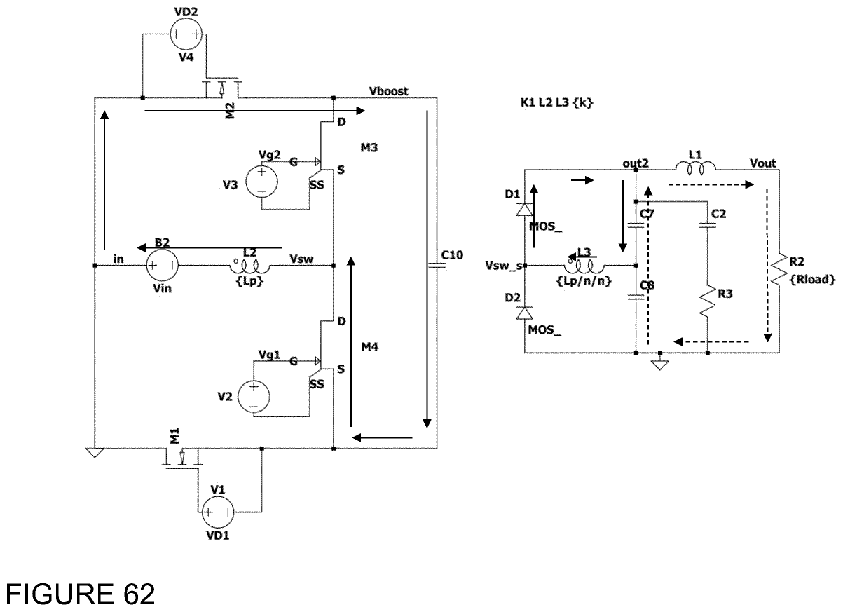

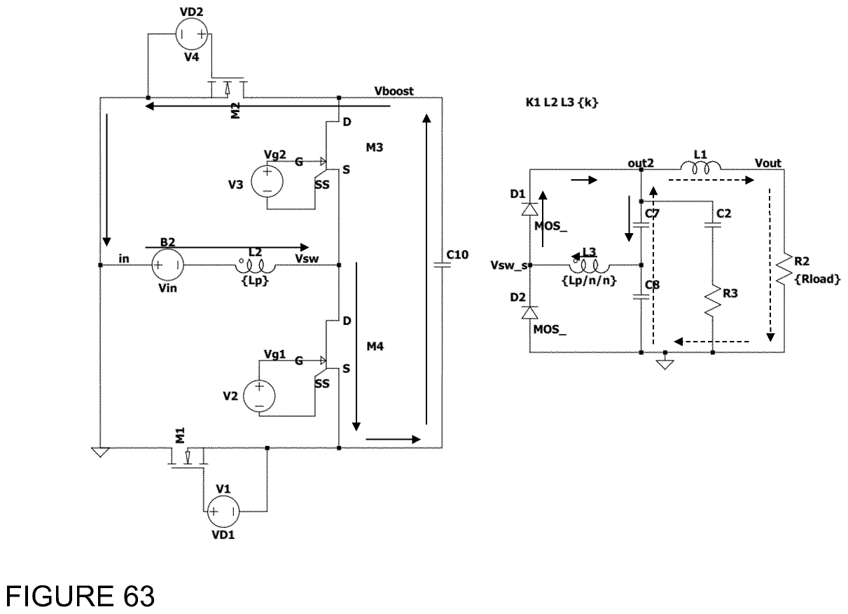

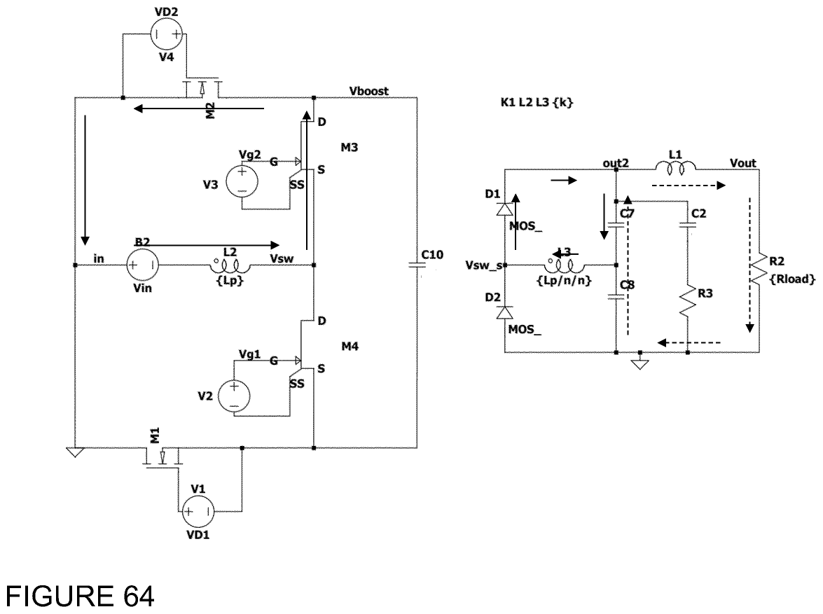

When the AC input is reversed (negative input half wave), the same cycle takes place with M2 substituting M1, and with M3 and M4 driven in the complementary way than the description above (FIGS. 61-64).

### 4.2 Bridgeless Insulated Converter Used as an Insulated PFC

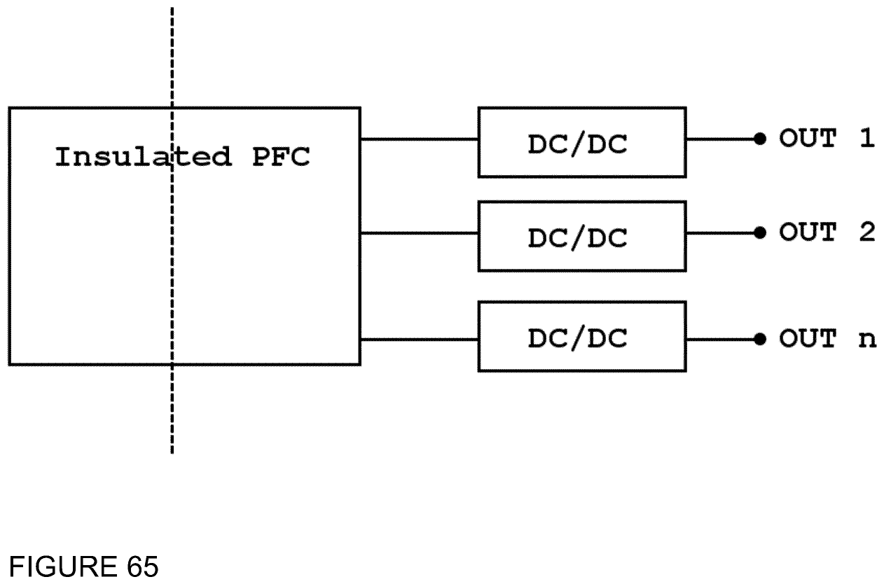

The proposed converter can be used as an insulated PFC, as shown in FIG. 65.

Energy may be stored on the secondary side:
At the output capacitor of the secondary side rectifier
At a battery or supercapacitor which is the output of the secondary side rectifier.

Energy may be stored at high voltage on the primary side on C10 high voltage capacitor. The lower the coupling between L2 and L3, the higher the energy stored on C10. If the converter is used as a PFC, then another DC/DC converter in series may be needed (or multiple DC/DC converters) to supply each load in order to achieve both PFC and output load regulations easily. However, a single stage solution can be also implemented, using one degree of freedom (i.e. the Ton of M4) to control the input current in order to achieve Power Factor Correction, and another degree of freedom (i.e. the Toff of M3) to control the output voltage

Additional degrees of freedom may also be added without increasing the number of active devices. In particular, a delay in the turn-off instant of the secondary side FETs D1 and D2 can be used to reduce the ratio between active energy delivered to the load and reactive energy in the converter, regulating the output voltage very quickly and effectively, avoiding additional converters in series.

4.3 Bridgeless Insulated Converter Used as a Converter without PFC

In case that no PFC is needed, the degrees of freedom of the converter in FIG. 56 may for example be used to ensure the output voltage/current regulation without the need of additional DC/DC converter in series. Of course, in this case the input current is not in phase with the input voltage.

In both configurations (with or without PFC), the converter has several advantages, such as one or more of the following:
In comparison with standard high-power converters with PFC (usually done with PFC+LLC+DC/DC converter or PFC+flyback converter), there are just 1 or 2 stages in series, increasing the efficiency.
The circuit has better performance at light load than standard LLC based circuits
The size of the main magnetic component is much smaller than flyback converters (similarly to standard forward converters).
The circuit has a lower number of components in comparison with standard forward converters.
The circuit has a lower number of components in comparison with other bridgeless architectures.
The circuit is Zero Voltage Switching, leading to very high efficiency.
The circuit is not resonating like an LLC or class E converter, thus the light load efficiency is much higher.

### 4.4 Battery or Supercapacitor as Storage Element

When a battery or a supercapacitor is used as storage element on the secondary side, there are some significant advantages in comparison with standard capacitors:
Energy density (J/cm\hat{ }3) is much higher in a battery than a standard capacitor. This means that the same amount of energy can be stored in a much smaller size, reducing dramatically the size of the converter.
If the size of the battery is high enough (i.e. considering a 3.7V lithium battery, more than some thousands mah—i.e. 10.000 mah), then the converter will act at the same time as an AC/DC converter and as a power bank, creating a hybrid device that saves volume and cost in comparison with 2 separated accessories (an AC/DC adapter+a power bank) or in comparison with an accessory that integrates a standard AC/DC circuit+a standard power bank circuit inside.

### 4.5 Primary Side C10 Capacitor Used as Storage Element

Thus, by decreasing the mutual coupling, such as for example with a mutual coupling k of about 0.5, less energy would be stored on the secondary side and in turns more voltage would be stored on the storage element C10 of the primary side. In this case, there are some advantages in comparison with storing energy on the secondary side:
This approach has the advantage of high voltage energy store (thus, reducing the storage capacitance because energy follows E=½*C*V\hat{ }2 rule). This leads to reduction of size of the storage capacitors in comparison with secondary side storage.
Another advantage of this storage is the fact that—in comparison with conventional adapters without PFC—the same high voltage C10 capacitor may be used to store energy at high voltage, whatever the input AC voltage is. By contrast, in a standard adapter the input capacitor is pretty inefficient as it must resist to the high voltage of the EU grid (thus less efficient in terms of F/cm\hat{ }3), and at the same time must have big capacitance and low resistance to store energy at low voltage and higher current when the US grid is connected (thus, the input capacitor is very bulky). By contrast, using C10 as storage element means that it will be regulated as the output of a standard boost converter, so storing energy in a very efficient way at high voltage whatever the input voltage is (like in a standard boost PFC—but with only 1 or 2 stages in series rather than 3).

### 4.6 Light Load Conditions

When the load increases, the duty cycle increases. By contrast, the duty cycle decreases for light load conditions.

When light load occurs, there may be a problem in reducing the duty cycle of M1 too much. Often controlling the duty cycle for light load conditions is very complicated or very expensive as it requires the use of expensive timers.

A proposed solution for reducing the duty cycle is to turn off the high side MOSFET M2 located on the primary side when the current in the transmitting coil is 0 A and the voltage in the capacitor is at its maximum (an instant before the current reverses from the capacitor to the input source).

Then the system can remain turned off for a long time, and then restarted in ZVS conditions when a new cycle is needed.

Advantages of this solution includes:
high efficiency is achieved.
ZVS is achieved even in light load conditions. As a comparison, this is not possible with standard burst-mode controllers.
Zero current condition is also achieved.
The turn off time can be changed in a continuous way.

Alternatively, this may also be applied to other non-insulated topology with a load directly coupled to C10 in parallel.

### 4.7 Inrush Diodes

Depending on the technology used to realize an electronic switch, the topology may embed a body diode (such as silicon FETs) or any other mechanisms that allow the current to flow from source to drain even with a low driving signal (ie. gallium nitride FETs).

When the DC or AC voltage is first applied to the input of the circuit, body diodes may provide a current path from the input voltage to the initially discharged capacitor. The capacitor may then start quickly charging with a very high current, which in turn may overstress the switch. In order to protect the switch, inrush diodes are added to the circuit in order to carry the inrush current that may otherwise damage the switches.

Several solutions are presented: in case of an AC input, both FETs must be protected, while in case of a DC input, just one switch must be protected because the other one does not provide a capacitor charging current path.

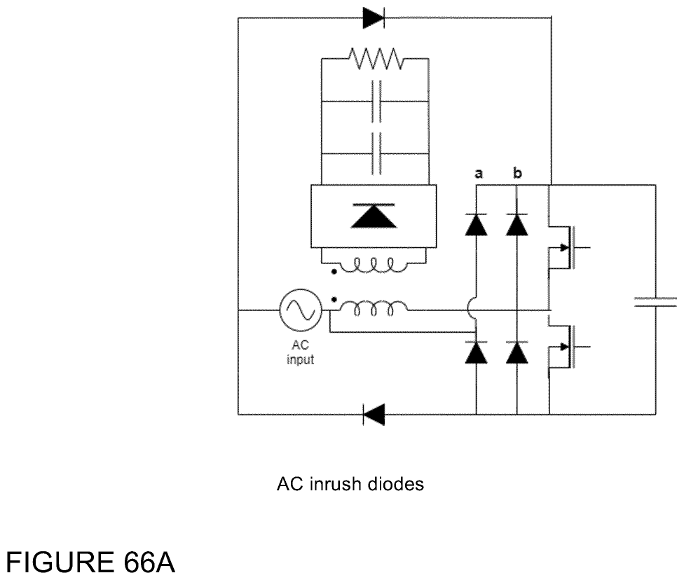

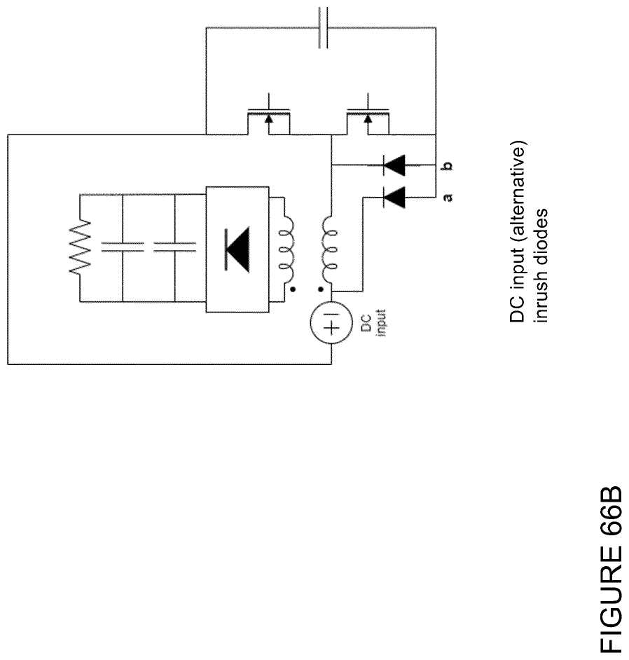

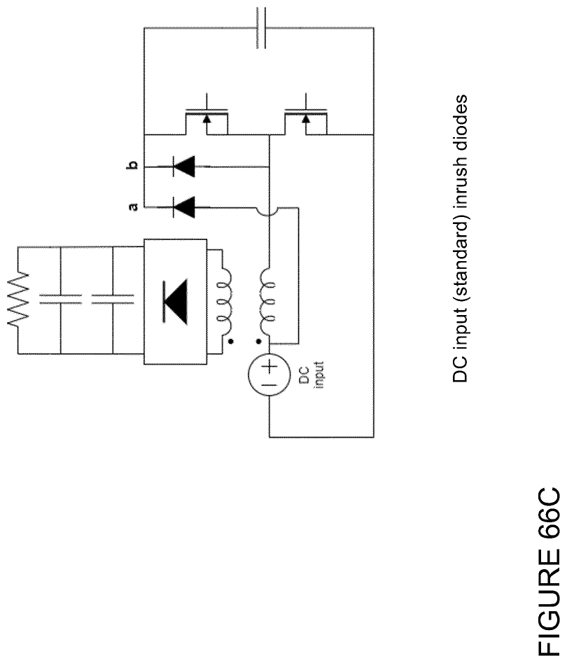

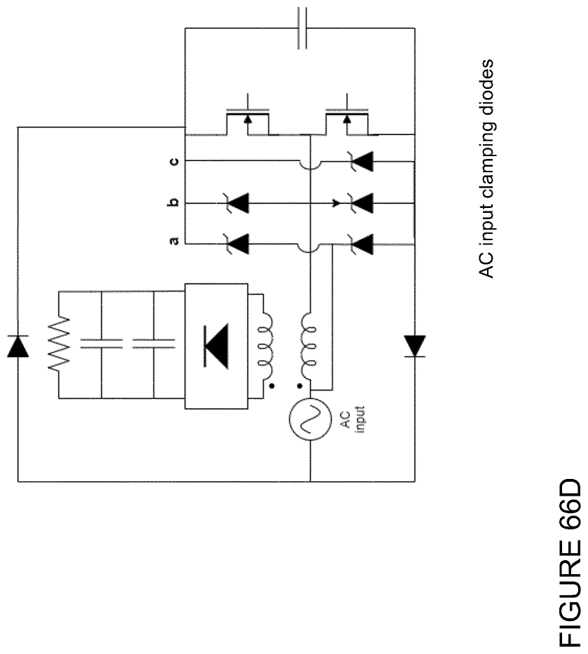

In order to protect the low-side FET, the diode's anode must be connected to the FET's source, and the cathode can be connected to one of the two terminals of the primary side winding (FIG. 66A and FIG. 66B).

In order to protect the high-side or upper MOSFET, the diode's cathode must be connected to the FET's drain, and the anode can be connected to one of the two terminals of the primary side winding (FIG. 65A and FIG. 65C).

### 4.8 Clamping Diodes

During start up, light load conditions, reversible and not reversible fault conditions or for other reasons, the high frequency switching FETs may both be turned off for an undefined time (up to some seconds). Additionally, if the FETs present an embedded body diode or a similar behaviour, the body diodes then behave like a voltage doubler rectifier for the AC input voltage. In this condition, the voltage on the capacitor would be equal to the double of the input voltage.

In many countries, the upper tolerance of the 230 VAC nominal mains is about 265 VAC, that means a peak voltage of 373V, and the double of the peak would be 747V.

If the FETs and the output capacitor can all individually sustain this voltage, no additional protections are needed. If it is not the case, some voltage clamps (such as zener diodes, Transient Voltage Suppressors or MOVs.) may be needed.

A single clamping diode may be connected in parallel with the half bridge (FIG. 66D, option “c”), or two clamping diodes may clamp each FET's voltage, with the same options described for the inrush current limiting diodes (FIG. 66D, options “a” and “b”).

### Section V. Simplified AC/DC

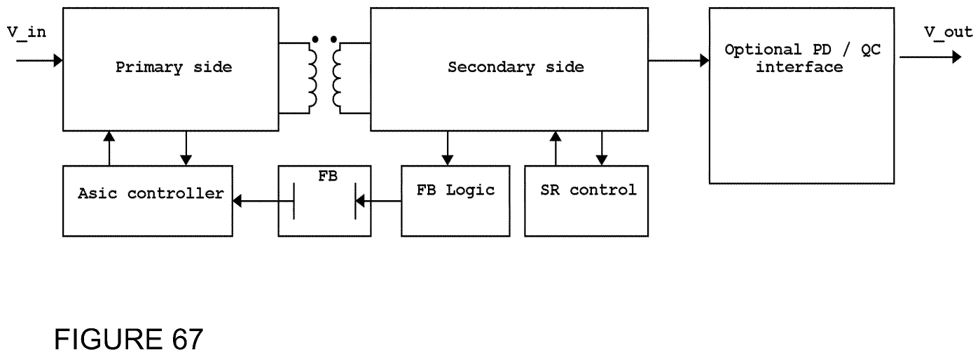

FIG. 67 shows a conventional block diagram of the typical architecture of a <75 W input AC-DC converter. The architecture comprises a primary side ASIC controller, a feedback device (typically an opto-isolator), a rectifier, some feedback logic (with usually a shunt regulator) and an optional output controller for the support of charging protocols like Power Delivery (PD) or Quick Charge (QC). A typical architecture, as shown, may often be composed of five integrated circuits without counting power switches. These components can easily add up to 40% of BOM cost.

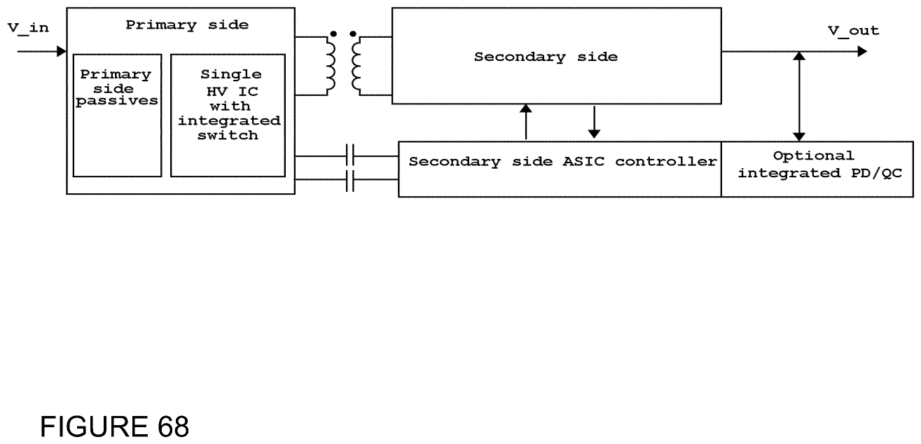

With reference to FIG. 68, the block diagram of a simplified AC/DC converter is provided. The secondary side circuit is configured to work at low voltage and includes an ASIC (application specific integrated circuit) controller. The primary side circuit includes a high voltage ASIC with integrated switch. The simple primary side logic is embedded on the primary side switch(es) DIE, composing a single High Voltage IC (i.e. made of Silicon, GaN or SiC).

As compared to conventional architectures, the proposed simplified AC/DC converter removes the need for sending a feedback signal to the primary side controller. The primary side circuit is simple, and all the control logic is located in a single IC on the secondary side. Optionally, the secondary side controller may also include support for charging algorithms like PD (Power Delivery) or QC (quick Charge) or other proprietary charging algorithms.

Advantageously, the proposed architecture is able to substantially reduce the ICs cost in AC/DC power adaptors and battery chargers, and the total cost as well.

Further optional features include, but are not limited to:
Depending on the application requirement in terms of cost & efficiency, the primary side HV IC may be realized with Silicon or with a wide bandgap semiconductor material (including but not limited to GaN, SiC, GaAs).
Primary side HV IC is equipped with an internal HV-startup system with an internal (or external) HV-startup switch capable of providing a stable power to primary side even before the converter has started. The corresponding optional features are described in the following paragraph.
Communication between primary side and secondary side ASICs is digital. It can be performed by means of, but not limited to:
   a capacitive interface (modulated or baseband communication).
   a digital opto-isolator.
   an integrated power and signal transformer
   a proximity antenna
   a signal transformer
Secondary side ASIC may include support for protocols such as PD, QC or others.
Secondary side IC may include a control scheme able to induce primary side ZVS commutation from secondary side, with many possible HW configurations, as described in Section I. This can be done with proper driving of the synchronous rectifier or with an auxiliary MOSFET on an auxiliary winding, which may be placed at primary or secondary side
Secondary side IC may actuate a “fine” output voltage or current control by means of handling the turn-off delay of the secondary side rectifier (phase shift control), therefore reflecting back some excess energy to primary side in a non-dissipative fashion, as described in Section I.
Auxiliary voltage generation can be implemented, as described in Section I.
The primary side IC includes a rectification circuit used to rectify an auxiliary winding voltage in order to generate the auxiliary voltages.
The primary side IC includes a DC/DC converter used to generate the auxiliary voltages from the input rail or from another rail.
Primary side IC includes current sensing capability for the power switches in order to implement current control and overcurrent protections. The current sensing mechanism may be implemented with various techniques, including but not limited to: low side shunt current sensing, high side shunt current sensing, sensefet current sensing, current sensing transformers ecc.
The primary side IC may include one or more additional switches, for example, it may include two switches in half-bridge configuration.
The primary side IC may include the switch(es) gate driver(s).
This system architecture can be applied to a multitude of power topologies, including but not limited to: flyback and flyback variations (QR flyback, Active Clamp flyback, ZVS-induced flyback), LLC/LCC/others half or full bridge based resonant converters or asymmetrical half-bridge fly-back (AHBF).
This system architecture can be easily applied to both no-PFC and PFC-based architectures, possibly with the addition of a battery on the secondary or on the auxiliary branch, as described in Section III.

### Techniques for High-Voltage Startup

A high voltage start-up system may be realized with a circuit used to charge the auxiliary power capacitor on the primary side during the start-up, draining current from the main high voltage input rail. It may also be triggered when the auxiliary voltage falls below a safe level, in order to ensure that the control circuits are supplied also in abnormal situations.

The circuit may be based on an electronic switch such as a BJT, a MOSFET (Si or SiC) or a GaN HEMT. The switch may be enhancing mode or even depletion mode, in order to be turned on by default during the start-up. GaN devices are convenient since they are natively depletion mode.

At runtime, auxiliary power supply is generated with a different mechanism, including but not limited to: an auxiliary winding on the transformer, an auxiliary switching power supply which may be integrated in the primary side HV IC.

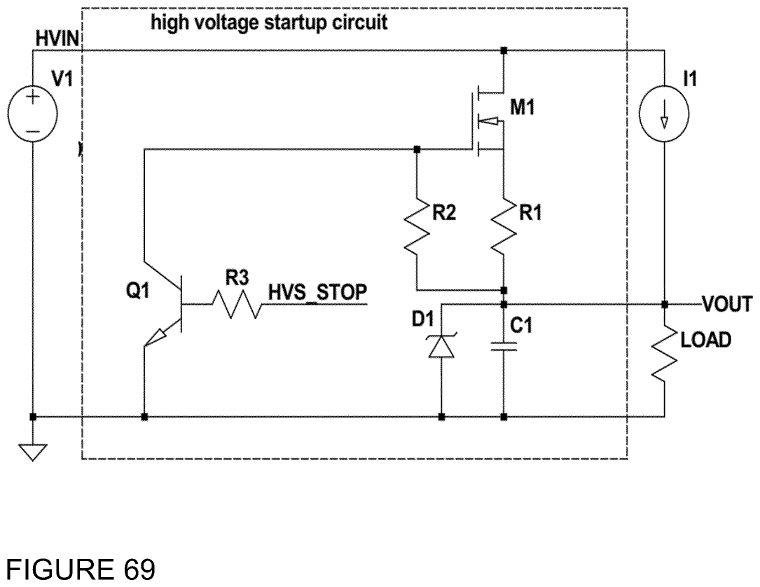

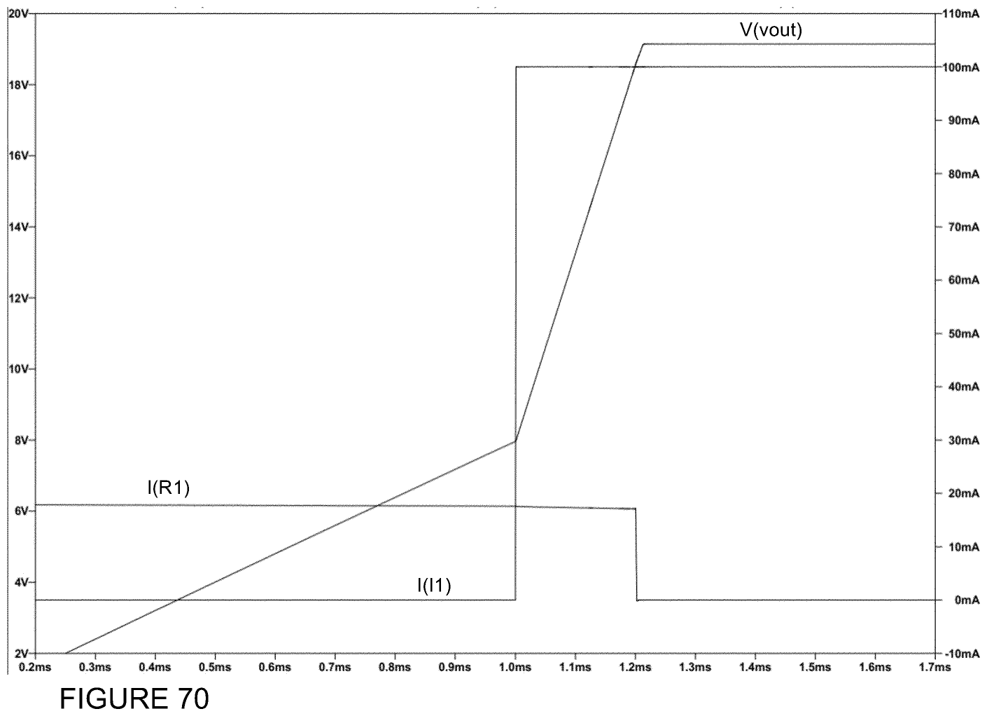

FIGS. 69-70 show an example of a high voltage start-up circuit and corresponding waveforms. At start-up, M1 (depletion mode) is on and charges C1 with a constant current determined by R1 and by the input voltage. When the voltage at Vout is high enough to start the power supply, C1 voltage may be maintained charged by a different mechanism (auxiliary switching power supply, auxiliary winding on transformer, etc.), represented with the generic current source I1, and the “HVS_STOP” signal may be used to stop draining current from the high voltage source.

This circuit is retriggerable: if during normal operation an event causes a drop in the auxiliary voltage (Vout), the signal “HVS_STOP” may be released to re-enable the current path between the input rail and C1, in order to compensate for the voltage drop.

Primary side HV IC may be equipped with a simple quasi-open-loop start-up procedure. While the main secondary side controller is still off due to the lack of energy on the secondary side, the primary side HV IC starts switching, regulating the output voltage in quasi-open-loop mode to a safe value in order to trigger the secondary side controller start-up. During this phase, feedback information regarding the output voltage can be indirectly deduced from features extracted on the primary side (for example, voltage on an auxiliary winding or back-reflection of output voltage).

With this configuration, the secondary side ASIC controller takes control of the converter as soon as it is powered up. The secondary side controller is able to measure all the information needed to perform a good quality converter control, including synchronous rectifier driving, accurate voltage sensing, overcurrent protection etc.

### Section VI. Additional Features of the Flyback Converter

We now describe further additional features which can be implemented with any of the flyback converter features described in Section I above.

ZVS Control Scheme with Main Controller Located at the Secondary Side

As previously shown in FIG. 9, a flyback converter topology may include a control unit on the secondary side. Different control schemes are also presented in FIGS. 15A to 15E.

FIG. 15E provides an example in which the secondary winding is driven by combining a rectification signal and a signal configured to induce ZVS on the primary switch. The combination of the signals is implemented using an OR logic gate. Alternatively, the OR logic gate may be implemented using a different device or circuit.

The improvements described in this section relate on how to achieve the combination of the rectification signal and the signal configured to induce ZVS on the primary switch (ZVS_SEC or ZVS pulse).

1) ZVS Pulse and SYNC_RECT Pulse Originated with Two Parallel MOSFETs

As shown in FIG. 71, an implementation is provided in which a control unit is located at the secondary side of the transformer. The transformer has a primary side winding (PRI) and a secondary side winding (SEC). A primary side switch (M1) is located at the primary side of the transformer. Two secondary side switches (M6, M2) are located at the secondary side of the transformer.

The control circuit generates the signals used to drive two switches or MOSFETs (M6, M2). The control unit generates a rectification signal (SYNC_RECT) and a signal configured to induce a ZVS pulse on the primary switch M1 (ZVS_SEC) or ‘ZVS pulse’. The two switches or MOSFETs (M6, M2) are connected in parallel and have different characteristics from one another.

As described above, at the end of a switching cycle, before turning on the primary side switch: the control unit is configured to generate the ZVS pulse in the secondary side winding, via the secondary side switches, such that the parasitic capacitor of the primary side switch is discharged, and to consequently turn on the primary side switch in ZVS conditions or near ZVS conditions.

In particular, when the voltage at the drain terminal of the primary side switch goes to zero or close to zero, the primary side switch is then turned ON in ZVS conditions.

The two switches (M6, M2) may have different characteristics based on the signal being used to drive each of the switch. The secondary side switch or MOSFET (M6) is driven by the ZVS pulse and the other secondary side switch or MOSFET (M2) is driven by the rectification signal.

As an example, one of the switches may be a power MOSFET and the other switch may be a low power MOSFET.

As an example, the ZVS pulse switch or MOSFET (M6) being driven by the ZVS pulse may be much more resistive than the rectification switch or MOSFET (M2) being driven by the rectification signal and much less capacitive (i.e., gate and source capacitance) than the one driving the rectification signal (M2).

Hence the rectification MOSFET (M2) may be a power MOSFET that is able to support high current conduction.

The ZVS pulse MOSFET (M6) may be a low power MOSFET and less power is needed to drive the ZVS pulse MOSFET. Advantageously, M6 therefore requires less energy to turn ON or OFF, as compared to other switches such as power MOSFETs.

FIG. 71 shows a flyback converter architecture including a secondary side rectifying switch driven by a rectification signal and a secondary side ZVS pulse switch configured to induce ZVS on the primary switch or ‘ZVS pulse’. In the implementation shown, the rectifying and ZVS pulse switches are coupled to the low voltage side/the secondary side of the transformer. Alternatively, the ZVS pulse switch may also be coupled to a medium or low voltage winding of the transformer located at the primary or secondary side of the converter.

Some components of the control unit may also be located on the primary side, such as a microcontroller.

Alternatively, the rectification switch M2 may also be a diode, or a switch controlled synchronously or by an ideal-diode controller.

This technique is logically equivalent to what is described with reference to FIG. 15E. Advantageously, the unbalance between the switches, such as an unbalance between the drain-source on resistance (Rds,on) of the switches, allows for a flyback converter with improved efficiency.

M2 is a low Rds,on MOSFET with a range between 1.5 milliohm and 50 milliohms. This is because M2 substantially conducts all the output current. On the other hand, M2 may have high gate (1-10 nF) and output (0.05 nF-2 nF) capacitance. As a result, the rectifying switch M2 may therefore be “energy expensive” in terms of switch on/off.

M6 is a medium-high Rds,on MOSFET with a range between range between 100 milliohms and 5 ohms and consequently it has low gate (0.03-1 nF) and output (10-50 pF) capacitances. Therefore, M6 may be a ZVS actuation MOSFET that is “energetically cheap” to operate or turn ON/OFF. The static losses are contained (despite the high resistance) because the currents involved for the ZVS impulse are typically low, such as less or equal than 0.5Arms (Amps root mean squared).

An advantage of this configuration is an improved efficiency at middle and light loads. Actuating the ZVS pulse is much less energetically expensive with this second MOSFET M6 as compared to other flyback converters, boosting efficiency especially at middle and light loads.

An advantage is that improved efficiency and ZVS are also achieved in zero load conditions or near zero load conditions.

Light load conditions may refer to a load that is less than 10% of the nominal output power. Middle load conditions may refer to a load that is less than or equal to 50% of the nominal output power.

Current flyback converters often achieve high efficiency at higher loads with a substantial decrease in efficiency under light load conditions. As a comparison, the architecture described achieves high efficiency or substantially similar efficiency for any type of load conditions. This has a significant impact in consumer electronics which are often working under zero or near zero load conditions. As a result, the architecture described is not only cost efficient but also provides a greener solution.

### 2) ZVS Pulse as an Extension of SYNC_RECT Pulse

Another implementation is now described that is similar to 1) above, as described in FIG. 71, but without using a second MOSFET M6. Alternatively, M6 can also be de-activated or even absent at all (as in the schemes of FIGS. 15A-15D).

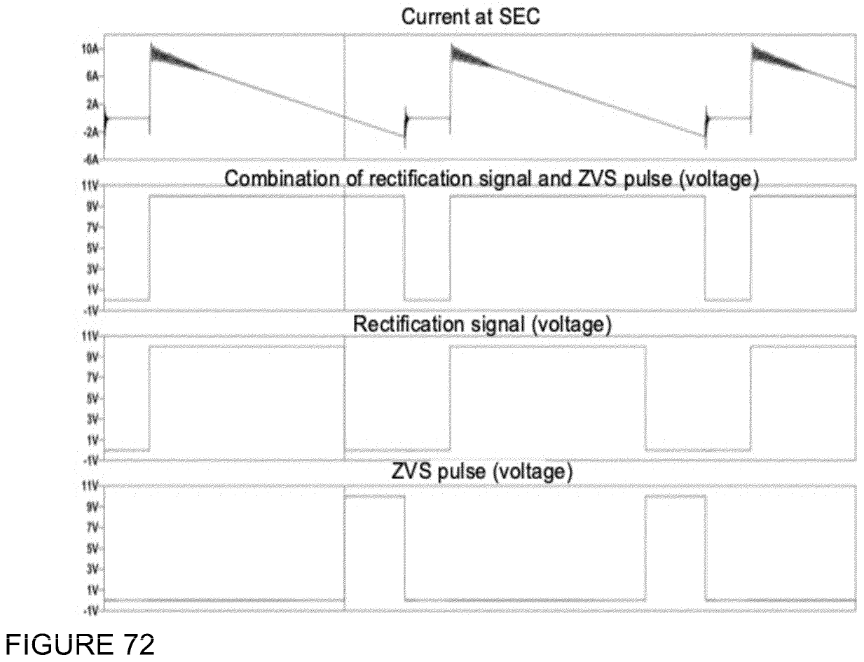

In this implementation, a single switch may be used, such as M2, and the signals, mainly the rectification signal and the ZVS pulse, are combined internally by a microcontroller. In this case, the ZVS pulse is added to the rectification signal using for example an embedded digital timer, as shown in the waveforms illustrated in FIG. 72. In this example, the ZVS pulse begins when the rectification signal ends.

An example to induce ZVS on the primary side switch is to simply use the main secondary MOSFET (M2) by extending its conduction time beyond the synchronous rectification window allowing the current to reverse (conceptually, “appending” the ZVS pulse at the end of the rectification pulse).

Some advantages include but are not limited to: a) one less active switch is used (no ZVS MOSFET); b) less driving losses (as only one MOSFET needs to be driven on the secondary side instead of two) are achieved.

Consequently, the switching frequency may need to be higher at middle or low loads, such as loads equal to or less than 50% of the nominal output power.

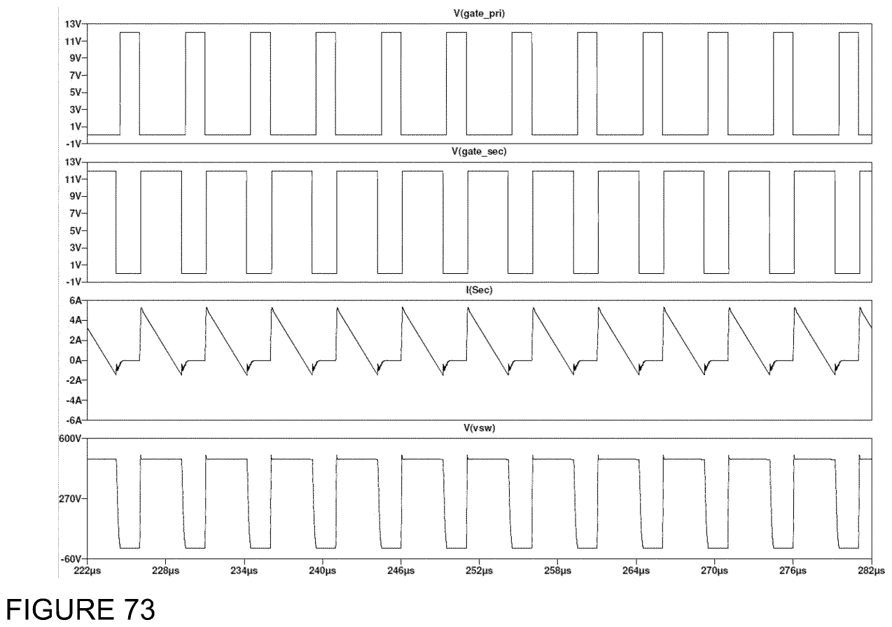

FIG. 73 shows a plot of the voltage at the gate of the primary side switch the voltage at the gate of the secondary side switch, the corresponding switching voltage vsw, and the current at the secondary side.

In both implementations described above, the duration of the ZVS pulse may be predetermined or pre-defined by a user. T_{zvs} refers to the approximate pulse width of the ZVS pulse.

To achieve a Zero Voltage Switching of the primary side switch, an amount of energy is introduced into the transformer to substantially “empty” the drain node of the primary side switch,

The system is then configured to reach a peak current value in the ZVS MOSFET (n*I_{zvs}) such that the corresponding primary peak current value (I_{zvs}) is sufficient to empty the primary node. The condition to be satisfied is the following:

$$\frac{1}{2} * {L}_{p r i} * {( {I}_{z v s} )}^{2} = \frac{1}{2} * {C}_{e q} * {( {V}_{i} + ( n * {V}_{o u t} ) )}^{2}$$

$$and therefore : {I}_{z v s} = \sqrt{( \frac{{c}_{e q}}{{L}_{p r \dot{ι}}} )} * ( {V}_{i} + ( n * {V}_{o u t} ) )$$

where Vᵢ refers to the input voltage (or V4 as seen in FIG. 71), Vₒᵤₜ refers to the output voltage, Lₚᵣᵢ refers the inductance value of the primary winding of the transformer, C_{eq} refers to an equivalent drain to ground total capacitance at the primary side switch (C_{eq} is not depicted in FIG. 71) and n refers to the transformer turn ratio between primary and secondary windings.

Contributors to the equivalent total capacitance C_{eq} may include: the total capacitance on the output side of the primary side MOSFET or Coss, the transformer intra-winding capacitance and any other stray capacitances.

To be able to reach the current peak value I_{zvs}, the necessary pulse T_{zvs} duration may be determined using the following:

$${T}_{z v s} = {I}_{z v s} * \frac{{L}_{p r i}}{n * {V}_{o u t}}$$

and therefore, integrating in the formula the target value of I_{zvs}:

$${T}_{z v s} = \frac{{V}_{i} + ( n * {V}_{o u t} )}{n * {V}_{o u t}} * \sqrt{{C}_{e q} * {L}_{p r i}}$$

As an example, if the input voltage Vᵢ is 300V and the output voltage Vₒᵤₜ is 15V, the flyback converter may be designed with an inductance of the primary winding Lₚᵣᵢ equal to 400 pH and an equivalent total capacitance C_{eq} being substantially equal to 30 pF. Using the above equation, with a current peak value I_{zvs} of about 106.8 ms, the necessary pulse T_{zvs} may be determined to be about 475 ns.

As the calculation above do not consider the entirety of the parasitic or non-linear phenomena, such as the Cₒₛₛ of the switches, some manual tuning may be necessary when fine-tuning the width of the pulse T_{zvs}. Tuning may also be automatically implemented via a microcontroller.

### 3) A Combination of the Two Techniques

The circuit scheme is the same indicated above for example 1) above, where two MOSFETs (M2) and (M6) are present on the secondary side. Several combinations of the two configurations above may be implemented depending on the required application.

As an example, to handle light loads, the MOSFETS (M2) and (M6) may be driven according to the example 1; to handle middle and high load conditions, the MOSFET (M6) may be deactivated and only the MOSFET (M2) may be driven according to the example 2.

Hence for lower load conditions, the MOSFET (M6) may be used in order to provide a higher flexibility as to when a ZVS pulse is generated. This provides a better control of frequency and lowers the switching frequency and reduces the overall losses.

For higher load conditions, only one MOSFET may be used. This optimises the overall run time of the transformer, ensuring that no idle time is introduced within the switching period with quasi-zero current flowing in the transformer. This, in turns, causes an overall reduction in transformer RMS currents and losses

Alternatively, the flyback converter may be configured to automatically detect the load conditions and to activate or de-activate the ZVS MOSFET (M6) depending on the detected load conditions. This may be done automatically by the control unit and may be implemented as a microcontroller or ASIC.

### Appendix—Key Features

In this Appendix, we list key features, with a number of optional features. The key features are organised using the same categories or core technology as described in the previous sections. Note that any of the key features of any categories can be combined with one or more of the other features, and any of the optional features of any categories. Any of the optional features can be combined with one or more of the other optional features.

### Section I. Flyback Converter

1.1 Improved Performance of Flyback Using a Control Unit with Two Different MOSFETs Connected in Parallel

### We can Generalise as Follows:

A flyback converter comprising:
a) a transformer having a primary side winding and a secondary side winding;
b) a primary side switch located at the primary side of the transformer;
c) two secondary side switches located at the secondary side of the transformer; in which the two secondary side switches are connected in parallel and have different characteristics;
d) a control unit configured to generate a rectification signal and a Zero Voltage Switching (ZVS) pulse and to drive the two secondary side switches; in which a secondary side switch is driven by the rectification signal and the other secondary side switch is driven by the ZVS pulse;
and in which at the end of a switching cycle, before turning on the primary side switch: the control unit is configured to generate the ZVS pulse in the secondary side winding such that the parasitic capacitor of the primary side switch is discharged, and to consequently turn on the primary side switch in ZVS conditions or near ZVS conditions.

A method of operating a flyback converter, the flyback converter comprising:
a) a transformer having a primary side winding and a secondary side winding;
b) a primary side switch located at the primary side of the transformer;
c) two secondary side switches located at the secondary side of the transformer; in which the two secondary side switches are connected in parallel and have different characteristics;
d) a control unit at the secondary side of the transformer; and in which the control unit is configured to generate a rectification signal and a Zero Voltage Switching (ZVS) pulse and to drive the two secondary side switches; in which a secondary side switch is driven by the rectification signal and the other secondary side switch is driven by the ZVS pulse;
and in which at the end of a switching cycle, before turning on the primary side switch: the control unit is configured to generate the ZVS pulse in the secondary side winding such that the parasitic capacitor of the primary side switch is discharged, and to consequently turn on the primary side switch in ZVS conditions or near ZVS conditions.

An advantage is that the efficiency of the flyback converter is improved at middle and light loads.

Another advantage is that the flyback converter provides substantially high efficiency under any load conditions, from zero load conditions to high load conditions.

Optional features:
The characteristics of the secondary side switches are selected based on the signal being used to drive each secondary side switch.
One secondary side switch is a high power MOSFET and the other secondary side switch is a low power MOSFET.
The secondary side switches are any combination of Silicon MOSFETs, GaN or SiC transistors with different drain to source on resistance. (This provides an unbalance between the MOSFETs connected in parallel).
The first secondary side switch or MOSFET (M2) is configured as a power rectifier and is driven by the rectification signal.
A secondary side switch or MOSFET (M6) is driven by the ZVS pulse.
A secondary side switch characteristics are determined such that the switch requires less energy to run (and hence also generates less heat).
The first secondary side switch or MOSFET (M2) has a lower drain source on resistance than the second control unit switch or MOSFET (M6).
One of the secondary side switch has a drain-source on resistance value that ranges between 1.5 milliohms and 50 milliohms, and the other secondary side switch has a drain-source on resistance value that ranges between 100 milliohms and 5 ohms.
The first secondary side switch or MOSFET (M2) has a higher gate to source capacitance than the second control unit switch or MOSFET (M6).
One secondary side switch has a gate to source capacitance value that ranges between 1 nanofarad to 10 nanofarads, and the other secondary side switch has a gate to source capacitance value that ranges between 0.03 nanofarad to 1 nanofarad.
The first secondary side switch or MOSFET (M2) has a higher output capacitance than the second control unit switch or MOSFET (M6).
one secondary side switch has an output capacitance value that ranges between 0.05 nanofarad to 2 nanofarads, and the other secondary side switch has an output capacitance value that ranges between 10 picofarad to 50 picofarads
The transformer is connected to a load. The secondary side switch (M6) is configured to be de-activated depending on the load conditions (such as middle and high loads).
The secondary side switch is de-activated when the load conditions are higher than a pre-determined threshold, such as higher than 10% of the nominal output power or 50% of the nominal power.
The secondary side switch is automatically de-activated when the load conditions are higher than a pre-determined threshold, such as higher than 10% of the nominal output power or 50% of the nominal power.
When the secondary side switch (M6) is de-activated or turned OFF, the control unit is configured to digitally add the ZVS pulse to the rectification signal.
The control unit is located on the secondary side of the transformer.
The control unit is located on the primary side of the transformer.
The control unit includes a first control sub-unit located on the primary side, and a second control sub-unit located on the secondary side.
   1.2 Improved Performance of Flyback Using a Control Unit with MOSFET Configured to Drive a ZVS Pulse

### We can Generalise as Follows:

A flyback converter comprising:
a) a transformer having a primary side winding and a secondary side winding;
b) a primary side switch at the primary side of the transformer;
c) a secondary side switch at the secondary side of the transformer;
d) a control unit at the secondary side of the transformer;
and in which the control unit is configured to digitally add a ZVS pulse to a rectification signal, and in which the ZVS pulse is configured to discharge the parasitic capacitor of the primary side switch allowing to consequently turn on the primary side switch in ZVS conditions or near ZVS conditions.

A method of operating a flyback converter, the flyback converter comprising:
a) a transformer having a primary side winding and a secondary side winding;
b) a primary side switch at the primary side of the transformer;
c) a secondary side switch at the secondary side of the transformer;
d) a control unit configured to digitally add a ZVS pulse to a rectification signal, and in which the ZVS pulse is configured to discharge the parasitic capacitor of the primary side switch allowing to consequently turn on the primary side switch in ZVS conditions or near ZVS conditions.

### Optional Features:

characteristics of the secondary side switch, mainly the drain source on resistance, gate to source capacitor or output capacitance are determined such that the secondary side switch optimises the overall run time of the transformer.
the secondary side switch has a source-drain on resistance value that ranges between 1.5 milliohm and 50 milliohms.
the secondary side switch has a gate capacitance value that ranges between 1 nanofarad and 10 nanofarads.
the secondary switch has an output capacitance value that ranges between 0.05 nanofarad and 2 nanofarads.
the duration of the ZVS pulse is configured to enable a peak current value (Izvs) to be reached such that the voltage at the drain of the primary side switch drops down to zero or near zero volt.
the duration of the ZVS pulse is calculated as a function of the input voltage, output voltage, inductance of the primary side winding, an equivalent drain to ground capacitance at the primary side switch and the number of turns of the windings of the transformer.
the duration of the ZVS pulse T_{zvs} is determined using the following equation:

$${T}_{z v s} = \frac{{V}_{i} + ( n * {V}_{o u t} )}{n * {V}_{o u t}} * \sqrt{{C}_{e q} * {L}_{p r i}} ,$$

where Vᵢ refers to the input voltage, Vₒᵤₜ refers
to the output voltage, Lₚᵣᵢ refers to the inductance value of the primary winding of the transformer, C_{eq} refers to an equivalent drain to ground total capacitance at the primary side switch and n refers to the transformer turn ratio between primary and secondary windings.
The control unit is located on the secondary side of the transformer.
The control unit is located on the primary side of the transformer.
The control unit includes a first control sub-unit located on the primary side, and a second control sub-unit located on the secondary side.

An advantage is the ability to induce ZVS pulse without the need of a dedicated switch or MOSFET and signal, by simply turning off the rectification switch or MOSFET slightly after a “standard controller” would. This in turns, leads to a power converter with a cheaper BOM. Another advantage is that this configuration optimises the overall run time of the transformer.

The flyback converters described above may be implemented together with any one or more of the features, or sub-features below.

### 2.1 Improved Performance of Flyback by Forcing ZVS on the Primary Side Switch

### Concept A—Method of Generating a Secondary Side Pulse to Force ZVS on the Primary Side Switch

Method of operating a flyback converter,
the flyback converter comprising:
   a transformer having a primary side winding and a secondary side winding, a primary switch at the primary side of the transformer and a secondary switch at the secondary side of the transformer, and a control unit;
   the method comprising:
   at the end of a switching cycle, before turning on the primary side switch: the control unit is configured to generate a Zero Voltage Switching (ZVS) pulse in the secondary side winding such that the parasitic capacitor of the primary switch is discharged, and to consequently turn on the primary side switch in ZVS conditions or near ZVS conditions.
      Concept B—Method of Generating a Secondary Side Pulse to Force ZVS on the Primary Side in which the Secondary Switch is Turned on when a Minimum Voltage at the Drain Terminal of the Secondary Switch is Detected.

Method of operating a flyback converter, the flyback converter comprising: a transformer having a primary side winding and a secondary side winding, a primary switch at the primary side of the transformer and a secondary switch at the secondary side of the transformer, a primary side controller connected to primary switch, and a control unit;
the method comprising:
at the end of a switching cycle, before turning on the primary side switch: the control unit is configured to generate a ZVS pulse in the secondary winding when a local minimum voltage at the drain terminal of the secondary side switch is detected, such that the parasitic capacitor of the primary switch is discharged, and to consequently turn on the primary side switch in ZVS or near ZVS conditions.

### Concept C—Phase Shift Regulation of a Flyback Converter

Method of operating a flyback converter,
the flyback converter comprising: (i) a transformer having a primary side winding and a secondary side winding, a primary switch in series with the primary side of the transformer and a secondary switch in series with the secondary side of the transformer, (ii) a control unit; (iii) a synchronizer unit located at the secondary side of the transformer and including a rectifier or an ideal diode, and (iv) an output;
the method comprising: driving the secondary switch using a synchronous rectification signal and adjusting the power delivered to the output of the flyback converter by adjusting the duration of a pulse control signal.

### Concept D—Method of Generating a Secondary or Auxiliary Side Pulse to Force ZVS on the Primary Side Switch

The methods and related systems described in this section may also be applied to a flyback converter including an auxiliary winding. In this case, the ZVS pulse may be generated on the auxiliary winding itself in order to force the primary switch to turn on under ZVS or near ZVS conditions. We can generalise as follows:

Method of operating a flyback converter,
the flyback converter comprising:
   a transformer having a primary side winding, a secondary side winding and an auxiliary winding, a primary switch at the primary side of the transformer, a secondary switch at the secondary side of the transformer, an auxiliary switch at the auxiliary side, and a control unit;
   the method comprising:
   at the end of a switching cycle, before turning on the primary side switch: the control unit is configured to generate a ZVS pulse in the secondary winding or in the auxiliary winding, such that the parasitic capacitor of the primary switch is discharged, and to consequently turn on the primary side switch in Zero Voltage Switching conditions or near ZVS conditions.

Generally applicable optional features:
The flyback converter is a quasi-resonant flyback.
The ZVS pulse consists in turning on the secondary side switch or the auxiliary side switch for a predefined time duration.
The ZVS pulse duration is dependent on the parameters of the converter, such as input voltage or output power.
The predefined time duration is less than the switching period or cycle of the converter, such as less than 10% of the switching period.
The ZVS pulse is configured to discharge the primary side parasitic capacitor until the voltage at the drain of the primary side switch drops down to a predefined minimum voltage, such as zero or near zero volt.
The parasitic capacitance of the primary switch is discharged until a value that is less than 50% of the converter's input voltage.
Turn-on hard switching losses are reduced to almost zero or near zero.
The control unit implements a control scheme at a fixed frequency.
Primary switch and secondary switch are MOSFETs.
Switch is GaN FET.
Switch is a SiC FET.
Switch is a Si FET.
No communication link between the primary side and the secondary side is present.
A communication link exists between the primary side and the secondary side.
The communication link uses one or a combination of the following: capacitive link, inductive link, a proximity antenna, an integrated power and signal transformer.
The control unit is located on the primary side circuit.
The control unit is located on the secondary side circuit.
The control unit includes a first control sub-unit located on the primary side, and a second control sub-unit located on the secondary side.
The control unit includes a digital controller.
The converter includes a synchronizer unit that is configured to detect an optimum instant to turn on the secondary switch.
Synchronizer unit is configured to synchronize the ZVS pulse with a secondary side drain valley.
Synchronizer unit at the secondary side is configured to synchronize the ZVS pulse while sensing the voltage at the secondary side to detect a secondary side drain valley.
Synchronizer unit side is configured to synchronize the ZVS pulse with a primary side drain voltage local peak.
Synchronizer unit is configured to synchronize the ZVS pulse with an auxiliary side drain voltage valley or local peak.
The secondary side switch is driven by combining two signals: the synchronous rectification signal and the pulse control signal.
The pulse control signal is configured to rise at the synchronous rectification signal falling edge.
When the synchronous rectification signal is high, the secondary switch conducts current from its source terminal to its drain terminal, transferring power from the transformer to an output capacitor, and when the pulse control signal is high, the switch conducts current from its drain terminal to its source terminal, reflecting power from the output capacitor to the transformer.
A secondary side rectifier is configured to control the secondary switch.
Secondary side switch is driven by combining a secondary rectification signal and the ZVS pulse signal and/or the pulse control signal
Auxiliary side switch is driven by combining a secondary rectification signal and the ZVS pulse signal and/or the pulse control signal
The combination of the signals is implemented in hardware.
The combination of the signals is implemented by a digital control (ie. a microcontroller with an embedded digital timer).
The control unit is configured to send a ZVS request.
The control unit is configured to send a turn-on request to the primary side switch.
The control unit is configured to send pulses or turn-on requests to the primary side, in which the parameters of the pulses define the primary side switch duty cycle.
The control unit is configured to send pulses or turn on requests to the primary side, in which the parameters of the pulses define the current threshold at which the primary side switch must turn off.
The method uses an indirect pulse detection technique in which the primary side switch is turned on after a ZVS pulse is detected.
The indirect pulse detection technique is implemented on the primary side circuit of the transformer.
The indirect pulse detection technique senses the primary switch drain voltage in order to detect a deep valley.
The indirect pulse detection technique senses the primary switch drain voltage in order to detect a voltage higher than a predefined threshold and that is maintained longer than a predefined threshold duration.
The indirect pulse detection technique senses the dv/dt slope of the primary switch drain voltage.
The primary side switch on-time is calculated from the frequency of the ZVS pulse.
The control unit is configured to vary the frequency of the ZVS pulse.
Parasitic capacitance corresponds to the drain to source parasitic capacitance of the primary side switch.
The control unit is a Proportional Integral Derivative (PID).
The control unit is digital or analog.

### Concept E—Implementation of the Flyback Converter Using any of the Concepts or Sub-Concepts Above

A flyback converter comprising:
a transformer including a primary side winding and a secondary side winding; an input port coupled to a voltage source and connected to the primary side winding of the transformer;
a primary switch arranged between the primary side winding of the transformer and the ground;
a secondary switch arranged in series between the secondary side winding of the transformer and an output port,
in which a control unit is configured to turn on the secondary side switch using a ZVS pulse in order to discharge the parasitic capacitor of the primary side switch, before turning on the primary side switch.

### Optional Features:

Flyback converter without PFC delivers up to 75 Watts.
Flyback converter with PFC delivers usually up to 100 W-500 W.
Flyback converter is used for USB power delivery.

### 2.2 Improved Performance of Flyback Converter Using an Auxiliary Winding

Concept A—A Flyback Converter with Bifilar Winding Between the Primary Winding and the Auxiliary Winding.

A flyback converter, the flyback converter comprising:
(i) a transformer including primary side winding, secondary side winding and auxiliary winding, in which the auxiliary winding is configured to have a high—almost ideal (k=1)—mutual coupling with the primary side winding and
(ii) a primary switch, a secondary switch and an auxiliary switch, each located respectively at the primary side, secondary side and auxiliary side of the transformer; in which a bifilar or n-filar wire is used for the primary and auxiliary windings to ensure high coupling.

### Optional Features:

Zero or near zero leakage inductance exists between the primary and auxiliary windings.
Winding configuration of the auxiliary winding determines the auxiliary voltage at the auxiliary winding.
The primary winding is composed of two windings in series.
The auxiliary winding is composed of two windings in antiseries.
The auxiliary winding is partially wound in series and partially wound in anti-series relative to the primary winding.
The wire of the primary winding is made of one or more individually-insulated strands and is grouped with the auxiliary winding.
The wire of the auxiliary winding is made of one or more individually-insulated strands and is grouped with the primary winding.
The primary and the auxiliary windings are grouped together and protected by the same coating. The coating may provide triple insulation.
The auxiliary winding is configured to ensure a lower auxiliary inductance in comparison with the primary inductance (the anti-series inductance cancels the series inductance, thus the difference between series and antiseries is used to define the resulting auxiliary inductance).
The auxiliary winding is configured to ensure a lower auxiliary inductance in comparison with the primary inductance in order to get a low auxiliary voltage (recycled energy) useful to supply the converter.
The auxiliary winding is configured to discharge the parasitic capacitor of the primary side switch.
The flyback converter is configured to store the energy recovered by the auxiliary winding.
Discharging the parasitic capacitor of the primary side switch using the auxiliary winding forces ZVS on the primary side of the transformer to turn on the flyback converter.
The energy recovered by the auxiliary winding is used to supply components of the converter, such as the controller or the driver or any other peripherals.
A capacitor is used to store the energy recovered by the auxiliary winding (which otherwise must be dissipated because of the k<1 between primary side and secondary side, which leads to leakage inductance on the primary side is not coupled with secondary side).
Dissipative clamping is avoided or reduced because of the energy recycled.
Parasitic capacitor is discharged at the end of a switching cycle, before turning on the primary side switch.
Parasitic capacitor is discharged until the voltage at the drain of the primary side switch drops down to zero or near zero volt.
Hard-switching turn-on of the switches (MOSFET) is avoided or reduced because of the parasitic capacitor discharged before the turn-on of the primary side switch.

### Concept B—Auxiliary Voltage Generation for Transformer-Based Converters

Method of generating an auxiliary voltage in a converter, the converter comprising: a transformer including primary side winding, secondary side winding and auxiliary winding, in which the auxiliary winding is connected to a rectification circuit and an auxiliary switch, the method including the step of generating an auxiliary voltage by enabling or disabling the rectification circuit using the auxiliary switch.

### Optional Features:

The converter does not need a fixed input and/or output.
The auxiliary winding is connected between a local ground and the anode terminal of a first diode.
The auxiliary switch is connected between a ground terminal and the node of a first inductor, and in which the second node of the first inductor is connected to the cathode terminal of the first diode, a first capacitor is connected between the cathodes terminals of the first and second diodes, tha anode of the second diode is connected to the local ground, a second capacitor is connected to the local ground and to the auxiliary voltage rail, a second inductor is connected to the auxiliary voltage and the cathode terminal of the second diode,
The auxiliary circuit couples to a feedback circuit that is configured to enable/disable the switch when the auxiliary voltage is lower or/higher than a certain threshold.
The converter includes an external linear regulator.
The auxiliary switch is driven by an analog circuit.
The auxiliary switch is driven by a digital controller.

### Concept C—Auxiliary Voltage Generation for Switching and Resonant Circuits

Method of generating an auxiliary voltage in a converter including an auxiliary voltage circuit, the method including: generating the auxiliary voltage from an input voltage at a switching or resonant node, in which a capacitor is configured to charge during the positive front of the input voltage and to deliver current to the auxiliary voltage during the negative front of the input voltage.

Optional features:
The converter does not include magnetic components such as inductors and transformers.
The capacitor is directly connected to the switching or resonant node.
The auxiliary voltage circuit includes 1) a first diode connected between a local ground and a central node that connects to the capacitor and 2) a second diode connected between the central node and the output delivering the auxiliary voltage.
One or more additional capacitors each in series with a switch are added in parallel to the first diode,
In order to regulate the output voltage, a control circuit enables or disables the switches in series with the additional capacitors.

### Section II. Active Storage

Concept A: Magnetic single-stage PFC AC/DC converter

A single stage PFC AC/DC converter system comprising a transformer including a primary winding, a secondary winding and an auxiliary winding, and in which:
(i) the primary winding couples to an AC input voltage,
(ii) the secondary winding provides an output voltage to a load,
(iii) the auxiliary side circuit is configured to store and release energy;
and in which the system is configured to (a) regulate the output voltage or current such that the output voltage or current is substantially ripple-free and (b) regulate the input current such that the input current is substantially in phase with the input voltage.
   Concept B: Magnetic Single-Stage PFC AC/DC Converter in which the Primary Side Provides the PFC Function and the Auxiliary Side Provides the Converter Function.

A single stage PFC AC/DC converter system comprising a transformer including a primary winding, a secondary winding and an auxiliary winding, and in which:
(i) the primary winding couples to an AC input voltage,
(ii) the secondary winding provides an output voltage to a load,
(iii) the auxiliary side circuit is configured to store and release energy, in which the auxiliary side circuit is configured to regulate the output voltage or current such that the output voltage or current is substantially ripple-free,
and in which the primary side circuit is configured to regulate the input current such that the input current is substantially in phase with the input voltage.
   Concept C: Magnetic Single-Stage PFC AC/DC Converter in which the Primary Side Provides the Converter Function and the Auxiliary Side Provides the PFC Function.

A single stage PFC AC/DC converter system comprising a transformer including a primary winding, a secondary winding and an auxiliary winding, in which
(i) the primary winding couples to an AC input voltage,
(ii) the secondary winding provides an output voltage to a load,
(iii) the auxiliary side circuit is configured to store and release energy, in which the auxiliary side circuit is configured to regulate the input current such that the input current is substantially in phase with the input voltage,
and in which the primary side circuit is configured to regulate the output voltage or current such that the output voltage or current is substantially ripple-free.
   Concept D: Magnetic Single-Stage PFC AC/DC Converter in which the Output Voltage is Regulated by Sensing the Output Voltage

A single stage PFC AC/DC converter system comprising a transformer including a primary winding, a secondary winding and an auxiliary winding, in which
the primary winding couples to an AC input voltage and the secondary winding provides an output voltage to a load,
and in which based on continuously sensing the input voltage and the output voltage: (a) either the primary side or the auxiliary side of the transformer supplies the secondary side of the transformer, such that the output voltage or current is substantially ripple-free and (b) the primary side supplies both a storage capacitor on the auxiliary side and the load on the secondary side, such that the input voltage and the input current are substantially in phase.

### Concept E: Active Storage PFC Using Parallel Storage Capacitor

A single stage PFC AC/DC converter system comprising a transformer including a primary winding, a secondary winding and an auxiliary winding, in which
(i) the primary winding couples to an AC input voltage,
(ii) the auxiliary winding couples to a storage capacitor,
(iii) the secondary winding provides an output voltage to a load;
and in which the storage capacitor is configured to (a) charge during a main phase, wherein the primary side of the transformer supplies the secondary side of the transformer, and (b) discharge during an aux phase, wherein the auxiliary side of the transformer supplies the secondary side of the transformer.
   Concept F: A Single Stage PFC AC/DC Converter System with Zero-Voltage-Switching (as Defined in Section I Above)

Generally applicable optional features:
No direct connection exists between the AC input voltage/power and DC output voltage/power (thus providing an isolation barrier).
The primary side circuit includes a rectifier configured to rectify an AC input voltage.
Sensing unit at the primary side is configured to sense the rectified voltage and compare the rectified voltage to a threshold voltage.
The method includes the step of sensing the input current.

### Auxiliary Winding Features

Auxiliary winding is configured to have a high mutual coupling with the primary winding.
A bifilar or n-filar wire is used for the primary and auxiliary windings to ensure high coupling.
Auxiliary winding can be partially wound in series and partially wound in anti-series relative to the main winding in order to get the desired winding ratio between main winding and auxiliary winding (thus, the desired voltage on the auxiliary winding lower than the voltage on the main winding), ensuring at the same time very high coupling between main winding and auxiliary winding.
Auxiliary winding and main winding can be wound with n-filar winding, so that for turn of the main winding there are n turns of the auxiliary winding, in order to get the desired winding ratio between main winding and auxiliary winding (thus, the desired higher voltage on the auxiliary winding that the voltage on the main voltage), ensuring at the same time very high coupling between main winding and auxiliary winding.
Auxiliary winding is configured to achieve simultaneously high coupling factor k with the primary winding and low auxiliary winding inductance in order to step down the voltage on the auxiliary winding.
Auxiliary winding is configured to achieve simultaneously high coupling factor k with the primary winding and high auxiliary winding induction in order to step up the voltage on the auxiliary winding
Auxiliary winding is located on the primary side of the transformer.
Auxiliary winding is located on the secondary side of the transformer.
Auxiliary and primary windings are in flyback configuration.
Auxiliary and primary windings are in forward configuration.

### Storage Capacitor

Excess energy between the primary side and secondary side windings is stored through auxiliary winding on the primary side of the transformer (excess energy is the difference of energy between the energy requested by the load and the excess energy absorbed by the system in order to ensure that the input current is in phase with the input voltage).
Excess energy is the difference between the energy delivered to the load by the system and the energy absorbed from the grid (AC input) by the system.
Auxiliary side circuit includes a storage (or bulk) capacitor.
Auxiliary side stores the excess energy using a storage capacitor.
Auxiliary side stores the energy coming from the leakage inductance between primary and secondary windings.
The storage capacitor charges during a main phase and discharges during an aux phase.

### Primary Side

Primary control unit coupled to the primary winding is configured to regulate the duty cycle of the primary side switch.
Primary control unit includes a switch that is connected in series with the primary winding.

### Secondary Side

A rectifier switch or diode couples to the secondary winding.

### Auxiliary Side

Auxiliary control unit includes a bidirectional switch.
Auxiliary control unit coupled to the auxiliary winding is configured to turn on and off the bidirectional switch.
Bidirectional switch comprises two switches or MOSFETS connected in anti-series. (We'll refer to the two MOSFETs of the auxiliary control unit as the first aux MOSFET or M2 and the second aux MOSFET or M3.)

### Battery Pack or Super Capacitor

Auxiliary winding couples to a battery pack or super capacitor.
Secondary winding couples to a battery pack or super capacitor.
The single-stage PFC AC/DC converter is used as a combined power bank and power adaptor.

### Main Phase

At a main phase, the primary side of the transformer supplies the secondary side of the transformer.
At the main phase, the primary side of the transformer also supplies the auxiliary side of the transformer charging the storage capacitor.

### Auxiliary Phase or Aux Phase

At an aux phase, the auxiliary side supplies the secondary side of the transformer.
At the aux phase, the storage capacitor discharges in order to supply the secondary side.

### Threshold Voltage

When the rectified input voltage is lower than the threshold voltage, the converter works in the main phase
When the rectified input voltage is lower than the threshold voltage, the converter either works in the aux phase or toggles between the main and aux phase.
   Optional Features of Concept B Above in which the Primary Side Provides the PFC Function and the Auxiliary Side Provides the Voltage Converter Function.

### Main Phase

Primary control unit regulates the duty cycle during the main phase in order to ensure that input current is in phase with the input voltage, hereby acting as a PFC.
During the main phase, M2 acts as a diode. This can be obtained by just keeping the MOSFET turned off or driving it as an ideal diode (turned on when a current flows from source to drain).
During the main phase, M3 is driven to regulate the duty cycle and to control the amount of energy stored in the storage capacitor based on sensing the output voltage (i.e if the output voltage is higher than a predetermined output voltage, the storage capacitor charges—hence the storage capacitor is configured to store any excess energy in order to regulate the output voltage—the higher the difference between the power absorbed by the load and the power absorbed by the converter, the higher the duty cycle of M3 in order to store more energy on the storage capacitor).

### Aux Phase

Primary control unit is turned off during the aux phase.
During the aux phase, M3 is turned on.
During the aux phase, M2 and M3 are driven with the same signal.
During the aux phase, the M2 is driven with a duty cycle proportional to the amount of energy supplied to the secondary side by the storage capacitor. Thus, during the aux phase the storage capacitor is supplying energy to the load.
   Optional Features of Concept C Above in which the Primary Side Provides the Voltage Converter Function and the Auxiliary Side Provides the PFC Function:

### Main Phase

Primary control unit regulates the duty cycle during the main phase in order to ensure that output voltage or current is stable, acting as a voltage or current controller.
During the main phase, M2 acts as a diode. This can be obtained by just keeping the MOSFET turned off or driving it as an ideal diode (turned on when a current flows from source to drain).
During the main phase, M3 is driven regulating the duty cycle to control the amount of energy stored in the storage capacitor based on sensing the input voltage to be in phase with the input voltage (thus, the aux control is acting as a PFC).

### Aux Phase

Primary control unit is turned off during the aux phase.
During the aux phase, M3 is turned on.
During the aux phase, M2 and M3 are driven with the same signal.
During the aux phase, M2 is driven with a duty cycle proportional to the amount of energy supplied to the secondary side by the storage capacitor. Thus, during the aux phase the storage capacitor is supplying energy to the load.

Examples of advantages are, but not limited to: as compared to standard PFC for similar requirement (input AC, output voltage or current, power delivered):
Higher efficiency (due in part because the average current on the PFC auxiliary circuit is reduced).
Reduced size of the storage capacitor (this is because for a normal converter, energy flows from input to output continuously—however here the amount of energy flowing through the capacitor is much less).
Reduced cost as a cheap Flyback-like single-magnetic topology is used.
Improved safety—as no direct connection between main and output power.
Single stage PFC converter provides both a simple configuration with high efficiency.
The single stage PFC acts both as a PFC and as a regulator.

### Use Case Applications

[300 Watts TV panel power supply]. 110-230 VAC input, 22V 200 W main output rail, 12V 100 W secondary output rail. Each output rail is generated by a converter based on this architecture.

[150 Watts power supply—provide general details]. 110-230 VAC input, 40V single output rail generated by a converter based on this architecture

Concept G: Single Stage AC/DC Converter in which Storage Element is a Battery Pack or a Super Capacitor

A single stage AC/DC converter system comprising a transformer with a primary winding, a secondary winding and an auxiliary winding, in which the primary winding and auxiliary winding are configured to have a high mutual coupling, and in which the primary winding couples to an AC input voltage and the secondary winding couples to a battery pack or one or more supercapacitors and provides an output voltage to a load.

### Optional Features:

Battery pack includes a plurality of lithium ion battery cells (advantage of using battery pack as a storage element includes improvement of efficiency and reduction of size of the storage element and reduction of size of the ripple as more energy can be stored).
Battery pack is connected to a DC/DC converter that is configured to regulate the output voltage at the load.
System is used as a PFC (configured to (a) regulate the output voltage or current such that the output voltage or current is substantially ripple-free and (b) regulate the input current such that the input current is substantially in phase with the input voltage).
Single stage AC/DC converter system acts as a combined power bank and power adaptor.
Single stage AC/DC converter system is implemented on a single chip.
Primary and secondary windings are configured to have a low mutual coupling.
System is configured to enforce ZVS or almost ZVS conditions on the primary side.

### Section III. Active Parallel Filter

### Concept A: AC/DC Converter Including Insulated PFC

AC/DC converter for providing several output voltages, the AC/DC converter comprising:
(a) a single stage insulated PFC for providing power factor correction; (b) a storage element connected to the output of the PFC; and
(c) several DC to DC converters providing multiple output voltages.

Optional features:
Removes the need of having an input storage capacitor (therefore energy can be absorbed in a sinusoidal way).
An input bridge rectifier is placed before the insulated PFC stage.
The insulated PFC stage is bridgeless.
AC/DC converter includes a storage element that is composed by one or more capacitors and/or supercapacitors and/or batteries.
Removes the need of having a LLC with an isolation barrier.
Removes the need of having a flyback converter with an isolation barrier.
Signal transmitted across the isolation barrier of the PFC.
Capacitor is a low voltage storage capacitor—<50V.
When output voltage needed is lower than the storage voltage, buck converters are used.
Any converters can be used, such as flyback, forward, quasi resonant, LLC or LCC converters, class-Egg, Quar-Egg, class-E, or insulated converter described in section IV.
Capacitor is selected based on the average voltage and ripple voltage.
AC/DC converter is used as a combined power bank and power adaptor.

The following optional concepts provide specific architectures which can be used to implement an insulated PFC:
Insulated PFC is implemented with class-Egg architecture and magnetic coupling;
Insulated PFC is implemented with a class-Egg architecture and capacitive coupling;
Insulated PFC is implemented with a bridgeless insulated PFC.

The storage element when implementing these architectures may be a capacitor, super capacitor or battery pack.

### Concept B: Idea of Non-Inverting Buck Boost Converter (Optionally Insulated)

Method for transferring power from a DC voltage source to a DC load, in which the converter is based on a cuk converter wherein the cuk storage capacitor is split into two storage capacitors C1 and C3 and the nodes at the junction between the storage capacitors and the DC load are inverted (by twisting the wires), such that power is transferred from the DC voltage source to the DC load in a non-inverting way.

### Optional Features:

The converter may be optionally insulated or non-insulated.
The insulated converter provides safety insulation.
The insulated converter increases storage voltage.
The converter has no restriction on input voltage.
The primary side circuit includes an input capacitor, the primary side inductor and the primary switch. The secondary side circuit includes an output capacitor, the secondary inductor and the secondary switch. A first insulating capacitor is connected to the node in common between the primary side inductor and the primary circuit input capacitor, and the node in common between the secondary side switch and the secondary side inductor. A secondary insulating inductor is connected to the node in common with the primary side switch and the primary side input capacitor, and the node in common between the secondary side switch and the secondary side output capacitor.
The converter is bidirectional.
   Concept C: Single Stage AC/DC Converter with a Parallel Active Energy Storage

A single stage AC/DC converter with a parallel active energy storage, in which the converter comprises an insulated PFC coupled to an active parallel storage including a control unit and a storage element, in which the active parallel storage is configured to store and release energy in order to (a) regulate the output voltage or current such that the output voltage or current is substantially ripple-free and (b) regulate the input current such that the input current is substantially in phase with the input voltage.

### Optional Features:

The storage element is made of one or more capacitors, batteries and/or supercapacitors
The active parallel energy storage is placed on the primary side, connected to the insulated PFC input voltage rail.
The active parallel energy storage is placed on the secondary side, connected to the insulated PFC output voltage rail.

The following concepts (Concept D to F) provide specific architectures which can be used to implement the active parallel storage.

Concept D: Parallel Storage with Non-Insulated DC-DC Bidirectional Converter

Active parallel storage that is configured to act as a boost converter when the storage element is charging and as a buck converter when the storage element releases energy, or vice versa to act as a buck converter when the storage element capacitor is charging and as a boost converter when the storage element capacitor releases energy

### Optional Feature:

The active parallel storage circuit includes two switches.
   Concept E: Parallel Storage with Resonant Capacitive Circuit

Active parallel storage provided by a bi-directional circuit comprising two inductors, two low-side switches and a storage element, and in which the galvanic isolation barrier is provided between the input terminals and the storage capacitor.

### Optional Features:

galvanic isolation barrier is provided by one or more capacitors.
circuit provides ZVS.
control unit can be driven at very high frequency.
control unit includes two low-side switches.
the symmetrical circuit can provide transfer of energy from rail to storage or storage to rail.
bi-directional circuit achieved by changing the driving of the switches.
   Concept F: Parallel Storage with Weak Coupling Between Inductors

Active parallel storage provided by a bi-directional circuit comprising two inductors, two low-side switches and a storage element, in which the two inductors are configured to have mutual coupling and a leakage inductance, and in which galvanic isolation barrier is provided between the input terminals and the storage element.

### Optional Features:

leakage inductance is configured to resonate with the switch parasitic capacitance.
active parallel storage can be configured as a forward or flyback converter.
coupling between inductors can be used to transfer energy to storage.
two inductors are arranged on the same core.

Other architectures may be used to achieve this active parallel storage, such as simple flyback converter (enabling ZVS or ZCS operations), a standard cuk converter or a modified cuk converter as provided above.

### Concept G—AC/DC Including a Secondary Side Storage Element

An AC/DC power converter system for receiving an input supply voltage and for supplying power to at least one load, the system comprising:
(i) an insulated power converter connected to the input supply voltage; in which the insulated power converter includes a transformer with a primary side winding and a secondary side winding;
(ii) a storage element connected to the secondary side of the insulated power converter; and
(iii) a DC/DC converter connected to the storage element and configured to supply power to at least one load.

### Optional Features:

storage element comprises one or more batteries and/or supercapacitors.
AC/DC power converter operates efficiently over a broad range of power supply requirements.
AC/DC power converter is able to have a peak input power lower than 75 W.
AC/DC power converter is able to supply a load higher than the input power multiplied by the converter's efficiency without exceeding 75 W input power—thus, without having to use a PFC stage between the input voltage and the insulated power converter.
AC/DC power converter is configured to provide a high level of output power (greater than 75 W multiplied by the converter's efficiency) for a time period determined by the state of charge (SOC) of the storage element, compensating the input power limit of 75 W needed to avoid PFC;
AC/DC power converter is configured to supply at least one load for a time period determined by the state of charge (SOC) of the storage element, even when the AC input voltage is not present, hence providing power bank functionality.

### Section IV. Insulated Converter

### Concept A—Insulated Converter

An insulated converter comprising: a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node; and in which the primary winding and secondary winding are arranged on the same core and configured to have a weak mutual coupling k.

### Optional Features:

The transformer is a weakly coupled transformer as implemented by any of the features listed above.
Half bridge circuit is configured to provide a required switching frequency.
When the input source is an AC input, the drain terminal of the upper MOSFET connects to the input source through a diode and the source terminal of the upper MOSFET connects to the second node of the primary winding.
The source terminal of the lower MOSFET is connected to the input source through a diode; the drain terminal of the lower MOSFET connects to the second node of the primary winding.
The AC input is rectified by an input bridge rectifier followed by a big capacitor, so the input source of the converter is quasi-DC.
The AC input is rectified by an input bridge rectifier followed by a small (or none) capacitor, so the input source of the converter is a rectified sine.
When the input source is a DC input, its positive terminal is connected to one node of the primary winding, and its negative terminal is connected to the source terminal of the lower MOSFET.
When the input source is a DC input, its negative terminal is connected to one node of the primary winding, and its positive terminal is connected to the drain terminal of the upper MOSFET.
A capacitor is connected to the drain terminal of the upper MOSFET and the source terminal of the lower MOSFET.
A capacitor is connected to the drain terminal of the upper MOSFET and one terminal of the primary winding, another capacitor is connected to the same terminal of the primary winding and the source terminal of the lower MOSFET.
The bridgeless isolated converter directly connects to an AC input voltage to provide a single stage wireless charger.
The converter works in forced continuous conduction mode and is able to achieve ZVS. The low MOSFET is always turned off when the primary winding current is flowing toward the half-bridge switching node, so, during the dead time, the leakage inductance of the winding pushes current to the node increasing its voltage till the voltage across the high-side MOSFET is zero. The high-side MOSFET is then turned on in ZVS. The high-side FET turns off when the primary winding is draining current from the switching node, so the node reaches zero volts and the low-side MOSFET is turned on in ZVS.
Secondary winding is connected to a rectifier, such as a voltage double circuit or a full bridge circuit or any other rectifier circuit.
Windings are wire windings.
Windings are planar windings printed on a substrate.
Primary and secondary windings are planar windings printed on the same substrate.
Primary windings are printed on one side of the substrate, and the secondary windings are printed on the other side of the substrate.
Primary winding is printed on the inner layers of the substrate.
Secondary winding is printed on the inner layers of the substrate.
Windings are a combination of wire windings and planar windings.
One inrush current diode is placed between an input terminal and the source terminal of the low-side MOSFET, in order to limit the MOFET stress due to the startup charge of the capacitor.
One inrush current diode is placed between an input terminal and the drain terminal of the high-side MOSFET, in order to limit the MOFET stress due to the startup charge of the capacitor.
One inrush current diode is placed between the switching node and the source terminal of the low-side MOSFET, in order to limit the MOFET stress due to the startup charge of the capacitor.
One inrush current diode is placed between the switching node and the drain terminal of the high-side MOSFET, in order to limit the MOFET stress due to the startup charge of the capacitor.
One voltage clamping device (zener diode, Transient Voltage Suppressor, Metal Oxide Varistor or similar) is placed between an input terminal and the source terminal of the low-side MOSFET.
One voltage clamping device (zener diode, Transient Voltage Suppressor, Metal Oxide Varistor or similar) is placed between an input terminal and the drain of the high-side MOSFET.
One voltage clamping device (zener diode, Transient Voltage Suppressor, Metal Oxide Varistor or similar) is placed between the switching node and the source terminal of the low-side MOSFET.
One voltage clamping device (zener diode, Transient Voltage Suppressor, Metal Oxide Varistor or similar) is placed between the switching node and the drain terminal of the high-side MOSFET.
One or more diodes provide both inrush current protection and voltage clamping protection

### Concept B—Insulated Converter Used as a PFC

A PFC comprising an isolated converter, the isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
in which the primary winding and secondary winding are arranged on the same core and configured to have a weak mutual coupling k.
and in which the Power Factor Correction is obtained by controlling the converter in order to absorb a current with almost the same waveform and phase of the input voltage and a low harmonic content.

### Optional Feature:

The input source is AC or rectified AC.

### Concept C—Bridgeless Class-Egg Converter

A single stage PFC AC/DC converter system comprising a transformer including a primary winding and a secondary winding, and in which:
(i) the primary winding couples to an AC input voltage,
(ii) the primary winding is in series with two switches in antiseries configuration,

and in which the system is configured to (a) provide power to the secondary side circuit and (b) regulate the input current such that the input current is substantially in phase with the input voltage.

### Optional Features:

The primary to secondary windings coupling factor is low (k<0.95).
The converter is insulated.
The primary side circuit only includes two power switches.
The primary side switches are turned on in ZVS or quasi-ZVS conditions thanks to the resonance between the primary winding and the capacitance between the node in common between a switch and the primary winding.
The rectifier may be half-wave or full-wave, such as single switch, push-pull, voltage doubler and current doubler rectifiers.
An interleaved version of the converter is implemented using one or more additional primary side branches.

### Concept D—Battery or Supercapacitor as Storage Element

An isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
and in which the primary winding and secondary winding are arranged on the same core and configured to have a weak mutual coupling k, and in which the storage element is located on the secondary side, after a rectifier circuit.

### Optional Features:

The storage element includes one or more batteries.
The storage element is a supercapacitor.

### Concept E—Primary Side Capacitor Used as Storage Element

An isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
and in which the primary winding and secondary winding are arranged on the same core and configured to have a weak mutual coupling k, and in which one or more primary side capacitors are used as storage elements.

### Optional Features:

The mutual coupling k is about 0.5.
The mutual coupling k is about 0.9.
A storage capacitor is connected to the drain terminal of the upper MOSFET and the source of the lower MOSFET.
A storage capacitor is connected to the drain of the upper MOSFET and one terminal of the primary winding, a second storage capacitor is connected to the same terminal of the primary winding and the source of the lower MOSFET.
The converter is supplied with an AC or a rectified AC voltage and operates as a PFC. When the power absorbed from the input is higher than (or less than) the power delivered to the load, the exceeding (or needed) power is stored in (or withdrawn from) the storage capacitor.
In case of an temporary input voltage drop, the converter is able to provide power to the load by extracting it from the previously charged stored capacitor.

### Concept F—Light Load Conditions

An insulated converter comprising:
a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
a load located at the secondary side circuit;
   in which the turn off time of the isolated converter is adapted or changed in a continuous way.

### Optional Features:

The primary winding and secondary winding are arranged on the same core and configured to have a weak mutual coupling k.
The primary winding connects to two switching MOSFETs, namely an upper MOSFET and a lower MOSFET, and in which the duty cycle on the primary side is reduced by controlling the upper MOSFET.
upper MOSFET is turned off when the voltage at the capacitor is at its maximum.
the converter is configured to restart under zero volt or zero current conditions after an amount of time in which both the upper MOSFET and lower MOSFET are turned off.
The converter is able to achieve more than 90% efficiency under light load conditions.
Light load conditions refer to a load that is less than 10% than the peak load.
   Concept G—Rectifier MOSFET with Delayed Turn-Off

An insulated converter comprising:
a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
in which the secondary side circuit includes a rectifying circuit and a load;
and in which the turn off time of the rectifying circuit is delayed in order to reflect part of the energy received on the secondary side circuit back to the primary side circuit via the coupling between the primary winding and secondary winding.

### Optional Features

The turn off time of the rectifying circuit is delayed by a specific time duration that is determined in order to regulate the output voltage or current at the load.
The delay is implemented by a closed-loop controller, such as a Proportional, Integrative and Derivative (PID) controller.
The delay is increased to reduce the output voltage or current at the load.
The delay is determined or calculated by a digital controller.
The delay is implemented using an analog circuit.
One or more of the rectifying switches are turned off with a certain delay, and one or more switches are turned off with no delay.
The converter is configured to provide PFC and output power regulation.
The delayed turn off technique is used to have an extra degree of freedom and easily

### Section V. Simplified AC/DC

### Concept A. Insulated AC/DC Converter Implemented Using Two ICs: A Primary Side IC Including High-Voltage Startup and an High Voltage Switch, and a Low Voltage IC Secondary Side Controller

An insulated AC/DC converter comprising:
a transformer including a primary winding and a secondary winding;
a primary side circuit including a switch coupled to the primary winding; a secondary side circuit including a controller coupled to the secondary winding; in which the AC/DC converter is implemented using (i) a primary side IC including high-voltage startup and a high voltage switch, and (ii) a low voltage IC secondary side controller.

### Concept B. Insulated AC/DC Converter Implemented Using Only Two ICs

An insulated AC/DC converter comprising:
a transformer including a primary winding and a secondary winding;
a primary side circuit including a switch coupled to the primary winding; a secondary side circuit including a controller coupled to the secondary winding; in which the AC/DC converter is implemented using only two integrated circuits.

Generally applicable optional features:
The primary side switch is configured to start up the secondary side controller.
No additional primary side power switches are needed.
The primary side high voltage IC is implemented in Silicon.
The primary side high voltage IC is implemented with a wide bandgap semiconductor material, such as GaN, SiC or GaAs.
A digital communication between primary side switch and secondary side controller include:
   a capacitive interface (modulated or baseband).
   a digital opto-isolator.
   power-transformer-based signalling (signal passes through the transformer).
Secondary side ASIC includes support for protocols such as PD, QC or others.
AC/DC converter can be configured in any flyback converter topology, such as QR flyback, Active Clamp flyback, ZVS-induced flyback, asymmetrical half-bridge fly-back.
AC/DC converter can be configured in any resonant converter topology, such as half or full bridge resonant converters or asymmetrical half-bridge fly-back (AHBF).
AC/DC converter can be configured as a flyback converter topology, and in which the flyback converter is capable of inducing ZVS switching on the primary side.
a start up circuit and high voltage switch are implemented with a single IC on the primary side of the transformer.

### Concept C—Primary-Side IC Integrating High-Voltage Startup System and a High-Voltage Switch

A single integrated circuit configured to be used on the primary side circuit of a converter comprising a transformer, in which the converter includes a primary side circuit and a secondary side circuit, and in which the integrated circuit includes a high-Voltage startup circuit and a high voltage power switch.

### Optional Features

Converter is an AC/DC converter.
Converter is a DC/DC power converter
The Integrated circuit also embeds one or more additional power switches.
The integrated circuit also includes one or more primary side switch gate drivers or any other primary side components, such as a control circuit.
The IC includes a rectification circuit used to rectify an auxiliary winding voltage
The IC includes a DC/DC converter used to generate the auxiliary voltages from the input rail or from another rail.
The IC includes current sensing capability for the power switches
The IC includes a data transmitting or receiving peripheral
The IC embeds a control circuit used to control the power switches, for example in current mode
The embedded switch(es) are implemented with a wide bandgap semiconductor material, such as GaN, SiC or GaAs

Note that different concepts or approaches and features may be combined with one another. For simplicity, we have organised features as relating to a specific higher-level feature or concept; however, this is generally a preferred implementation only and the skilled implemented will appreciate that features should not be interpreted as being limited to the specific context in which they are introduced but may be independently deployed

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-43. (canceled)

44. A flyback converter comprising:
a) a transformer having a primary side winding and a secondary side winding;
b) a primary side switch located at the primary side of the transformer;
c) two secondary side switches located at the secondary side of the transformer; in which the two secondary side switches are connected in parallel and have different characteristics; in which the two secondary side switches includes a first secondary side switch (M2) and a second secondary side switch (M6); and
d) a control unit configured to generate a rectification signal and a Zero Voltage Switching (ZVS) pulse and to drive the two secondary side switches; in which the first secondary side switch (M2) is driven by the rectification signal and the second secondary side switch (M6) is driven by the ZVS pulse; and in which at the end of a switching cycle, before turning on the primary side switch: the control unit is configured to generate the ZVS pulse in the secondary side winding such that the parasitic capacitor of the primary side switch is discharged, and to consequently turn on the primary side switch in ZVS conditions or near ZVS conditions.

45. The flyback converter of claim 44, in which one secondary side switch is a high power MOSFET and the other secondary side switch is a low power MOSFET.

46. The flyback converter of claim 44, in which the secondary side switches are any combination of Silicon MOSFETs, GaN or SiC transistors with different drain to source on resistance.

47. The flyback converter of claim 44, in which the first secondary side switch (M2) is configured as a power rectifier and is driven by the rectification signal.

48. The flyback converter of claim 44, in which one secondary side switch (M2) has a lower drain-source on resistance value than the other secondary side switch.

49. The flyback converter of claim 44, in which one secondary side switch (M2) has a higher gate to source capacitance than the other secondary side switch (M6).

50. The flyback converter of claim 44, in which one secondary side switch (M2) has a higher output capacitance than the other secondary side switch (M6).

51. The flyback converter of claim 44, in which one secondary side switch (M6) is configured to only be activated or turned ON for light load conditions, such as when the load is less than 10% of a nominal output power.

52. The flyback converter of claim 44, in which one secondary side switch (M6) is configured to be de-activated or turned OFF depending on the load conditions, such as middle and high loads.

53. The flyback converter of claim 44, in which one secondary side switch is configured to be de-activated when the load conditions are higher than a pre-determined threshold, such as higher than 10% of a nominal output power or 50% of the nominal output power.

54. The flyback converter of claim 44, in which one secondary side switch is configured to be automatically de-activated when the load conditions are higher than a pre-determined threshold, such as higher than 10% of a nominal output power or 50% of the nominal output power.

55. The flyback converter of claim 44, in which the ZVS pulse is generated when a local minimum voltage at the drain terminal of the second secondary side switch (M6) is detected.

56. A flyback converter comprising:
a) a transformer having a primary side winding and a secondary side winding;
b) a primary side switch at the primary side of the transformer;
c) a secondary side switch at the secondary side of the transformer;
d) a control unit configured to digitally add a ZVS pulse to a rectification signal, and in which the ZVS pulse is configured to discharge the parasitic capacitor of the primary side switch allowing to consequently turn on the primary side switch in ZVS conditions or near ZVS conditions.

57. The flyback converter of claim 44, in which the duration of the ZVS pulse T_{zvs} is determined using the following equation:
$${T}_{z v s} = \frac{{V}_{i} + ( n * {V}_{o u t} )}{n * {V}_{o u t}} * \sqrt{{C}_{e q} * {L}_{p r i}} ,$$
where Vᵢ refers to the input voltage, Vₒᵤₜ refers to the output voltage, Lₚᵣᵢ refers to the inductance value of the primary winding of the transformer, C_{eq} refers to an equivalent drain to ground total capacitance at the primary side switch and n refers to the transformer turn ratio between primary and secondary windings.

58. The flyback converter of claim 44, in which the primary side switch on-time is calculated from the frequency of the ZVS pulse.

59. A method of operating a flyback converter, the flyback converter comprising: a) a transformer having a primary side winding and a secondary side winding; b) a primary side switch located at the primary side of the transformer; c) two secondary side switches located at the secondary side of the transformer; in which the two secondary side switches are connected in parallel and have different characteristics; in which the two secondary side switches includes a first secondary side switch (M2) and a second secondary side switch (M6); d) a control unit configured to generate a rectification signal and a Zero Voltage Switching (ZVS) pulse and to drive the two secondary side switches; in which the first secondary side switch (M2) is driven by the rectification signal and the first secondary side switch (M1) is driven by the ZVS pulse; and in which at the end of a switching cycle, before turning on the primary side switch: the control unit is configured to generate the ZVS pulse in the secondary side winding such that the parasitic capacitor of the primary side switch is discharged, and to consequently turn on the primary side switch in ZVS conditions or near ZVS conditions.

60. A method of operating a flyback converter, the flyback converter comprising: a) a transformer having a primary side winding and a secondary side winding; b) a primary side switch at the primary side of the transformer; c) a secondary side switch at the secondary side of the transformer; d) a control unit; and in which the control unit is configured to digitally add a ZVS pulse to a rectification signal, in which the ZVS pulse is configured to discharge the parasitic capacitor of the primary side switch allowing to consequently turn on the primary side switch in ZVS conditions or near ZVS conditions, and in which the ZVS pulse begins when the rectification signal ends.

61. The flyback converter of claim 56, and in which the ZVS pulse begins when the rectification signal ends.
